(19) United States
(12) Patent Application Publication
(10) Pub. No.: US 2026/0145995 A1
(43) Pub. Date: May 28, 2026

(54) FOLDABLE APPARATUS

(71) Applicants: CORNING INCORPORATED, CORNING, NY (US); Corning Precision Materials Co., LTD., Asan-si (KR)

(72) Inventors: Claire Renata Coble, Horseheads, NY (US); Lin Lin, Painted Post, NY (US); Alexandre Michel Mayolet, Corning, NY (US); Balamurugan Meenakshi Sundaram, Painted Post, NY (US); Dong-gun Moon, Yongin-si (KR); James Edward Morrison, JR., Hornell, NY (US); James Joseph Price, Corning, NY (US); Vitor Marino Schneider, Painted Post, NY (US); Ananthanarayanan Subramanian, Corning, NY (US)

(21) Appl. No.: 19/389,972

(22) Filed: Nov. 14, 2025

Related U.S. Application Data
(60) Provisional application No. 63/725,906, filed on Nov. 27, 2024.
(60) Provisional application No. 63/876,428, filed on Sep. 5, 2025.
(60) Provisional application No. 63/904,906, filed on Oct. 24, 2025.

(51) Int. Cl. C03C 17/34

(52) U.S. Cl. CPC C03C 17/3435; C03C 2217/213; C03C 2217/281; C03C 2217/734; C03C 2217/76; C03C 2217/78; C03C 2218/154

(57) ABSTRACT

Foldable apparatus are described herein that include hard coating disposed on a first major surface of a foldable substrate comprising a glass-based material. A substrate thickness of the foldable substrate is from greater than or equal to 20 micrometers to less than or equal to 300 micrometers. The hard coating includes an inorganic material exhibiting a hardness greater than or equal to 8 GigaPascals as measured by a Berkovich Indenter Hardness Test. The foldable apparatus can achieve a parallel plate distance in millimeters equal to 0.1 times the substrate thickness in micrometers. In aspects, the hard coating can include an optical stack that includes an anti-reflective coating with a thickness from greater than or equal to 10 nanometers to less than or equal to 10 micrometers. In aspects, the foldable apparatus can further comprise an anti-fingerprint coating disposed on the hard coating.

### FIELD

This application claims the benefit of priority under 35 U.S.C. § 119 of U.S. Provisional Application Ser. No. 63/904,906 filed on Oct. 24, 2025, U.S. Provisional Application Ser. No. 63/876,428 filed on Sep. 5, 2025, and U.S. Provisional Application Ser. No. 63/725,906 filed on Nov. 27, 2024, the content of which are relied upon and incorporated herein by reference in their entirety.

### FIELD

The present disclosure relates generally to apparatus having a hard coating disposed on a substrate and, more particularly, to foldable apparatus having a hard coating disposed on a glass-based foldable substrate.

### BACKGROUND

Glass-based materials are commonly used in various consumer electronic products including display devices, for example, liquid crystal displays (LCDs), electrophoretic displays (EPD), organic light-emitting diode displays (OLEDs), plasma display panels (PDPs), or the like. For example, chemically strengthened glass is favored for many touch-screen products, including cell phones, music players, e-book readers, notepads, tablets, laptop computers, automatic teller machines, and other similar devices. Many of these glass-based materials are also employed in displays and display devices of consumer electronic products that do not have touch-screen capability but are prone to direct human contact, including desktop computers, laptop computers, elevator screens, equipment displays, and others. Glass materials are often treated to provide aesthetic and functional characteristics based on the end-use application of the material. Consequently, there is a need for a new foldable apparatus that can provide improved abrasion resistance and/or optical properties while maintaining foldability. This need and others are addressed by the present disclosure.

### SUMMARY

There are set forth herein foldable apparatus having a hard coating disposed over a foldable substrate that still maintains foldability comparable to that of the underlying foldable substrate. As demonstrated by the Examples discussed herein, it was unexpectedly discovered that the foldable apparatus including the hard coating described herein can achieve parallel plate distances less than or equal to 0.1 mm/μm (or 0.05 mm/μm) times the substrate thickness (or 5 mm or 3 mm) in the Static Folding Test. It would have been expected that a foldable apparatus having the hard coating would fail due to the high stiffness imparted by the high modulus and high hardness hard coating and/or brittleness of the hard coating. Instead, the hard coating improves the folding performance of the foldable apparatus (by incorporating the hard coating). Further, it was unexpectedly discovered that the foldable apparatus including the hard coating described herein can exhibit low residual warp after the Static Warp Test (e.g., 24 hours). Again, it would have been expected that the increased stiffness imparted by the high modulus (e.g., higher modulus than the foldable substrate) and high hardness hard coating would have resisted the foldable apparatus returning to the folded configuration, which would appear as high warp (e.g., greater than 3 times the parallel plate distance in the Static Fold Test).

In aspects, foldable apparatus can comprise an anti-fingerprint coating disposed over the hard coating that can reduce a visibility and/or color shift associated with disposing a fingerprint thereon. Providing a low total surface energy (including a low dispersive surface energy and/or a low polar surface energy) of the anti-fingerprint coating can enable oils (e.g., fingerprint oil) to be dispersed across the anti-fingerprint surface (e.g., oleophilic), which can decrease a visibility and/or a color shift associated with fingerprints. For example, providing an alkyl silane can reduce a surface energy (e.g., total, dispersive, polar) of the anti-fingerprint coating, which can enable the anti-fingerprint coating to be oleophilic. Providing a low hexadecane contact angle (e.g., 30° or less) and/or a low diiodomethane contact angle (e.g., 60° or less) can reduce the visibility and/or color shift associated with fingerprints by enabling fingerprint oil to be dispersed across the anti-fingerprint coating rather than beading up into pronounced droplets. Providing a high water contact angle (e.g., 100° or more) can enhance the removal of aqueous material (e.g., water droplets, sweat droplets) from the anti-fingerprint coating. Consequently, the anti-fingerprint coating can be hydrophobic and oleophilic.

The foldable substrate can comprise a glass-based material, which can provide good dimensional stability, good impact resistance, and/or good puncture resistance. The glass-based substrate can comprise one or more compressive stress regions, which can further provide increased impact resistance and/or increased puncture resistance.

Some example aspects of the disclosure are described below with the understanding that any of the features of the various aspects may be used alone or in combination with one another.

Aspect 1. A foldable apparatus comprising:
a foldable substrate comprising a glass-based material, a first major surface and a second major surface opposite the first major surface, a substrate thickness defined between the first major surface and the second major surface, and the substrate thickness is from greater than or equal to 20 micrometers to less than or equal to less than or equal to 300 micrometers; and
a hard coating disposed on the first major surface, the hard coating comprising an inorganic material and exhibits a hardness of greater than or equal to 8 GigaPascals as measured by a Berkovich Indenter Hardness test,
wherein the foldable apparatus can achieve a parallel plate distance in millimeters equal to 0.1 times the substrate thickness in micrometers.

Aspect 2. The foldable apparatus of aspect 1, wherein the foldable apparatus including the hard coating exhibits the hardness of greater than or equal to 12 GigaPascals as measured by the Berkovich Indenter Hardness test.

Aspect 3. The foldable apparatus of any one of aspects 1-2, wherein an elastic modulus of the hard coating is greater than or equal to 100 GigaPascals.

Aspect 4. The foldable apparatus of any one of aspects 1-3, wherein the hard coating comprises an optical stack, the optical stack comprises an anti-reflective coating, a band-pass filter coating, an edge neutral mirror, a beam splitter coating, a multi-layer high-reflectance coating, or an edge filter coating.

Aspect 5. The foldable apparatus of aspect 4, wherein the optical stack is the anti-reflective coating.

Aspect 6. The foldable apparatus of any one of aspects 4-5, wherein the optical stack has a stack thickness from greater than or equal to 10 nanometers to less than or equal to 10 micrometers.

Aspect 7. The foldable apparatus of aspect 6, wherein the stack thickness of the optical stack is from greater than or equal to 50 nanometers to less than or equal to 5 micrometers.

Aspect 8. The foldable apparatus of aspect 7, wherein the stack thickness of the optical stack is from greater than or equal to 50 nanometers to less than or equal to 5 micrometers.

Aspect 9. The foldable apparatus of any one of aspects 4-8, wherein the optical stack comprises a scratch-resistant layer, and wherein the scratch-resistant layer has a thickness from greater than or equal to 0.05 micrometers to less than or equal to 3 micrometers.

Aspect 10. The foldable apparatus of aspect 9, wherein the scratch-resistant layer exhibits an elastic modulus greater than or equal to 200 GigaPascals.

Aspect 11. The foldable apparatus of any one of aspects 9-10, wherein the scratch-resistant layer comprises a Vickers hardness greater than or equal to 500.

Aspect 12. The foldable apparatus of any one of aspects 4-11, wherein the optical stack comprises one or more of a silicon-containing oxide, a silicon-containing nitride, a silicon-containing oxynitride, an aluminum-containing nitride, an aluminum-containing oxynitride, or niobia.

Aspect 13. The foldable apparatus of any one of aspects 4-11, wherein the optical stack comprises two or more layers with different refractive indices including at least a first low refractive index layer and a second high refractive index layer, an absolute value of a difference between the first low refractive index layer and the second high refractive index layer is 0.2 or more, and further wherein the optical stack comprises one or more of a silicon-containing oxide, a silicon-containing nitride, a silicon-containing oxynitride, an aluminum-containing nitride, an aluminum-containing oxynitride, or niobia.

Aspect 14. The foldable apparatus of any one of aspects 1-13, wherein the hard coating disposed on the foldable substrate exhibits a pencil hardness of 9H or more.

Aspect 15. The foldable apparatus of any one of aspects 1-14, wherein the hard coating disposed on the foldable substrate exhibits a Mohs hardness of 7 or more.

Aspect 16. The foldable apparatus of any one of aspects 1-14, wherein a first Mohs hardness of the hard coating disposed on the foldable substrate is greater than a second Mohs hardness of the foldable substrate alone.

Aspect 17. The foldable apparatus of any one of aspects 1-16, wherein the foldable apparatus can achieve a parallel plate distance in millimeters equal to 0.05 times the substrate thickness in micrometers.

Aspect 18. The foldable apparatus of any one of aspects 1-17, wherein the foldable apparatus can achieve a parallel plate distance of 5 millimeters.

Aspect 19. The foldable apparatus of any one of aspects 1-18, wherein the foldable apparatus can achieve a minimum parallel plate distance from 0.5 millimeters to 10 millimeters.

Aspect 20. The foldable apparatus of any one of aspects 1-19, wherein the foldable apparatus can withstand 200,000 cycles to the parallel plate distance equal to 0.1 times the substrate thickness in micrometers in a Dynamic Cycling Test at 23° C. and 50% relative humidity.

Aspect 21. The foldable apparatus of any one of aspects 1-20, wherein the foldable apparatus can withstand 200,000 cycles to a parallel plate distance of 5 millimeters in a Dynamic Cycling Test at 23° C. and 50% relative humidity.

Aspect 22. The foldable apparatus of any one of aspects 1-20, wherein the foldable apparatus can withstand 200,000 cycles to a parallel plate distance of 3 millimeters in a Dynamic Cycling Test at 23° C. and 50% relative humidity.

Aspect 23. The foldable apparatus of any one of aspects 1-22, wherein the foldable apparatus can withstand being held at the parallel plate distance equal to 0.1 times the substrate thickness in micrometers in a Static Folding Test at 60° C. and 90% relative humidity for 24 hours.

Aspect 24. The foldable apparatus of any one of aspects 1-22, wherein the foldable apparatus can withstand being held at a parallel plate distance of 3 millimeters in a Static Folding Test at 60° C. and 90% relative humidity for 24 hours.

Aspect 25. The foldable apparatus of any one of aspects 23-24, wherein a residual warp 24 hours after completion of the Static Folding Test is less than 11.0 millimeters.

Aspect 26. The foldable apparatus of any one of aspects 1-25, wherein a residual warp 24 hours after completion of a Static Folding Test where the foldable apparatus is held at a parallel plate distance of 5 millimeters at 60° C. and 90% relative humidity for 24 hours is less than or equal to 1.0 millimeter.

Aspect 27. The foldable apparatus of any one of aspects 1-26, further comprising:
an anti-fingerprint coating comprising an exterior surface of the foldable apparatus, and the anti-fingerprint coating disposed over the hard coating,
wherein the hard coating is positioned between the first major surface of the foldable substrate and the anti-fingerprint coating, and the anti-fingerprint coating exhibits a water contact angle of greater than or equal to 100° or more.

Aspect 28. The foldable apparatus of aspect 27, wherein the water contact angle is from greater than or equal to 105° to less than or equal to 120°.

Aspect 29. The foldable apparatus of any one of aspects 27-28, wherein the anti-fingerprint coating exhibits a diiodomethane contact angle of 60° or more.

Aspect 30. The foldable apparatus of any one of aspects 27-29, wherein the anti-fingerprint coating wets hexadecane or exhibits a hexadecane contact angle of 30° or less.

Aspect 31. The foldable apparatus of any one of aspects 27-30, wherein the anti-fingerprint coating comprises a polar surface energy of 3 milliNewtons per meter (mN/m) or less.

Aspect 32. The foldable apparatus of any one of aspects 27-31, wherein the anti-fingerprint coating comprises a total surface energy of 30 milliNewtons per meter (mN/m) or less.

Aspect 33. The foldable apparatus of any one of aspects 27-32, wherein the anti-fingerprint coating exhibits an abraded water contact angle of greater than or equal to 90° after being abraded for 2,000 cycles in a Steel Wool Abrasion Test.

Aspect 34. The foldable apparatus of any one of aspects 27-33, wherein the anti-fingerprint coating exhibits a cheesecloth-abraded water contact angle of greater than or equal to 90° after being subjected to 200,000 cycles in a Cheesecloth Abrasion Test.

Aspect 35. The foldable apparatus of any one of aspects 27-34, wherein the anti-fingerprint coating exhibits a rubber abrasion water contact angle of greater than or equal to 100° after being subjected to 5,000 cycles in a Rubber Abrasion Test.

Aspect 36. The foldable apparatus of any one of aspects 25-35, wherein the foldable substrate exhibits a reflectance haze from greater than or equal to 0.01% to less than or equal to 0.5% after being abraded for 500 cycles in a Taber Abrasion Test.

Aspect 37. The foldable apparatus of any one of aspects 1-36, wherein the substrate thickness is from greater than or equal to 25 micrometers to less than or equal to 150 micrometers.

Aspect 38. The foldable apparatus of any one of aspects 1-37, wherein the foldable substrate is substantially unstrengthened.

Aspect 39. The foldable apparatus of any one of aspects 1-37, wherein the foldable substrate comprises a first compressive stress region extending from the first major surface to a first depth of compression, a first maximum compressive stress of the first compressive stress region is from greater than or equal to 500 MegaPascals to less than or equal to 1,500 MegaPascals.

Aspect 40. The foldable apparatus of aspect 39, wherein the first depth of compression is from greater than or equal to 5 micrometers to less than or equal to 25% of the substrate thickness.

Aspect 41. The foldable apparatus of any one of aspects 1-40, wherein a composition of the foldable substrate comprises:
from 40 mol % to 80 mol % SiO₂;
from 5 mol % to 30 mol % Al₂O₃;
from 0 mol % to 10 mol % B₂O₃;
from 0 mol % to 5 mol % ZrO₂;
from 0 mol % to 15 mol % P₂O₅;
from 5 mol % to 20 mol % R₂O, R₂O is a total amount of Li₂O, Na₂O, K₂O, Rb₂O, and Cs₂O; and
from 0 mol % to 15 mol % RO, RO is a total amount of MgO, CaO, SrO, BaO, and ZnO.

Aspect 42. The foldable apparatus of aspect 41, wherein the composition of the foldable substrate comprises:
from 60 mol % to 72 mol % SiO₂;
from 8 mol % to 17 mol % Al₂O₃;
from 0 mol % to 2 mol % B₂O₃;
from 0 mol % to 2 mol % P₂O₅;
from 12 mol % to 20 mol % R₂O; and
from 3 mol % to 7 mol % RO.

Aspect 43. The foldable apparatus of any one of aspects 41-42, wherein the composition of the foldable substrate comprises:
from 14 mol % to 19 mol % Na₂O;
from 0 mol % to 1 mol % Li₂O; and
from 0 mol % to 0.5 mol % K₂O.

Aspect 44. The foldable apparatus of any one of aspects 41-43, wherein the composition of the foldable substrate exhibits Al₂O₃—Na₂O from greater than or equal to −6.0 mol % to less than or equal to −2.0 mol %.

Aspect 45. The foldable apparatus of any one of aspects 1-44, wherein a local thickness of the foldable substrate across the first major surface of the foldable substrate is substantially equal to the substrate thickness.

Aspect 46. The foldable apparatus of any one of aspects 1-44, wherein the foldable substrate comprises:
a first portion comprising the substrate thickness;
a second portion comprising the substrate thickness; and
a central portion positioned between the first portion and the second portion, the central portion comprising a central thickness defined between a first central surface area and a second central surface area opposite the first central surface area, and the substrate thickness is greater than the central thickness by greater than or equal to 30 micrometers.

Aspect 47. The foldable apparatus of aspect 46, wherein the first central surface area is recessed from the first major surface by greater than or equal to 30 micrometers.

Aspect 48. The foldable apparatus of any one of aspects 46-47, wherein the second central surface area is recessed from the second major surface by greater than or equal to 30 micrometers.

Aspect 49. The foldable apparatus of any of the aspects 13-48, wherein: the optical stack comprises the anti-reflective coating and the anti-reflective coating comprises alternating layers of one or more higher refractive index materials and one or more lower refractive index materials, wherein refractive indices of the one or more higher refractive index materials of the first layered film are higher than refractive indices of the one or more lower refractive index materials, and a quantity, thicknesses, number, and materials of the alternating layers of the optical stack are configured so that the foldable apparatus exhibits: an average percentage transmittance, calculated over a wavelength range between 400 nm and 700 nm, of greater than or equal to 92% for light normally light incident on the first major surface, and first surface photopic percentage reflectance, of less than 1.5% for light normally light incident on an outer surface of the optical stack facing an observer.

Aspect 50. The foldable apparatus of the aspect 49, wherein the average percentage transmittance is greater than or equal to 94%.

Aspect 51. The foldable apparatus of any of the aspects 49-50, wherein the first surface photopic average reflectance is less than or equal to 1%.

Aspect 52. The foldable apparatus of any of the aspects 49-51, wherein the quantity, thicknesses, number, and materials of the alternating layers of the optical stack are configured so that the foldable apparatus exhibits: an average percentage transmittance, calculated over a wavelength range from 400 nm to 700 nm, of greater than or equal to 85% for light incident on the first major surface at each angle in a range of angles of incidence from 0° to 60°, and a first surface photopic percentage reflectance of less than 1% for light incident on the outer surface at each angle in a range of angles of incidence from 0° to 30°.

Aspect 53. The foldable apparatus of any of the aspects 49-52, wherein, at a point on the outer surface, the anti-reflective coating comprises a single-surface reflectance under a D65 illuminant having an angular color variation, ΔE_{θ}, defined as: ΔE_{θ}={(a*_{θ1}−a*_{θ2})²+(b*_{θ1}−b*_{θ2})²}, where a*_{θ1} and b*_{θ1} are a* and b* values of the point measured from a first angle θ₁, and a*_{θ2} and b*_{θ2} are a* and b* values of the point measured from a second angle θ₂, θ₁ and θ₂ being any two different viewing angles at least 5 degrees apart in a range from about 10° to about 60° relative to a normal vector of the top side, wherein ΔE_{θ} is less than 5.

Aspect 54. The foldable apparatus of any of the aspects 49-53, wherein the foldable apparatus exhibits a puncture resistance (in kgf) that is greater than the substrate thickness (in μm) squared divided by 3300, as measured by the Quasi-Static Puncture test.

Aspect 55. The foldable apparatus according to any of the aspects 49-54, wherein the foldable apparatus can achieve a parallel plate distance in millimeters that is less than or equal to 0.3 (mm/μm) times the thickness of the foldable substrate (in μm) and greater than or equal to 0.1 (mm/μm) times the thickness of the foldable substrate (in μm) when the anti-reflective coating is placed on a surface of foldable substrate that is placed in tension by bending.

Aspect 56. The foldable apparatus according to any of the aspects 49-55, wherein, when abraded on the anti-reflective coating as outlined in Annex A2 of ASTM C158-02 (2012) with 320 grit SiC particles, the foldable apparatus avoids failure at a load which causes a comparable foldable apparatus including only the foldable substrate to fail.

Aspect 57. The foldable apparatus according to any of the aspects 49-56, wherein, when the anti-reflective coating is scratched using a conospherical diamond tip (90 degree angle/10 pm radius) at a scratch speed of 24 mm/min, the foldable apparatus avoids failure at a load which causes a comparable foldable apparatus including only the foldable substrate to fail.

Aspect 58. The foldable apparatus according to any of the aspects 49-57, wherein anti-reflective coating exhibits a residual compressive stress in a range from about 5 MPa to 500 MPa.

Aspect 59. The foldable apparatus of any one of the aspects 1-58, wherein: the hard coating comprises a scratch-resistant layer comprising a scratch-resistant layer having a thickness that is at least 1.5% of the substrate thickness, and the scratch-resistant layer comprises a higher Young's modulus than the foldable substrate.

Aspect 60. The foldable apparatus of the aspect 59, wherein the foldable substrate exhibits a reflectance haze from greater than or equal to 0.01% to less than or equal to 0.1% after being abraded for 1500 cycles in a Taber Abrasion Test.

Aspect 59. A consumer electronic product comprising:
a housing comprising a front surface, a back surface, and a side surface;
electrical components at least partially within the housing, the electrical components comprising a controller, a memory, and a display, the display at or adjacent the front surface of the housing; and
a cover substrate disposed over the display,
wherein at least a portion of the housing comprises the foldable apparatus of any one of aspects 1-58.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic view of a foldable apparatus in a flat configuration in accordance with aspects, wherein a schematic view of the folded configuration may appear as shown in FIG. 7;

FIG. 2 is a cross-sectional view of an exemplary foldable apparatus taken along line 2-2 of FIG. 1 having a hard coating disposed over a foldable substrate having a pair of recesses opposite one another in accordance with aspects;

FIG. 3 is a cross-sectional view of another exemplary foldable apparatus taken along line 2-2 of FIG. 1 having a hard coating disposed over a foldable substrate having a single recess in accordance with aspects;

FIG. 4 is a cross-sectional view of another exemplary foldable apparatus taken along line 2-2 of FIG. 1 having a hard coating disposed over a foldable substrate having a uniform thickness over its surface in accordance with aspects;

FIGS. 5-6 are cross-sectional views of additional exemplary foldable apparatus taken along line 2-2 of FIG. 1 having a hard coating including multiple layers disposed over a foldable substrate in accordance with aspects;

FIG. 7 is a schematic view of example foldable apparatus of embodiments of the disclosure in a folded configuration wherein a schematic view of the flat configuration may appear as shown in FIG. 1;

FIG. 8 is a cross-sectional view of a testing apparatus to determine the parallel plate distance of an example modified foldable apparatus along line 8-8 of FIG. 7 that can be used for the Parallel Plate Test, the Dynamic Cycling Test, and/or the Static Folding Test according to aspects;

FIG. 9 is a cross-sectional view of another example foldable apparatus along line 8-8 of FIG. 7 that can be used for the Parallel Plate Test, the Dynamic Cycling Test, and/or the Static Folding Test according to aspects;

FIG. 10 is a schematic perspective view of a pen drop apparatus in accordance with aspects;

FIG. 11 schematically illustrates a measurement of residual warp following a Static Folding Test in accordance with aspects;

FIG. 12 is a schematic plan view of an example consumer electronic device according to aspects;

FIG. 13 is a schematic perspective view of the example consumer electronic device of FIG. 12;

FIG. 14 is a schematic perspective view of a foldable consumer electronic product;

FIG. 15 schematically illustrates reflectance (%) on the vertical axis (y-axis) as a function of optical wavelength on the horizontal axis (x-axis) for Examples 1, 3, and AA-BB;

FIG. 16 schematically illustrates a load in kilograms-force (kgf) withstood in a Quasi-Static Puncture Test on the vertical axis (y-axis) for Examples 2-4 and AA-BB;

FIG. 17 schematically illustrates pen drop heights in centimeters (cm) in a Pen Drop Test on the vertical axis (y-axis) for Examples 1-5 and BB;

FIG. 18 schematically illustrates scratches in Example AA after the Taber Abrasion Test;

FIG. 19 schematically illustrates scratches in Example 1 after the Taber Abrasion Test;

FIG. 20 schematically illustrates an article fractured from the inside surface of the article in a folded configuration for Example AA;

FIG. 21 schematically illustrates a foldable apparatus fractured from the inside surface of the foldable apparatus in a folded configuration for Example 1;

FIG. 22 is a plot of parallel plate distance achieved for an uncoated example and a coated example coated with HC3 (coated example is “Example 2”), with the coating placed in tension and compression;

FIG. 23 is a plot of quasi-static puncture test performance of an uncoated sample and the sample coated with HC3;

FIG. 24 is a plot of nanoindentation hardness and modulus as a function of depth for the sample coated with HC3;

FIG. 25 is a plot of transmittance for the sample coated with HC3 and a bare sample;

FIG. 26 is a plot of single-sided reflectance for the sample coated with HC3 and a bare sample;

FIG. 27 is a plot of change in haze (SCE) resulting from different numbers of cycles of the Taber Abrasion Test of the sample coated with HC3;

FIG. 28 is a plot of modelled first-surface reflectance for a sample coated with HC4;

FIG. 29 is a plot of modelled first-surface photopic reflectance as a function of incident angle for the sample coated with HC4;

FIG. 30 is a plot of modelled transmittance for a sample coated with HC4;

FIG. 31 is a plot of modelled first-surface reflected color for a sample coated with HC4;

FIG. 32 is a plot of modelled transmitted color for a sample coated with HC4;

FIG. 33 is a plot of nanoindentation hardness and modulus as a function of depth for the sample coated with HC5;

FIG. 34 is a plot of nanoindentation hardness and modulus as a function of depth for the sample coated with HC6

FIG. 35 is a plot of quasi-static puncture test performance of an uncoated sample and the sample coated with HC6;

FIGS. 36 and 37 are micrographs of samples coated with HC6 after impacts at 700 mm/s and 1000 mm/s, respectively, with a 10 mm diameter 220 grit (˜63 μm) garnet sandpaper disc; and

FIG. 38 is a plot of change in haze (SCE) resulting from different numbers of cycles of the Taber Abrasion Test of the sample coated with HC6.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

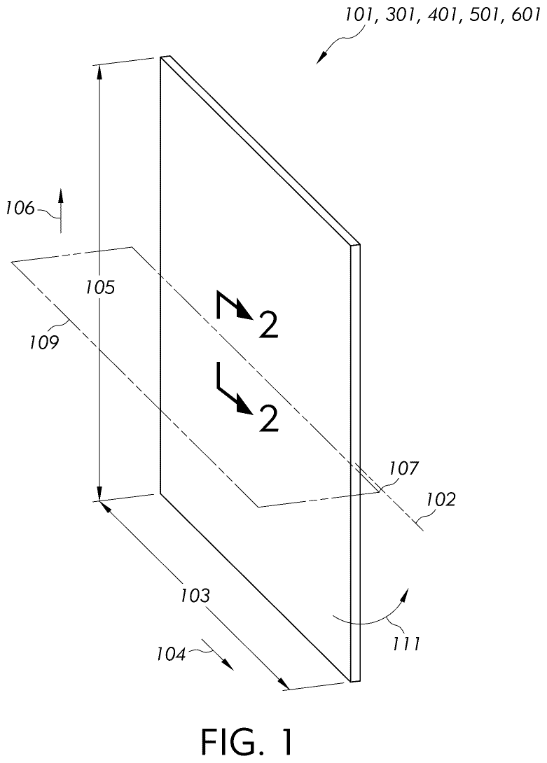

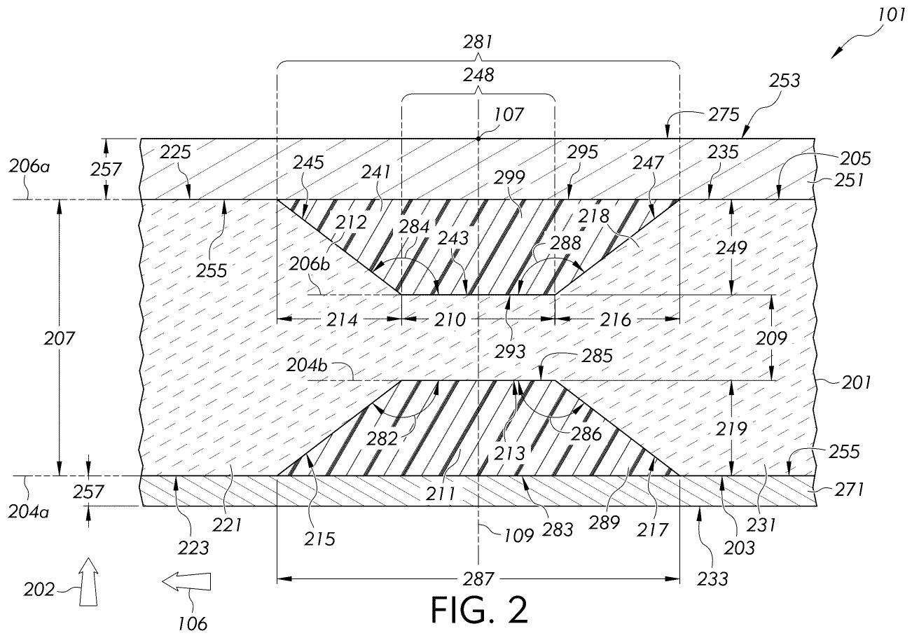

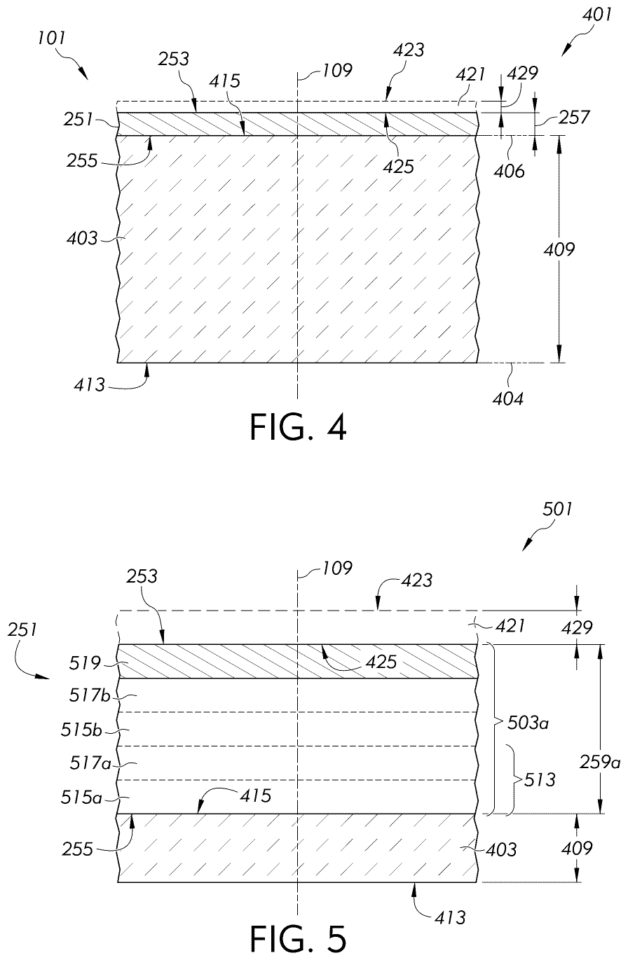

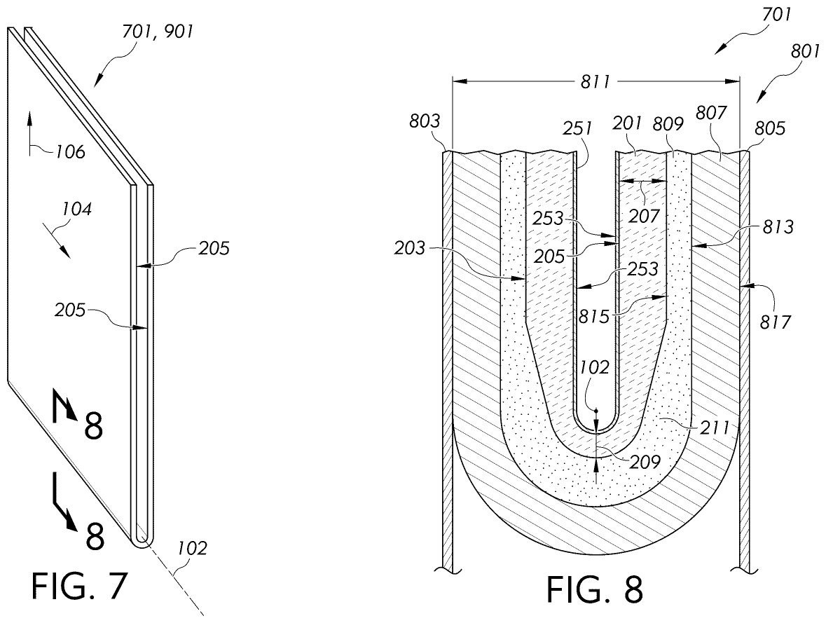

FIGS. 1-6 illustrate foldable apparatus 101, 301, 401, 501, and/or 601 in a flat configuration and FIG. 7-9 illustrate foldable apparatus 701 and/or 901 (e.g., modified foldable apparatus) in a folded configuration (e.g., as part of the Parallel Plate Test, the Dynamic Cycling Test, and/or the Static Folding Test). FIGS. 2-6 and 8-9 illustrate cross-sectional views of the foldable apparatus 101, 301, 401, 501, 601, 701, and/or 901 comprising a hard coating 251 disposed over (e.g., disposed on, contacting) a second major surface 205 of a foldable substrate 201 and/or 403. In aspects, as shown in FIGS. 2-3 and 8-9, the foldable substrate 201 can comprise one or more recesses 211 and/or 241; alternatively, as shown in FIGS. 4-6, the foldable substrate 403 may not comprise a recess (e.g., having a substantially uniform thickness across the first major surface). In aspects, as shown in FIGS. 4-6, the foldable apparatus can further comprise an anti-fingerprint coating 421 disposed over the foldable substrate 201 and the hard coating 251. Unless otherwise noted, a discussion of features of aspects of one anti-fingerprint coating or foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

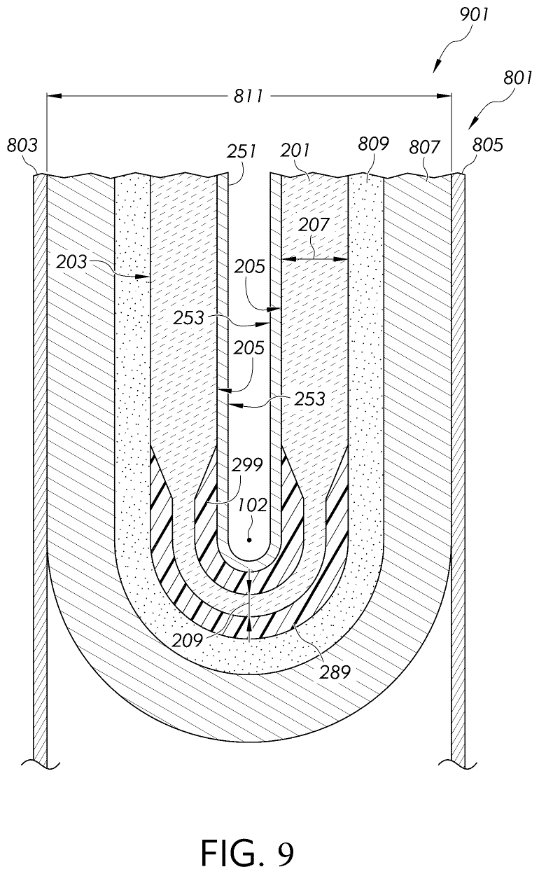

Throughout the disclosure, with reference to FIG. 1, the width 103 of the foldable apparatus 101, 301, 401, 501, 601, 701, and/or 901 is considered the dimension of the foldable apparatus taken between opposed edges of the foldable apparatus in a direction 104 of a fold axis 102 of the foldable apparatus, wherein the direction 104 also comprises the direction of the width 103. Furthermore, throughout the disclosure, the length 105 of the foldable apparatus is considered the dimension of the foldable apparatus taken between opposed edges of the foldable apparatus in a direction 106 perpendicular to the fold axis 102 of the foldable apparatus. It is to be understood that the direction 104 of the width 103 and/or the direction 106 of the length 105 can correspond to corresponding directions in the foldable substrate 201. In aspects, as shown in FIGS. 1-2, the foldable apparatus of any aspects of the disclosure can comprise a fold plane 109 that includes the fold axis 102 when the foldable apparatus is in the flat configuration (see FIG. 2). In further aspects, as shown in FIG. 2, the fold plane 109 can extend along the fold axis 102 and in a direction of the substrate thickness 207 when the foldable apparatus is in the flat configuration. The fold plane 109 may comprise a central axis 107 of the foldable apparatus. In aspects, the foldable apparatus can be folded in a direction 111 (see FIG. 1) about the fold axis 102 extending in the direction 104 of the width 103 to form a folded configuration (see foldable apparatus 701 and/or 901 in FIGS. 8-9). As shown, the foldable apparatus and/or the foldable substrate may include a single fold axis to allow the foldable apparatus and/or the foldable substrate to comprise a bifold wherein, for example, the foldable apparatus and/or the foldable substrate may be folded in half. In further aspects, the foldable apparatus and/or the foldable substrate may include two or more fold axes with each fold axis including a corresponding central portion similar or identical to the central portion 281 discussed herein. For example, providing two fold axes can allow the foldable apparatus and/or the foldable substrate to comprise a trifold wherein, for example, the foldable apparatus and/or the foldable substrate may be folded with the first portion 221, the second portion 231, and a third portion similar or identical to the first portion or second portion with the central portion 281 and another central portion similar to or identical to the central portion positioned between the first portion and the second portion and between the second portion and the third portion, respectively.

In aspects, the foldable substrate and/or the foldable apparatus can be rollable. As used herein, a foldable substrate or a foldable apparatus is “rollable” if it can achieve a threshold parallel plate distance over a length of the corresponding foldable substrate and/or foldable apparatus that is the greater of 10 mm or 10% of the length of the corresponding foldable substrate and/or foldable apparatus.

As shown in FIGS. 2-6, the foldable substrate 201 and/or 403 comprises a first major surface 203 or 413 and a second major surface 205 or 415 opposite the first major surface 203 or 413. As shown, the first major surface 203 or 413 can extend along a first plane 204a or 404, and/or the second major surface 205 or 415 can extend along a second plane 206a or 406. In aspects, as shown, the second plane 206a or 406 can be parallel to the first plane 204a or 404. As used herein, a substrate thickness 207 or 409 is defined between the first major surface 203 or 413 and the second major surface 205 or 415 (e.g., as a distance between the first plane 204a or 404 and the second plane 206a or 406. In aspects, the substrate thickness 207 or 409 can be 20 micrometers (μm) or more, 25 μm or more, 40 μm or more, 60 μm or more, 70 μm or more, 80 μm or more, 100 μm or more, 125 μm or more, 150 μm or more, 200 μm or more, 300 μm or less, 250 μm or less, 200 μm or less, 180 μm or less, 150 μm or less, 125 μm or less, or 100 μm or less. In aspects, the substrate thickness 207 or 409 can be from greater than or equal to 20 μm to less than or equal to 300 μm, from greater than or equal to 25 μm to less than or equal to 250 μm, from greater than or equal to 40 μm to less than or equal to 200 μm, from greater than or equal to 60 μm to less than or equal to 180 μm, from greater than or equal to 70 μm to less than or equal to 150 μm, from greater than or equal to 80 μm to less than or equal to 150 μm, from greater than or equal to 100 μm to less than or equal to 125 μm, or any range or subrange therebetween. In preferred aspects, the substrate thickness can be from greater than or equal to 20 μm to less than or equal to 2 mm, from greater than or equal to 20 μm to less than or equal to 300 μm, or from greater than or equal to 25 μm to less than or equal to 150 μm.

The foldable substrate 201 and/or 403 can comprise a glass-based material having a pencil hardness of 8H or more, for example, 9H or more. As used herein, pencil hardness is measured using ASTM D 3363-20 with standard lead graded pencils. Providing a glass-based material as the substrate can enhance puncture resistance and/or impact resistance. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Exemplary glass-based materials may be an alkali-free glass and/or comprise a low content of alkali metals (e.g., R₂O of 10 mol % or less, wherein R₂O is a total amount of Li₂O, Na₂O, K₂O, Rb₂O, and Cs₂O; and RO is a total amount of MgO, CaO, SrO, BaO, and ZnO). As used herein, “ceramic-based” includes both ceramics and glass-ceramics, wherein glass-ceramics have one or more crystalline phases and an amorphous, residual glass phase. In aspects, ceramic-based materials can comprise one or more oxides, nitrides, oxynitrides, carbides, borides, and/or silicides. Throughout the disclosure, an elastic modulus (e.g., Young's modulus) of the foldable substrate 201 and/or 403 is measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the foldable substrate 201 and/or 403 can comprise an elastic modulus ranging from 60 GPa to 200 GPa, from 70 GPa to 150 GPa, from 72 GPa to 120 GPa, from 75 GPa to 100 GPa, or any range or subrange therebetween.

In aspects, the glass-based material of the foldable substrate 201 and/or 403 can comprise from 40 mol % to 80 mol % SiO₂, from 5 mol % to 30 mol % Al₂O₃, from 5 mol % to 20 mol % Na₂O and/or R₂O, and optionally: from 0 mol % to 15 mol % RO; from 0 mol % to 10 mol % B₂O₃; and/or from 0 mol % to 5 mol % ZrO₂. In further aspects, the glass-based material of the foldable substrate 201 and/or 403 can comprise from 60 mol % to 72 mol % SiO₂, from 8 mol % to 17 mol % Al₂O₃, from 12 mol % to 20 mol % Na₂O and/or R₂O, from 3 mol % to 7 mol % MgO and/or RO, and optionally from 0 mol % to 2 mol % of one or more of B₂O₃ and/or P₂O₅. In even further aspects, the glass-based material of the foldable substrate 201 and/or 403 can further comprise from 14 mol % to 19 mol % Na₂O, from 0 mol % to 1 mol % Li₂O, and/or from 0 mol % to 0.5 mol % K₂O. In further aspects, the glass-based material of the foldable substrate 201 and/or 403 can comprise from 63 mol % to 72 mol % SiO₂, from 8 mol % to 15 mol % Al₂O₃, from 12 mol % to 18 mol % Na₂O and/or R₂O, from 2 mol % to 7 mol % MgO and/or RO, optionally from 0 mol % to 2 mol % of one or more of Li₂O, CaO, B₂O₃, and/or P₂O₅, and optionally from 0 mol % to 1 mol % K₂O. In further aspects, the foldable substrate 201 and/or 403 can comprise from 64.0 mol % 70 mol % SiO₂, from 9.5 mol % to 14.5 mol % Al₂O₃, from 14 mol % to 17 mol % Na₂O, from 3.0 mol % to 5.5 mol % MgO, from 0 mol % to 1 mol % of one or more of Li₂O, CaO, B₂O₃, and/or P₂O₅, and from 0.0 mol % to 0.5 mol % K₂O. In further aspects, Al₂O₃—R₂O (e.g., Al₂O₃—Na₂O) can be from −6.0 mol % to −2.0 mol % or from −5.8 mol % to −2.2 mol %.

In aspects, the foldable substrate 201 and/or 403 can be optically transparent. As used herein, “optically transparent” or “optically clear” means an average transmittance of 70% or more in the wavelength range of 400 nm to 750 nm through a 1.0 mm thick piece of a material. In aspects, an “optically transparent material” or an “optically clear material” may have an average transmittance of 75% or more, 80% or more, 85% or more, or 90% or more, 91% or more, 92% or more, 94% or more, 96% or more in the wavelength range of 400 nm to 750 nm through a 1.0 mm thick piece of the material. The average transmittance in the wavelength range of 400 nm to 700 nm is calculated by measuring the transmittance of whole number wavelengths from 400 nm to 700 nm and averaging the measurements.

In aspects, the foldable substrate 201 and/or 403, in addition to being transparent, can also be colored transparent, opaque, colored opaque, translucent, or colored translucent. As used herein “opaque” and “translucent” can mean as follows: opacity is the measure of impenetrability to visible light. An opaque object is neither transparent (allowing all light to pass through) nor translucent (allowing some light to pass through). When light strikes an interface between two substances, in general some may be reflected, some absorbed, some scattered, and the rest transmitted. An opaque substance transmits very little light, and therefore reflects, scatters, or absorbs most of it. Opacity depends on the frequency of the light being considered. For instance, some kinds of glass, while transparent in the visual range, are largely opaque to ultraviolet light. Further, the colored transparent, colored opaque, and colored translucent can be anyone of a variety of colors including, for example, black, white, green, yellow, pink, red, blue, orange, purple, or brown.

In aspects, the foldable substrate 201 or 403 comprising a glass-based material can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Without wishing to be bound by theory, chemically strengthening the foldable substrate 201 or 403 can enable good impact resistance, good puncture resistance, and/or enable small bend radii, for example, with the compressive stress from the chemical strengthening counteracting bend-induced tensile stress on the outermost surface of the foldable substrate. A compressive stress region may extend into a portion of the foldable substrate for a depth called the depth of compression (DOC). As used herein, depth of compression means the depth at which the stress in the chemically strengthened substrates described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the foldable substrate is generated by exchanging potassium ions into the foldable substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the foldable substrate, and the article being measured is thicker than 400 μm, SCALP is used to measure the depth of compression and central tension (CT). Where the stress in the foldable substrate is generated by exchanging both potassium and sodium ions into the foldable substrate, and the article being measured is thicker than 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force-balanced and calibrated to the maximum central tension value provided by a SCALP measurement. As used herein, “depth of layer” (DOL) means the depth that the ions have exchanged into the substrate (e.g., sodium, potassium). Throughout the disclosure, DOL is measured in accordance with ASTM C1422. Without wishing to be bound by theory, a DOL is usually greater than or equal to the corresponding DOC. Through the disclosure, when the maximum central tension cannot be measured directly by SCALP (as when the article being measured is thinner than 400 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the foldable substrate 201 or 403 may comprise a first compressive stress region at the first major surface 203 or 413 that can extend to a first depth of compression from the first major surface 203 or 413. In aspects, the foldable substrate 201 or 403 may comprise a second compressive stress region at the second major surface 205 or 415 that can extend to a second depth of compression from the second major surface 205 or 415. In aspects, the first depth of compression and/or the second depth of compression as a percentage of the substrate thickness 207 or 409 can be 5% or more, 10% or more, 15% or more, 17% or more, 20% or more, 30% or less, 25% or less, 22% or less, 20% or less, 17% or less, or 15% or less. In aspects, the first depth of compression and/or the second depth of compression as a percentage of the substrate thickness 207 or 409 can range from 5% to 30%, from 10% to 25%, from 15% to 22%, from 17% to 20%, or any range or subrange therebetween. In aspects, the first depth of compression and/or the second depth of compression can be 5 μm or more, 10 μm or more, 15 μm or more, 20 μm or more, 25 μm or more, 30 μm or more, 100 μm or less, 75 μm or less, 60 μm or less, 45 μm or less, 30 μm or less, or 20 μm or less. In aspects, the first depth of compression and/or the second depth of compression can range from 5 μm to 100 μm, from 10 μm to 75 μm, from 15 μm to 60 μm, from 20 μm to 45 μm, from 20 μm to 30 μm, or any range or subrange therebetween. In aspects, the first depth of compression and/or the second depth of compression can be from greater than or equal to 5 μm to less than or equal to 25% of the substrate thickness, from greater than or equal to 10 μm to less than or equal to 22% of the substrate thickness, from greater than or equal to 15 μm to less than or equal to 20% of the substrate thickness, or any range or subrange therebetween. By providing a glass-based material for the foldable substrate comprising a first depth of compression and/or a second depth of compression, good impact and/or puncture resistance can be enabled. Alternatively, in aspects, the foldable substrate 201 and/or 403 can be substantially unstrengthened (e.g., unstressed, not chemically strengthened, not thermally strengthened). As used herein, substantially unstrengthened refers to a substrate comprising either no depth of layer or a depth of layer in a range from 0% to 5% of the substrate thickness.

In aspects, the first compressive stress region can comprise a maximum first compressive stress, and/or the second compressive stress region can comprise a maximum second compressive stress. In further aspects, the maximum first compressive stress and/or the maximum second compressive stress can be 100 MegaPascals (MPa) or more, 300 MPa or more, 500 MPa or more, 600 MPa or more, 700 MPa or more, 1,500 MPa or less, 1,200 MPa or less, 1,000 MPa or less, or 800 MPa or less. In further aspects, the maximum first compressive stress and/or the maximum second compressive stress can range from 100 MPa to 1,500 MPa, from 300 MPa to 1,200 MPa, from 400 MPa to 1,000 MPa, from 500 MPa to 1,000 MPa, from 600 MPa to 900 MPa, from 700 MPa to 800 MPa, or any range or subrange therebetween. In preferred aspects, the maximum first compressive stress and/or the maximum second compressive stress can be from greater than or equal to 100 MPa to less than or equal to 1,500 MPa, from greater than or equal to 500 MPa to less than or equal to 1,500 MPa, or from greater than or equal to 600 MPa to less than or equal to 1,000 MPa. By providing a maximum first compressive stress and/or a maximum second compressive stress from 100 MPa to 1,500 MPa, good impact and/or puncture resistance can be enabled.

In aspects, the foldable substrate 201 or 403 may comprise a tensile stress region, which can be positioned between the first compressive stress region and the second compressive stress region. The tensile stress region can comprise a maximum tensile stress. In further aspects, the maximum tensile stress can be 10 MPa or more, 20 MPa or more, 30 MPa or more, 100 MPa or less, 80 MPa or less, or 60 MPa or less. In further aspects, the maximum tensile stress can range from 10 MPa to 100 MPa, from 20 MPa to 80 MPa, from 30 MPa to 60 MPa, or any range or subrange therebetween. Providing a maximum tensile stress from 10 MPa to 100 MPa can enable good impact and/or puncture resistance.

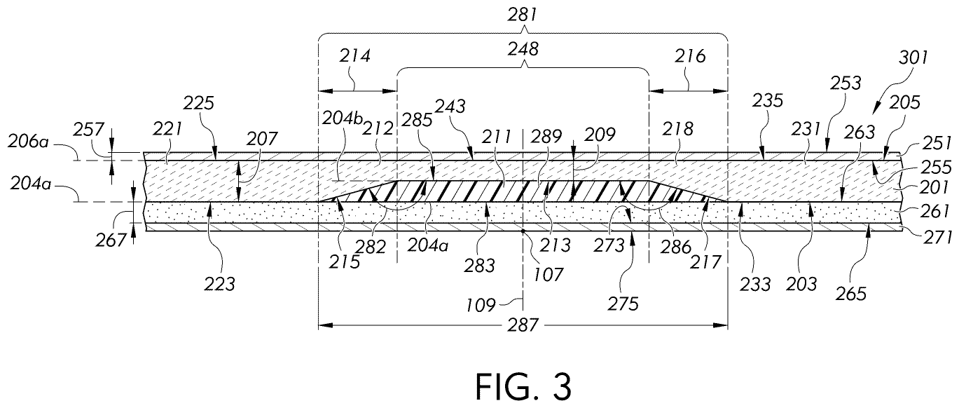

FIGS. 2-3 schematically illustrate foldable apparatus 101 and/or 301 comprising the foldable substrate 201 having one or more recesses 211 and/or 241, where FIGS. 2-3 show the foldable apparatus 101 and/or 301 in a flat configuration and FIGS. 8-9 show the foldable apparatus 701 and/or 901 having the foldable substrate 201 in a folded configuration in accordance with aspects of the present disclosure, although foldable substrate 403 may not comprise any recesses in other aspects of the present disclosure. In aspects, as shown in FIGS. 2-3, the foldable apparatus 101 and/or 301 comprises a first portion 221, a second portion 231, and a central portion 281 positioned between the first portion 221 and the second portion 231, where the one or more recesses 211 and/or 241 is formed in the central portion 281. In aspects, as shown, the foldable apparatus 101 and/or 301 can comprise a release liner 271 although other substrates (e.g., a glass-based substrate and/or display device discussed throughout the application) may be used in further aspects rather than with the illustrated release liner 271. In aspects, as shown in FIG. 3, the foldable apparatus 301 can comprise an adhesive layer 261. In aspects, as shown in FIGS. 2-3, foldable apparatus 101 and/or 301 can comprise a polymer-based portion 289 and/or 299, which can be positioned in a corresponding recess 211 and/or 241. In further aspects, as shown in FIGS. 2-3, the foldable substrate 201 can comprise a first recess 211 (e.g., defined in part by the first central surface area 213) opposite the hard coating 251. Alternatively or additionally, as shown in FIG. 2, the foldable substrate 201 can comprise a second recess 241 (e.g., defined in part by the second central surface area 243) that the hard coating is disposed over, for example, with a polymer-based portion 289 positioned in the second recess 241. It is to be understood that any of the foldable apparatus of the disclosure can comprise a second substrate (e.g., a glass-based substrate), a release liner 271, a display device, a hard coating 251, an adhesive layer 261, and/or a polymer-based portion 289 and/or 299 in addition to the foldable substrate 201 and/or 403 and the hard coating 251 disposed over (e.g., disposed on, contacting) the foldable substrate 201 (e.g., second major surface 205).

In further aspects, as shown in FIGS. 2-3, the first portion 221 of the foldable substrate 201 can comprise a first surface area 223 and a second surface area 225 opposite the first surface area 223. In further aspects, as shown, the first surface area 223 can comprise a planar surface, and/or the second surface area 225 of the first portion 221 can comprise a planar surface, for example, extending along the first plane 204a when the first major surface 203 is planar (excluding the central portion 281). In further aspects, as shown, the second surface area 225 can be parallel to the first surface area 223, for example, extending along the second plane 206a when the second major surface 205 is planar (excluding the central portion 281 in FIG. 2). As shown, the first major surface 203 comprises the first surface area 223 and the third surface area 233, and the second major surface 205 comprises the second surface area 225 and the fourth surface area 235. In aspects, the substrate thickness 207 can correspond to the distance between the first surface area 223 of the first portion 221 and the second surface area 225 of the first portion 221 and/or the distance between the third surface area 233 of the second portion 231 and the fourth surface area 235 of the second portion 231. In further aspects, the substrate thickness 207 can be substantially uniform across the first surface area 223 (e.g., first portion 221) and/or the third surface area 233 (e.g., second portion 231), for example, across its corresponding length (i.e., in the direction 106 of the length 105 of the foldable apparatus) and/or its corresponding width (i.e., in the direction 104 of the width 103 of the foldable apparatus). In further aspects, as shown in FIGS. 2-3, the thickness of the first portion and the thickness of the second portion can be equal to the substrate thickness 207.

In further aspects, as shown in FIGS. 2-3, the foldable substrate 201 can comprise a central portion 281 containing at least one recess 211 or 241 positioned between the first portion 221 and the second portion 231. In further aspects, the central portion 281 comprises a first central surface area 213 and a second central surface area 243 opposite the first central surface area 213. As shown, the first central surface area 213 of the central portion 281 can be positioned between the first surface area 223 and the third surface area 233, and/or the second central surface area 243 of the central portion 281 can be positioned between the second surface area 225 and the fourth surface area 235. In further aspects, the first central surface area 213 and/or the second central surface area 243 can correspond to a central region 248 of the central portion 281. In further aspects, as shown, the first central surface area 213 can extend along a third plane 204b and/or the second central surface area 243 can extend along a fourth plane 206b (see FIG. 2) when the foldable apparatus 101 and/or 301 is in a flat configuration. In even further aspects, the third plane 204b can be parallel to the fourth plane 206b, which can also be parallel to the first plane 204a and/or the second plane 206a in even further aspects.

As used herein, a central thickness 209 is defined as an average distance between the first central surface area 213 and the second central surface area 243 (e.g., in the central region 248). In aspects, as shown in FIGS. 2-3, the central thickness 209 can be less than the substrate thickness 207, for example, by 30 μm or more, 40 μm or more, 50 μm or more, or 75 μm or more, (e.g., from 30 μm to 250 μm, from 40 μm to 200 μm, from 50 μm to 150 μm, from 75 μm to 100 μm, or any range or subrange therebetween). In further aspects, the central thickness 209 can be 1 μm or more, 5 μm or more, 10 μm or more, 20 μm or more, 25 μm or more, 40 μm or more, 60 μm or more, 80 μm or more, 200 μm or less, 150 μm or less, 120 μm or less, 100 μm or less, 80 μm or less, 60 μm or less, 40 μm or less, or 30 μm or less. In further aspects, the central thickness 209 can be in a range from 1 μm to 200 μm, from 5 μm to 150 μm, from 10 μm to 120 μm, from 20 μm to 100 μm, from 25 μm to 80 μm, from 40 μm to 60 μm, or any range or subrange therebetween. In preferred aspects, the central thickness 209 can be in a range from 10 μm to 200 μm, from 25 μm to 100 μm, or from 25 μm to 60 μm. In further aspects, the central thickness 209 as a percentage of the substrate thickness 207 can be 0.5% or more, 2% or more, 5% or more, 10% or more, 15% or more, 20% or more, 25% or more, 30% or more, 50% or less, 45% or less, 40% or less, 35% or less, 30% or less, 25% or less, 20% or less, 15% or less, 13% or less, 10% or less, or 8% or less. In aspects, the central thickness 209 as a percentage of the substrate thickness 207 can be in a range from 0.5% to 50%, from 2% to 45%, from 5% to 40%, from 10% to 35%, from 15% to 30%, from 20% to 25%, or any range or subrange therebetween. In preferred aspects, the central thickness 209 as a percentage of the substrate thickness 207 can be from 0.5% to 50%, from 5% to 45%, or from 10% to 30%. By providing the first central surface area 213 of the central portion 281 extending along the third plane 204b parallel to the second central surface area 243 of the central portion 281 extending along the fourth plane 206b, a uniform central thickness 209 may extend across the central portion 281 that can provide enhanced folding performance at a predetermined thickness for the central thickness 209. A uniform central thickness 209 across the central portion 281 can improve folding performance by preventing stress concentrations that would occur if a portion of the central portion 281 was thinner than the rest of the central portion 281.

In even further aspects, as shown in FIGS. 2-3, the first central surface area 213 can be recessed from the first major surface 203 by a first distance 219 and define the first recess 211 (e.g., between the first central surface area 213 and the first plane 204a). In further aspects, the first distance 219 that the first central surface area 213 is recessed from the first plane 204a can be 30 μm or more, 40 μm or more, 50 μm or more, 60 μm or more, 75 μm or more, 100 μm or more, 200 μm or less, 150 μm or less, 125 μm or less, 100 μm or less, 80 μm or less, 60 μm or less, or 50 μm or less. In further aspects, the first distance 219 can be in a range from 30 μm to 200 μm, from 40 μm to 150 mm, from 50 μm to 125 μm, from 75 μm to 100 μm, or any range or subrange therebetween. In further aspects, the first distance 219 that the first central surface area 213 is recessed from the first plane 204a as a percentage of the substrate thickness 207 can be 1% or more, 5% or more, 10% or more, 15% or more, 20% or more, 25% or more, 30% or more, 35% or more, 40% or more, 45% or more, 50% or more, 55% or more, 60% or more, 65% or more, 70% or more, 90% or less, 85% or less, 80% or less, 75% or less, 70% or less, 65% or less, 60% or less, 55% or less, 50% or less, 40% or less, 35% or less, or 30% or less. In further aspects, the first distance 219 as a percentage of the substrate thickness 207 can be in a range from 1% to 90%, from 5% to 85%, from 10% to 80%, from 15% to 75%, from 20% to 70%, from 25% to 65%, from 30% to 60%, from 35% to 55%, from 40% to 50%, or any range or subrange therebetween. In preferred aspects, the first distance 219 as a percentage of the substrate thickness 207 can be in a range from 1% to 90%, from 20% to 75%, or from 30% to 50%. Additionally or alternatively, as shown in FIG. 2, the second central surface area 243 can be recessed from the second major surface 205 (e.g., second plane 206a) by a second distance 249 and define the second recess 241 (e.g., between the second central surface area 243 and the second plane 206a). In further aspects, the second distance 249 can be within one or more of the ranges discussed above for the first distance 219 (both the distance in μm and a percentage of the substrate thickness 207). In even further aspects, the first distance 219 can be equal to the second distance 249. Alternatively, the first distance can be greater than the second distance, Alternatively, in aspects, as shown in FIGS. 2, the second central surface area 243 can be coplanar with the second surface area 225 and/or the fourth surface area 235, for example, forming a planar second major surface 205 extending along the second plane 206a (see also second major surface 415 in FIGS. 4-6).

In further aspects, as shown in FIGS. 2-3, the central portion 281 can comprise a first transition region 212 comprising a first transition surface area 215 extending between the first surface area 223 and the first central surface area 213. In further aspects, as shown, a first transition width 214 of the first transition region 212 can be the minimum distance in a direction 106 of the length 105 (see FIG. 1) between a portion of the first central surface area 213 extending along the third plane 204b and a portion of the first surface area 223 (e.g., extending along the first plane 204a). In even further aspects, the first transition width 214 can be 1.5 mm or more, 1.7 mm or more, 2.0 mm or more, 2.2 mm or more, 2.5 mm or more, 2.7 mm or more, 3.0 mm or more, 3.2 mm or more, 3.5 mm or more, 6.0 mm or less, 5.5 mm or less, 5.0 mm or less, 4.5 mm or less, 4.0 mm or less, 3.8 mm or less, 3.5 mm or less, 3.2 mm or less, 3.0 mm or less, 2.8 mm or less, or 2.5 mm or less. In even further aspects, the first transition width 214 can be in a range from 1.5 mm to 6.0 mm, from 1.7 mm to 5.7 mm, from 2.0 mm to 5.5 mm, from 2.0 mm to 4.5 mm, from 2.2 mm to 4.0 mm, from 2.5 mm to 3.8 mm, 2.7 mm to 3.5 mm, from 3.0 mm to 3.2 mm, or any range or subrange therebetween. Providing a transition width from 1.5 mm to 6 mm for the first transition region and/or the second transition region can decrease a visibility of the transition region.

In further aspects, as shown in FIG. 2, the first transition region 212 can comprise a second transition surface area 245 extending between the second surface area 225 and the second central surface area 243. In further aspects, a width of the second transition surface area 245 is the minimum distance in a direction 106 of the length 105 (see FIG. 1) between a portion of the second central surface area 243 extending along the fourth plane 206b and a portion of the second surface area 225. In even further aspects, the width of the second transition surface area 245 can be substantially equal to the first transition width 214 of the first transition region 212. In aspects, as shown in FIG. 4, the portion of the first transition region 212 extending between the second surface area 225 and the second central surface area 243 can be coplanar with one or both surface areas.

In aspects, as shown in FIGS. 2-3, a thickness of the first transition region 212 can decrease between the substrate thickness 207 of the first portion 221 and the central thickness 209 of the central portion 281. In further aspects, as shown, a thickness of the first transition region 212 can smoothly decrease, monotonically decrease, and/or smoothly and monotonically decrease between the substrate thickness 207 of the first portion 221 and the central thickness 209 of the central portion 281. As used herein, a thickness decreases smoothly if changes in the cross-sectional area are smooth (e.g., gradual) rather than abrupt (e.g., step) changes in thickness. As used herein, a thickness decreases monotonically in a direction if the thickness decreases for a portion and for the rest of the time either stays the same, decreases, or a combination thereof (i.e., the thickness decreases but never increases in the direction). Providing a smooth shape of the first transition region and/or the second transition region can reduce optical distortions. Providing a monotonically decreasing thickness of the first transition region and/or the second transition region can reduce an incidence of mechanical instabilities and/or decrease a visibility of the transition region. In aspects, as shown in FIGS. 2-3, the first transition surface area 215 can comprise a linearly inclined surface extending between the first central surface area 213 and the first surface area 223. In aspects, although not shown, the first transition surface area can comprise a concave up shape, for example, with a local slope of the first transition surface area smoothly transitioning to a slope of the first central surface area 213 while a local slope of the first transition surface area is substantially different from a slope of the first surface area 223. In aspects, although not shown, the first transition surface area can comprise a sigmoid shape. In aspects, although not shown, a local slope of the first transition surface area can be greater at a midpoint of the first transition surface area than where the first transition surface area meets the first central surface area 213 and where the first transition surface area meets the first surface area 223. In aspects, although not shown, the first transition surface area can comprise a convex up shape, for example, with a local slope of the first transition surface area smoothly transitioning to a slope of the first surface area 223 while a local slope of the first transition surface area is substantially different from a slope of the first central surface area 213. In aspects, the second transition surface area can comprise one of the shapes or properties discussed above in this paragraph for the first transition surface area. For example, as shown in FIG. 2, the second transition surface area 245 can comprise a linearly inclined surface extending between the second central surface area 243 and the second surface area 225.

In aspects, as shown in FIGS. 2-5 and 33, a thickness of the first transition region 212 can decrease at a constant rate (e.g., linearly change) from the substrate thickness 207 to the central thickness 209. In aspects, although not shown, a thickness of the first transition region can decrease slower where the first transition surface area meets the first central surface area 213 than at a midpoint of the first transition region and/or than where the first transition surface area meets the first surface area 223 (e.g., first portion 221). In aspects, although not shown, a thickness of the first transition region can decrease faster where the first transition surface area meets the first central surface area 213 than at a midpoint of the first transition region and/or than where the first transition surface area meets the first surface area 223. Providing a non-uniform slope of a surface area of the first transition region and/or the second transition region can reduce an amount of the corresponding transition region comprising intermediate thicknesses, for example, comprising a chemical strengthening induced expansion strain less than a portion of the corresponding transition region closer to the first central surface area and/or the second central surface area and/or than the first central surface area and/or the second central surface area.

Throughout the disclosure, an “average angle” of a transition surface area relative to a central surface area is measured as an angle between a transition surface area and a central surface area. An “average angle” is calculated for a location on the corresponding transition surface area relative to the corresponding central surface area with the location of the corresponding central surface area approximated as a plane fitted from measurements at 20 locations evenly spaced over the corresponding central surface area in the direction 106 of the length 105. The “average angle” measured is an external angle for the foldable substrate, meaning that it extends from the plane fitted to the corresponding central surface area to the location on the corresponding transition surface area without passing through the material of the foldable substrate other than an incidental amount at the endpoints. The average angle is calculated from 10 locations on the corresponding transition surface area that are located in a region comprising 80% of a distance that the corresponding central surface area is recessed from the corresponding major surface with the region centered at the midpoint between the corresponding central surface area and the corresponding major surface in the direction 202 of the thickness (e.g., substrate thickness 207, central thickness 209). In aspects, as FIGS. 2-3, the first transition surface area 215 of the first transition region 212 extends between the first surface area 223 and the first central surface area 213 with a first average angle 282 relative to the first central surface area 213. As described above, the first average angle 282 is an external angle because it does not pass through the material of the foldable substrate 201 other than an incidental amount at the endpoints. In further aspects, the first average angle 282 can be 176.0° or more, 176.3° or more, 176.5° or more, 176.7° or more, 177.0° or more, 177.3° or more, 177.5° or more, 177.6° or more, 177.7° or more, 177.8° or more, 179.9° or less, 179.7° or less, 179.5° or less, 179.3° or less, 179.0° or less, 178.7° or less, 178.5° or less, 178.3° or less, 178.0° or less, 177.7° or less, 177.5° or less, 177.3° or less, or 177.0° or less. In further aspects, the first average angle 282 can be in a range from 176.0° to 179.9°, from 176.3° to 179.7°, from 176.5° to 179.5°, from 176.7° to 179.3°, from 177.0° to 179.0°, from 177.3° to 178.5°, from 177.5° to 178.3°, from 177.7° to 178.0°, or any range or subrange therebetween. In aspects, as shown in FIGS. 2-3, the third transition surface area 217 of the second transition region 218 extends between the third surface area 233 and the first central surface area 213 with a third average angle 286 relative to the first central surface area 213. In further aspects, the third average angle 286 can be within one or more of the ranges discussed above for the first average angle 282. In further aspects, the first average angle 282 can be equal to the third average angle 286.

In further aspects, as shown in FIGS. 2-3, the central portion 281 of the foldable substrate 201 can comprise a second transition region 218 comprising a third transition surface area 217 extending between the third surface area 233 and the first central surface area 213. In further aspects, as shown, a second transition width 216 of the second transition region 218 can be measured as the minimum distance in a direction 106 of the length 105 (see FIG. 1) between a portion of the first central surface area 213 extending along the third plane 204b and a portion of the third surface area 233, which can be within one or more of the ranges discussed above for the first transition width 214 and/or substantially equal to the first transition width 214. In further aspects, as shown in FIG. 2, the second transition region 218 can comprise a fourth transition surface area 247 extending between the fourth surface area 235 and the second central surface area 243. In further aspects, a width of the fourth transition surface area 247 can be measured as the minimum distance in a direction 106 of the length 105 (see FIG. 1) between a portion of the second central surface area 243 extending along the fourth plane 206b and a portion of the fourth surface area 235. In even further aspects, the width of the fourth transition surface area 247 can be substantially equal to the second transition width 216. In aspects, as shown in FIG. 2, a thickness of the second transition region 218 can decrease between the substrate thickness 207 of the second portion 231 and the central thickness 209 of the central portion 281. In further aspects, as shown, a thickness of the first transition region 212 can smoothly decrease, monotonically decrease, or smoothly and monotonically decrease between the substrate thickness 207 of the second portion 231 and the central thickness 209 of the central portion 281. In aspects, as shown in FIG. 4, the portion of the second transition region 218 extending between the fourth surface area 235 and the second central surface area 243 can be coplanar with one or both surface areas. In further aspects, as shown in FIGS. 2-3, the third transition surface area 217 can comprise a linearly inclined surface extending between the first central surface area 213 and the third surface area 233. In further aspects, the third transition surface area 217 and/or the fourth transition surface area 247 can comprise one of the shapes or properties discussed above with reference to the first transition surface area.

In further aspects, as shown in FIG. 2, the second transition surface area 245 of the first transition region 212 extends between the second surface area 225 and the second central surface area 243 with a second average angle 284 relative to the second central surface area 243. In further aspects, the second average angle 284 can be within one or more of the ranges discussed above for the first average angle 282. In further aspects, the first average angle 282 can be substantially equal to the second average angle 284. Providing an average angle within one of the above-mentioned ranges can provide reduced visibility of the transition region. In aspects, as shown in FIG. 2, the fourth transition surface area 247 of the second transition region 218 extends between the fourth surface area 235 and the second central surface area 243 with a fourth average angle 288 relative to the second central surface area 243. In further aspects, the fourth average angle 288 can be within one or more of the ranges discussed above for the second average angle 284. In further aspects, the second average angle 284 can be substantially equal to the fourth average angle 288. In further aspects, the first average angle 282 and/or the third average angle 286 can be substantially equal to the fourth average angle 288.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other.

As shown in FIG. 3, the foldable apparatus 301 can comprise an adhesive layer 261. As shown, the adhesive layer 261 comprises a first contact surface 263 and a second contact surface 265 opposite the first contact surface 263. In further aspects, as shown in FIG. 3, the second contact surface 265 and/or the first contact surface 263 can comprise a planar surface An adhesive thickness 267 of the adhesive layer 261 can be defined as a minimum distance between the first contact surface 263 and the second contact surface 265. In aspects, the adhesive thickness 267 of the adhesive layer 261 can be 1 μm or more, 5 μm or more, 10 μm or more, 15 μm or more, 100 μm or less, 60 μm or less, 30 μm or less, or 20 μm or less. In aspects, the adhesive thickness 267 of the adhesive layer 261 can be in a range from 1 μm to 100 μm, from 5 μm to 60 μm, from 10 μm to 30 μm, from 15 μm to 20 μm, or any range or subrange therebetween. In further aspects, as shown in FIG. 3, the second contact surface 265 of the adhesive layer 261 can face and/or contact the first major surface 273 of a release liner 271 (described below). In further aspects, as shown, the first contact surface 263 of the adhesive layer 261 can face and/or contact the first surface area 223 of the first portion 221 and/or the third surface area 233 of the second portion 231. In further aspects, as shown, the first contact surface 263 of the adhesive layer 261 can face the first central surface area 213 of the central portion 281. In further aspects, although not shown, the first contact surface 263 of the adhesive layer 261 can contact the second central surface area 243 of the central portion 281, for example by filling the region (e.g., first recess 211) indicated as occupied by the second polymer-based portion 299 in FIG. 2.

In aspects, the adhesive layer 261 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). In further aspects, the adhesive layer 261 can comprise an optically clear adhesive. In even further aspects, the optically clear adhesive can comprise one or more optically transparent polymers: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In even further aspects, the optically clear adhesive can comprise, but is not limited to, acrylic adhesives, for example, 3M 8212 adhesive, or an optically transparent liquid adhesive, for example, a LOCTITE optically transparent liquid adhesive. Exemplary aspects of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel. In aspects, the adhesive layer 261 can comprise an elastic modulus of 0.001 MegaPascals (MPa) or more, 0.01 MPa or more, 0.1 MPa or more, 1 MPa or less, 0.5 MPa or less, 0.2 MPa or less, 0.1 MPa or less, or 0.05 MPa or less. In aspects, the adhesive layer 261 can comprise an elastic modulus in a range from 0.001 MPa to 1 MPa, from 0.01 MPa to 0.5 MPa, from 0.05 MPa to 0.5 MPa, from 0.1 MPa to 0.2 MPa, or any range or subrange therebetween. In aspects, the adhesive layer can comprise an elastic modulus within one or more of the ranges discussed below for the elastic modulus of the polymer-based portions 289 and/or 299.

As shown in FIGS. 2-3, the polymer-based portion 289 and/or 299 of the foldable apparatus 101 can be positioned between the first portion 221 and the second portion 231. In further aspects, as shown, the polymer-based portion can comprise a first polymer-based portion 289 at least partially positioned in and/or filling the first recess 211 and/or a second polymer-based portion 299 at least partially positioned in and/or filling the second recess 241. In aspects, although not shown, the first recess and/or the second recess may not be totally filled, for example, to leave room for electronic devices and/or mechanical devices. In further aspects, although not shown, a portion of the first polymer-based portion 289 can be positioned in the first recess 211 of FIGS. 2-3 and another, contiguous portion of the first polymer-based portion 289 can extend beyond the corresponding recess (e.g., the first polymer-based portion 289 can further extend beyond the first plane 204a in FIGS. 2-3) with an additional thickness (e.g., 5 μm or more) disposed over the first major surface (e.g., in the location occupied by the adhesive layer 261 in FIG. 3). In further aspects, FIGS. 2-3, the first polymer-based portion 289 can comprise a third contact surface 283 and a fourth contact surface 285 opposite the third contact surface 283. In even further aspects, as shown, the third contact surface 283 can comprise a planar surface, for example, substantially coplanar (e.g., extend along a common plane, first plane 204a, substantially flush) with the first surface area 223 and the third surface area 233 (e.g., first major surface 203). In even further aspects, as shown, the third contact surface can face and/or contact the release liner 271 and/or the adhesive layer 261 with the understanding that the fourth contact surface can face a display device (e.g., in place of the release liner). In even further aspects, the fourth contact surface can face and/or contact the first central surface area 213. In further aspects, as shown in FIG. 2, the second polymer-based portion 299 can comprise a fifth contact surface 293 and a sixth contact surface 295 opposite the fifth contact surface 293. In even further aspects, as shown, the fifth contact surface 293 can contact the second central surface area 243. In even further aspects, as shown, the fifth contact surface 293 can comprise a planar surface, for example, being substantially coplanar (e.g., extend along a common plane with the fourth plane 206b) with the second central surface area 243. In even further aspects, as shown, the sixth contact surface 295 can comprise a planar surface, for example, substantially coplanar (e.g., extend along a common plane, second plane 206a, substantially flush) with the second surface area 225 and the fourth surface area 235 (e.g., second major surface 205). In even further aspects, the sixth contact surface 295 can face and/or contact the fourth major surface 255 of the hard coating 251.

In aspects, the polymer-based portion 289 and/or 299 comprises a polymer (e.g., optically transparent polymer). In further aspects, the polymer-based portion 289 and/or 299 can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further aspects, the polymer-based portion 289 and/or 299 comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). In aspects, the polymer-based portion 289 and/or 299 can further comprise nanoparticles, for example, carbon black, carbon nanotubes, silica nanoparticles, or nanoparticles comprising a polymer. In aspects, the polymer-based portion can further comprise fibers to form a polymer-fiber composite. In further aspects, the polymer-based portion 289 and/or 299 can comprise an elastic modulus of 0.001 MegaPascals (MPa) or more, 0.01 MPa or more, 1 MPa or more, 10 MPa or more, 20 MPa or more, 100 MPa or more, 200 MPa or more, 1,000 MPa or more, 5,000 MPa or less, 3,000 MPa or less, 1,000 MPa or less, 500 MPa or less, or 200 MPa or less. In aspects, the polymer-based portion 289 and/or 299 can comprise an elastic modulus in a range from 0.001 MPa to 5,000 MPa, from 0.01 MPa to 3,000 MPa, from 0.01 MPa to 1,000 MPa, from 1 MPa to 500 MPa, from 10 MPa to 200 MPa, from 100 MPa to 200 MPa, or any range or subrange therebetween. In even further aspects, the polymer-based portion 289 and/or 299 can comprise an elastic modulus in a range from 1 MPa to 5,000 MPa, from 10 MPa to 5,000 MPa, from 10 MPa to 1,000 MPa, from 20 MPa to 1,000 MPa, from 20 MPa to 200 MPa, or any range or subrange therebetween. In even further aspects, the elastic modulus of the polymer-based portion 289 and/or 299 (e.g., especially the second polymer-based portion 299) can be in a range from 1 GPa to 20 GPa, from 1 GPa to 18 GPa, from 1 GPa to 10 GPa, from 1 GPa to 5 GPa, from 1 GPa to 3 GPa, or any range or subrange therebetween.

Providing a first recess opposite a second recess can reduce a bend-induced strain of a material positioned in the first recess and/or second recess compared to a single recess with a surface recessed by the sum of the first distance and the second distance. Providing a reduced bend-induced strain of a material positioned in the first recess and/or the second recess can enable the use of a wider range of materials because of the reduced strain requirements for the material. Additionally, controlling properties of a material (e.g., first polymer-based portion 289) positioned in a recess and/or disposed thereon (e.g., hard coating 251) can control the position of a neutral axis of the foldable apparatus and/or foldable substrates, which can reduce (e.g., mitigate, eliminate) the incidence of mechanical instabilities, apparatus fatigue, and/or apparatus failure. Providing a first recess opposite a second recess can reduce the strain encountered by the polymer-based portion or other material (e.g., adhesive layer) in the recess (e.g., from 0% to 50% reduction). Consequently, requirements for a strain at yield of the polymer-based portion can be relaxed.

In aspects, as shown in FIGS. 2-3, the foldable apparatus 101 or 301 can comprise the release liner 271 although other substrates (e.g., glass-based substrate, display device) may be used in further aspects rather than the illustrated release liner 271. In further aspects, as shown in FIG. 3, the release liner 271 can be disposed over and/or contact the adhesive layer 261. In further aspects, as shown in FIG. 2, the release liner 271 can be disposed over and/or contact the first polymer-based portion 289. The release liner 271 comprises a first major surface 273 and a second major surface 275 opposite the first major surface 273, where the first major surface 273 faces the foldable substrate 201 (e.g., first major surface 203). In aspects, as shown, the second major surface 275 of the release liner 271, or another substrate, can comprise a planar surface. A substrate comprising the release liner 271 can comprise a paper and/or a polymer. Exemplary aspects of paper comprise kraft paper, machine-finished paper, poly-coated paper (e.g., polymer-coated, glassine paper, siliconized paper), or clay-coated paper. Exemplary aspects of polymers comprise polyesters (e.g., polyethylene terephthalate (PET)) and polyolefins (e.g., low-density polyethylene (LDPE), high-density polyethylene (HDPE), polypropylene (PP)). In aspects, although not shown, the foldable apparatus can comprise an additional substrate (e.g., instead of the release liner 271 discussed above). In further aspects, the additional substrate can comprise a glass-based material, a stiff polymer-based portion (e.g., PET, PMMA, PI), a display device, and/or a touch sensor.

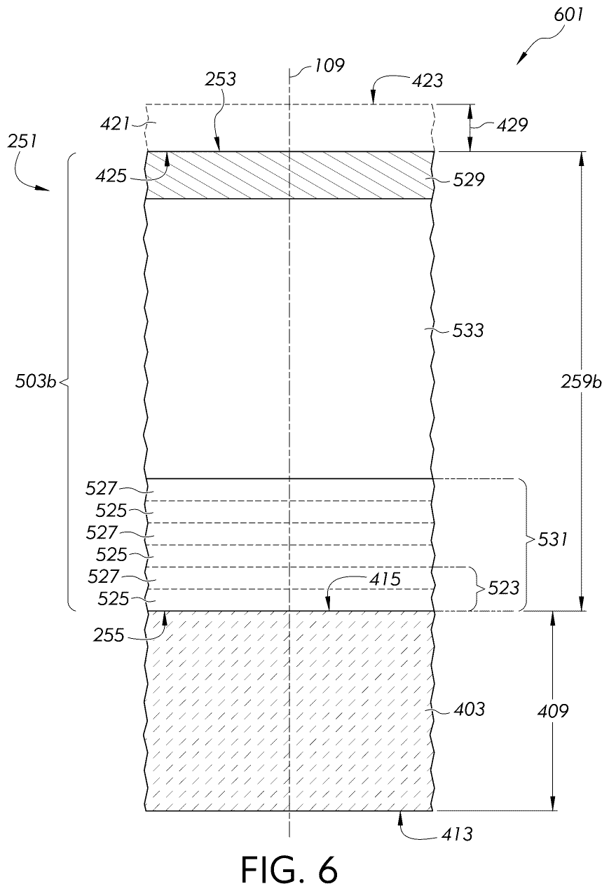

In aspects, as shown in FIGS. 1-6 and 8-9, the foldable apparatus 101, 301, 401, 501, 601, 701, and/or 901 comprises a hard coating 251 disposed over (e.g., disposed on, contacting) the foldable substrate 201 or 403 (e.g., second major surface 205 or 415). In further aspects, as shown in FIGS. 5-6, the hard coating 251 can comprise an optical stack 503a or 503b. As shown, the hard coating 251 and/or the optical stack 503a or 503b can comprise a third major surface 253 and a fourth major surface 255 opposite the third major surface 253, for example, where the fourth major surface 255 faces and/or contacts the second major surface 205 or 415 of the foldable substrate 201 or 403. A stack thickness 257, 259a, and/or 259b of the hard coating 251 and/or the optical stack 503a and/or 503b is defined as an average distance between the third major surface 253 and the fourth major surface 255. In aspects, the stack thickness 257, 259a, and/or 259b can be 10 nanometers (nm) or more, 50 nm or more, 100 nm or more, 300 nm or more, 500 nm or more, 700 nm or more, 1 μm or more, 10 μm or less, 5 μm or less, 2 μm or less, or 1 μm or less. In aspects, the stack thickness 257, 259a, and/or 259b can range from 10 nm to 10 μm, from 50 nm to 5 μm, from 100 nm to 2 μm, from 300 nm to 1 μm, from 500 nm to 1 μm, or any range or subrange therebetween. In aspects, the stack thickness 257, 259a, and/or 259b (corresponding to a physical thickness of the optical stack 503a and/or 503b and/or the hard coating 251—in contrast to the optical thickness discussed below) can be in a range from 50 nm to less 500 nm, from 75 nm to 490 nm, from 100 nm to 480 nm, from 125 nm to 475 nm, from 150 nm to 450 nm, from 175 nm to 425 nm, from 200 nm to 400 nm, from 225 nm to 375 nm, from 250 nm to 350 nm, from 250 nm to 340 nm, or any range or subrange therebetween. In further aspects, the stack thickness 257, 259a, and/or 259b can range from 0.5 μm to 3 μm, from 1 μm to 3 μm, from 1.2 μm to 3 μm, from 1.5 μm to 3 μm from 2 μm to 2.6 μm, or any range or subrange therebetween. In exemplary aspects, the stack thickness 257, 259a, and/or 259b can be from greater than or equal to 10 nm to less than or equal to 10 μm, from greater than or equal to 50 nm to less than or equal to 5 μm, or from greater than or equal to 50 nm to less than or equal to 500 nm.

In further aspects, the hard coating 251 and/or optical stack 503a or 503b can comprise an inorganic material (and/or consist of inorganic materials). As used herein, inorganic materials are free of carbon-carbon bonds. In even further aspects, the inorganic material of the hard coating 251 and/or optical stack 503a or 503b can include (or consist) of inorganic materials selected from a group consisting of a silicon-containing oxide, a silicon-containing nitride, a silicon-containing oxynitride, an aluminum-containing nitride, an aluminum-containing oxynitride, niobia, or combination thereof. In further aspects, the optical stack 503a or 503b can comprise an anti-reflective (AR) coating, a band-pass filter coating, an edge neutral mirror, a beam splitter coating, a multi-layer high-reflectance coating, and/or an edge filter coating. For example, as shown in FIGS. 4-6, the anti-reflective coating of the optical stack 503a or 503b can be positioned between the anti-fingerprint coating 421 (if present; otherwise forming an exterior surface of the foldable apparatus) and the foldable substrate 201 or 403. In even further aspects, the optical stack 503a or 503b (e.g., anti-reflective coating) can comprise two or more layers with differing refractive index values, for example, with a first low refractive index (RI) from 1.3 to 1.6 and a second high refractive index (RI) from 1.6 to 3.0. In still further aspects, the two or more layers of the optical stack 503a or 503b can form an alternating set of layers, for example, 2 sets or more, 3 sets or more, 5 sets or more, or 10 sets or more, for example, from 2 to 15 periods, from 2 to 10 periods, from 2 to 12 periods, from 3 to 8 periods, from 3 to 6 periods, or any range or subrange therebetween.

In aspects, as shown in FIG. 6, the foldable apparatus 601 comprises optical stack 503b comprising an optical film 531, a scratch-resistant layer 533, and an optional capping layer 529. In aspects, the optical stack 503b can include the scratch resistant coating, anti-reflective coating, and/or optical film structure described in U.S. Pat. No. 9,328,016, issued May 3, 2016, U.S. Pat. No. 9,684,097, issued Jun. 20, 2017, U.S. Pat. No. 9,703,011, issued Jul. 11, 2017, U.S. Pat. No. 9,079,802, issued Jul. 14, 2015, U.S. Pat. No. 9,726,786, issued Aug. 8, 2017, U.S. Pat. No. 10,416,352, issued Sep. 17, 2019, which are incorporated by reference in their entirety. For example, the optical stack 503b can be an anti-reflective coating and/or a scratch-resistant coating.

In aspects, with reference to FIGS. 5-6, the hard coating 251 (e.g., optical stack 503a or 503b) of the foldable apparatus 501 or 601 comprises a plurality of a silicon-containing oxide, a silicon-containing nitride, a silicon-containing oxynitride, and/or niobia-containing layers. For example, the optical stack 503a can be an anti-reflective coating (e.g., optical film 531 in FIG. 6). As shown, the optical stack 503a or 503b can comprise one or more periods 513 or 523 comprising two or more layers with different refractive indices, for example, a first low RI layer 515a or 525 and a second high RI layer 517a or 527. For example, the optical stack 503a shown in FIG. 5 has 2 periods 513 comprising first low RI layers 515a and 515b (L) and a second high RI layers 517a and 517b (H) that alternate in the following sequence of layers: L/H/L/H, although H/L/H/L could be provided in other aspects. For example, the optical stack 503b shown in FIG. 6 has 3 periods 523 forming the optical film 531 with alternating first low RI layers 525 and second high RI layers 527. In even further aspects, the optical film 531 can comprise any number of periods, for example, within one or more of the ranges discussed above for the optical stack 503a and/or 503b. An absolute value of a difference between the first low RI layer 515a or 525 and a second high RI layer 517a or 527 can be 0.01 or more, 0.05 or more, 0.1 or more, or even 0.2 or more. Exemplary materials for the first low RI layer 515a or 525 include SiO₂, Al₂O₃, GeO₂, SiO₂, AlOₓN_{y}, SiOₓN_{y}, SiᵤAlᵥOₓN_{y}, MgO, and MgAl₂O₄. In preferred aspects, the first low RI layer 515a or 525 can comprise (or consist of) a silicon-containing oxide (e.g., SiO₂). Exemplary materials for the second high RI layer 517a or 527 include SiᵤAlᵥOₓN_{y}, AlN, oxygen-doped SiNₓ, SiNₓ, Si₃N₄, AlOₓN_{y}, SiOₓN_{y}, Ta₂O₅, Nb₂O₅, HfO₂, TiO₂, ZrO₂, Y₂O₃, ZrO₂, Al₂O₃, and diamond-like carbon. In preferred aspects, the second high RI layer 517a or 527 can comprise (or consist) of an oxynitride (e.g., SiOₓN_{y}). The oxygen content of the materials for the high RI layer(s) 517a or 527 may be minimized, especially in SiNₓ or AlNₓ materials. The foregoing materials may be hydrogenated up to 30% by weight. As used herein, it is to be understood that the subscripts (e.g., “u,” “v”, “x,” “y,” and “z”) range from greater than 0 to 1, where the subscripts sum to 1 to represent an “atomic fraction formula.” See, for example: (i) Charles Kittel, Introduction to Solid State Physics, seventh edition, John Wiley & Sons, Inc., NY, 1996, pp. 611-627; (ii) Smart and Moore, Solid State Chemistry, An introduction, Chapman & Hall University and Professional Division, London, 1992, pp. 136-151; and (iii) James F. Shackelford, Introduction to Materials Science for Engineers, Sixth Edition, Pearson Prentice Hall, New Jersey, 2005, pp. 404-418. The balance of the material (i.e., 1 minus the sum of the subscripts) is the first atom (e.g., SiNₓ with x=0.57 actually corresponds to Si_{0.43}N_{0.57}, which is the same as Si₃N₄). Also, the sum of all subscripts is greater than 0.

In aspects, the optical stack 503a or 503b can include the antireflective structure, antireflective coating, or outer optical film described in U.S. Pat. No. 10,948,629, issued Mar. 16, 2021, U.S. Published Application No. 2022/0011468, and/or U.S. Published Application No. 2024/036236A1, which are incorporated by reference in their entirety. In aspects, as shown in FIGS. 5-6, the optical stack 503a or 503b can comprise a capping layer 519 or 529. In further aspects, the capping layer 519 or 529 can comprise a low refractive index material, which can be the same material as the first low RI layer 515a or 525. In further aspects, the capping layer 519 or 529 can comprise a silicon-containing oxide (e.g., silicon dioxide), a silicon-containing nitride (e.g., an oxide-doped silicon nitride, silicon nitride, etc.), and a silicon-containing oxynitride (e.g., silicon oxynitride). An exemplary aspect of the capping layer is silicon dioxide (SiO₂). In aspects, as shown, the layer of the optical stack 503a or 503b closest to the foldable substrate 403 can be a low index layer (i.e., first low RI layer 515a or 525), and the layer closest to the outer surface of the foldable apparatus 501 or 601 (e.g., anti-fingerprint coating 421) can be a low index layer (e.g., capping layer 519 or 529). In even further aspects, the capping layer 519 or 529 can include a low refractive index material, such as SiO₂, Al₂O₃, GeO₂, SiO₂, AlOₓN_{y}, SiOₓN_{y}, SiᵤAlᵥOₓN_{y}, MgO, MgF₂, BaF₂, CaF₂, DyF₃, YbF₃, YF₃, or CeF₃. In further aspects, a thickness of the capping layer 519 or 529 can be from 10 nm to 120 nm, from 20 nm to 115 nm, from 50 nm to 110 nm, from 80 nm to 110 nm, from 90 nm to 105 nm, or any range or subrange therebetween. An exemplary combination of materials for the optical stack is SiO₂ for the first low RI layer, silicon nitride (e.g., Si₃N₄, SiNₓ) or silicon oxynitride (SiOₓN_{y}) for the second high RI layer, and silicon dioxide (SiO₂) for the capping layer.

As used herein, “optical thickness” is determined by (n*d), where “n” refers to the RI of the sub-layer and “d” refers to the physical thickness of the layer. In aspects, at least one layer (e.g., a layer of the first low RI sub-layers 515a or 525 and/or the second high RI sub-layers 517a or 527) in the optical stack 503a and/or 503b can have an optical thickness from 2 nm to 200 nm, from 10 nm to 100 nm, from 15 nm to 90 nm, from 50 nm to 80 nm, or any range or subrange therebetween. In further aspects, with reference to FIG. 5, the first low RI layers 515a and 515b in periods 513 in the optical stack 503a can be within or more of the ranges mentioned in the previous sentence; and/or all of the layers in the optical film 531 (see FIG. 6) or all of the second high RI layers 517a or 527 can have an optical thickness within one or more of the ranges mentioned in the previous sentence.

In aspects, a combined physical thickness of the second high RI layers 517a and 517b can be 90 nm or more, 100 nm or more, 120 nm or more, 130 nm or more, 150 nm or more, or greater than 500 nm. For example, the combined physical thickness of the second high RI layers 517a and 517b can range from 90 nm to less 500 nm, from 100 nm to 300 nm, from 120 nm to 200 nm, or any range or subrange therebetween. In aspects, the combined physical thickness of the second high RI layers 517a and 517b as a percentage of the physical thickness of the stack thickness 259a can be 30% or more, 35% or more, 40% or more, or 45% or more, for example, ranging from 35% to 75%, from 40% to 65%, from 45% to 55%, or any range or subrange therebetween. In further aspects, a layer of the first low RI sub-layers 515a or 525 and/or the second high RI sub-layers 517a or 527 can comprise a physical thickness from 10 nm to 800 nm, from 10 nm to 500 nm, from 10 nm to 300 nm, from 10 nm to 200 nm, from 20 nm to 100 nm, or any range or subrange therebetween. In further aspects, the hard coating 251, optical stack 503a or 503b, and/or any one or of the layers or sections therein (e.g., optical film 531, a scratch-resistant layer 533, an optional capping layer 519 or 529) may exhibit an extinction coefficient (at a wavelength of 400 nm) of 10⁻⁴ or less.

In further aspects, as shown in FIG. 6, the scratch-resistant layer 533 can include an inorganic carbide, nitride, oxide, diamond-like material, or a combination thereof. Examples of suitable materials for the scratch-resistant layer 533 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 533 may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y}, or combinations thereof. In even further aspects, the scratch-resistant layer 533 can comprise the same material as the second high RI layers 517a or 527, for example, SiOₓN_{y}. In even further aspects, a physical thickness of the scratch-resistant layer and/or the optical stack can be from 0.05 μm to 5 μm, from 0.05 μm to 4 μm, from 0.05 μm to 3 μm, from 0.1 μm to 3 μm, from 0.2 μm to 3 μm, from 0.3 μm to 2.2 μm, from 0.5 μm to 2.1 μm, from 1 μm to 2.1 μm, from 1.8 μm to 2.1 μm, or any range or subrange therebetween. In exemplary aspects, a physical thickness of the scratch-resistant layer can be from 0.05 μm to 3 μm, from 0.3 μm to 2.2 μm, or from 1 μm to 2.1 μm. The scratch-resistant layer 533 and/or the optical stack 503a or 503b may exhibit a hardness of 8 GPa or more, 10 GPa or more, 12 GPa or more, 13 GPa or more, 15 GPa or more, or 17 GPa or more, as measured by the Berkovich Indenter Hardness Test (as described below). Although not shown, it is to be understood that the scratch-resistant layer can be sandwiched by portions of the optical film. For example, 3 or more periods can be positioned between the scratch-resistant layer and the foldable substrate while 2 or more periods can be positioned between the scratch-resistant layer and the anti-fingerprint coating. In aspects, the capping layer 519 or 529 may exhibit an intrinsic hardness in the range from 7 GPa to 10 GPa, as measured by the Berkovich Indenter Hardness Test (as measured on the surface of a layer of the same material of the capping layer, formed in the same manner, but having a thickness of 1 micrometer or more).

In aspects, the optical stack 503a or 503b can comprise a residual stress of less than +50 MPa (tensile) to −1000 MPa (compression). In aspects, the anti-reflective coating is characterized by a residual stress from −50 MPa to −1000 MPa (compression), or from −75 MPa to −800 MPa (compression). Unless otherwise noted, residual stress in the anti-reflective coating is obtained by measuring the curvature of the foldable substrate 201 or 403 before and after deposition of the anti-reflective coating, and then calculating residual film stress according to the Stoney equation according to principles known and understood by those with ordinary skill in the field of the disclosure.

In aspects, the optical stack 503a or 503b and/or the foldable apparatus 101, 301, 401, 501, 601, 701, and/or 901 may exhibit a visible photopic average reflectance of 3% or less, 2% or less, 1% or less, 0.9% or less, 0.8% or less, 0.7% or less, 0.6% or less, 0.5% or less, 0.4% or less, 0.3% or less, or 0.2% or less, over the optical wavelength regime. These photopic average reflectance values may be exhibited at incident illumination angles in the range from 0° to 20°, from 0° to 40°, or from 0° to 60°. As used herein, “photopic average reflectance” mimics the response of the human eye by weighting the reflectance versus wavelength spectrum according to the human eye's sensitivity. Photopic average reflectance may also be referred to as the luminance, or tristimulus Y value of reflected light, according to known conventions, for example CIE (CIELAB) color space conventions. The photopic average reflectance <Rₚ> is defined as the spectral reflectance, R(λ), multiplied by the illuminant spectrum, I(λ), and the CIE's color matching function, y̅(λ), related to the eye's spectral response:

$$〈 {R}_{p} 〉 = {\int }_{380 nm}^{720 nm} R ( λ ) \times I ( λ ) \times \overline{y} ( λ ) d λ .$$

Further, the foldable apparatus can exhibit a CIE a* value, in reflectance, from −10 to +2 and a CIE b* value, in reflectance, from −10 to +2, the CIE a* and CIE b* values each measured on the optical film structure at a normal incident illumination angle (using an D65 illuminant). In aspects, the optical stack 503a or 503b and/or the foldable apparatus 101, 301, 401, 501, 601, 701, and/or 901 can exhibit an average light transmission, from 400 nm to 700 nm, of 90% or more, 92% or more, 92.5% or more, 93% or more, 93.5% or more, 94% or more, 94.5% or more, or 95% or more, 96% or more, or 98% or more, over the optical wavelength regime. In aspects, the optical stack 503a or 503b and/or the foldable apparatus 101, 301, 401, 501, 601, 701, and/or 901 can exhibit an average light transmission of 87% or more, 88% or more, 89% or more, 90% or more, 91% or more, 92% or more, 93% or more, 94% or more, or 95% or more, over the infrared spectrum from 800 nm to 1000 nm, from 900 nm to 1000 nm, or from 930 nm to 950 nm. In aspects, the optical stack 503a or 503b and/or the foldable apparatus 101, 301, 401, 501, 601, 701, and/or 901 can exhibit a hardness of 8 GPa or more measured at an indentation depth of 100 nm or a maximum hardness of 9 GPa or greater measured over an indentation depth range from 100 nm to 500 nm, where the hardness and the maximum hardness measured by a Berkovich Indenter Hardness Test (as defined below). In further aspects, the hard coating 251 (e.g., optical stack 503a or 503b) can exhibit an average light reflectance of 1.25% or less, 1.0% or less, 0.75% or less, 0.5% or less, 0.25% or less, 0.1% or less, or even 0.05% or less over the optical wavelength regime. In further aspects, the hard coating 251 (e.g., optical stack 503a or 503b) can exhibit an average transmittance or average reflectance having an average oscillation amplitude of 5 percentage points or less over the optical wavelength regime.

The hard coating 251 and/or the optical stack 503a or 503b may be formed using various deposition methods, for example, vacuum deposition techniques, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used, for example, printing, spraying, or slot coating. Where vacuum deposition is utilized, inline processes may be used to form the hard coating 251 and/or the optical stack 503a or 503b in one deposition run. In aspects, the vacuum deposition can be made by a linear PECVD source. In aspects, hard coating 251 and/or the optical stack 503a or 503b can be prepared using a sputtering process (e.g., a reactive sputtering process), chemical vapor deposition (CVD) process, plasma-enhanced chemical vapor deposition process, or some combination of these processes. In aspects, the optical stack 503a or 503b comprising low RI layer(s) 515a, 515b, or 525 and high RI layer(s) 517a, 517b, or 527 can be prepared according to a reactive sputtering process. In aspects, optical stack 503a or 503b (including low RI layer 515a, 515b, or 525, high RI layer 517a, 517b, or 527 and capping layer 519 or 529) can be fabricated using a metal-mode, reactive sputtering in a rotary drum coater. The reactive sputtering process conditions were defined through careful experimentation to achieve the desired combinations of hardness, refractive index, optical transparency, low color, and controlled film stress.

In further aspects, the optical stack 503a or 503b can comprise a gradient coating comprising a refractive index gradient. In even further aspects, the refractive index gradient can span a range of refractive index values of 0.2 or more, 0.3 or more, 0.4 or more, 1 or less, 0.8 or less, 0.6 or less, or 0.5 or less, for example, from 0.2 to 1, from 0.3 to 0.8, from 0.4 to 0.6, or any range or subrange therebetween. In even further aspects, the gradient coating can comprise a concentration gradient of one or more of oxygen, nitrogen, and/or silicon. It should be understood, however, that other functional coatings may be provided in the optical stack 503a or 503b to achieve predetermined optical properties of the foldable apparatus.

According to one or more aspects, an anti-reflective coating can be used in combination with an anti-glare (AG) surface. Anti-glare surface treatments can impact the performance of anti-reflective coatings. Thus, selection of the proper anti-glare surface can be important for optimal performance, particularly in difficult use environments, such as vehicle interiors. In such environments, it may be beneficial for anti-glare surfaces on a cover glass to have the minimum sparkle and provide the appropriate anti-glare effect and tactile while meeting a required Contrast Ratio (CR) under sunlight. For example, a sample can be prepared with a chemically-etched Ultra-Low Sparkle (ULS) AG surface on a glass substrate made of Corning® Gorilla® Glass with an anti-reflective coating according to embodiments of this disclosure, and an easy-to-clean (ETC) coating to provide stable color appearance with wide-viewing angles to facilitate on sunlight viewability.

Anti-glare surfaces can be prepared on a Corning® Gorilla® Glass substrate by using a chemical etching method that enables ultra-low sparkle performance suitable for high-resolution display up to 300 pixels per inch (PPI). Anti-glare glass optical properties can be analyzed, including with and without contributions from specular reflection (i.e., specular component excluded (SCE) or specular component included (SCI)), transmission haze, gloss, distinctness of image (DOI), and sparkle. Further information regarding these properties and how these measurements are made can be found in (1) C. Li and T. Ishikawa, Effective Surface Treatment on the Cover Glass for Auto-Interior Applications, SID Symposium Digest of Technical Papers Volume 1, Issue 36.4, pp. 467 (2016); (2) J. Gollier, G. A. Piech, S. D. Hart, J. A. West, H. Hovagimian, E. M. Kosik Williams, A. Stillwell and J. Ferwerda, Display Sparkle Measurement and Human Response, SID Symposium Digest of Technical Papers Volume 44, Issue 1 (2013); and (3) J. Ferwerda, A. Stillwell, H. Hovagimian and E. M. Kosik Williams, Perception of sparkle in anti-glare display screen, Journal of the SID, Vol 22, Issue 2 (2014), the contents of which are incorporated herein by reference.

The balance of the five metrics of SCE/SCI (see previous paragraph), transmission haze, gloss, distinctness of image (DOI), and sparkle is important for maximizing the benefits of an anti-glare for display readability, tactility on the glass surface, and the aesthetic appearance of high-performance touch displays in applications such as vehicle interiors. Sparkle is a micro-scattering interaction of the anti-glare surface with LCD pixels to create bright spots degrading image quality, especially at high resolution. The sparkle effect can be characterized using the method of the Pixel Power Deviation with reference (PPDr) to examine the sparkle effect on different resolution displays. For example, ultra-low sparkle anti-glare glass with less than 1% PPDr will have invisible sparkle effect on a display of less than 300 pixels-per-inch (PPI). However, up to 4% PPDr may be acceptable depending on the contents of display, based on the preference of the end-user. In vehicular or automotive interior settings, 120 PPI to 300 PPI is acceptable, and displays over 300 PPI have diminishing value.

In aspects, the foldable substrate 201 or 403 and/or an anti-glare surface of the hard coating 251 (e.g., optical stack 503a and/or 503b) can comprise a textured surface, for example, having particulates, a mechanically roughened surface, and/or a chemically roughened surface. In further aspects, the anti-glare and/or textured surface can be formed by treating the corresponding surface with an anti-glare treatment. Exemplary aspects of anti-glare treatments include chemical or physical surface treatment to form irregularities and/or etching the surface (e.g., with hydrofluoric acid) to create an etched region exhibiting anti-glare properties.

Throughout the disclosure, hardness of the optical stack is measured using the “Berkovich Indenter Hardness Test.” As used herein, the “Berkovich Indenter Hardness Test” measures the hardness of a material by indenting the surface (e.g., third major surface 253) with a diamond Berkovich indenter to form an indent to an indentation depth in the range from 50 nm to 1000 nm (or the entire thickness of the optical stack 503a or 503b, whichever is less) and measuring the hardness from this indentation at various points along the entire indentation depth range, along a specified segment of this indentation depth (e.g., in the depth range from 100 nm to 500 nm), or at a particular indentation depth (e.g., at a depth of 100 nm, at a depth of 500 nm, etc.) generally using the methods set forth in Oliver, W. C. and Pharr, G. M., “An improved technique for determining hardness and elastic modulus using load and displacement sensing indentation experiments”, J. Mater. Res., Vol. 7, No. 6, 1992, 1564-1583; and Oliver, W. C. and Pharr, G. M., “Measurement of Hardness and Elastic Modulus by Instrument Indentation: Advances in Understanding and Refinements to Methodology”, J. Mater. Res., Vol. 19, No. 1, 2004, 3-20. Further, when hardness is measured over an indentation depth range (e.g., in the depth range from 100 nm to 500 nm), the results can be reported as a maximum hardness within the specified range, wherein the maximum is selected from the measurements taken at each depth within that range. As used herein, “hardness” and “maximum hardness” both refer to as-measured hardness values, not averages of hardness values. Similarly, when hardness is measured at an indentation depth, the value of the hardness obtained from the Berkovich Indenter Hardness Test is given for that particular indentation depth.

The hard coating 251 (e.g., optical stack 503a or 503b and/or scratch-resistant layer 533) can comprise a hardness of greater than 8 GPa, by the Berkovich Indenter Hardness Test at an indentation depth of 100 nm. The hard coating 251 (e.g., optical stack 503a or 503b and/or scratch-resistant layer 533) may exhibit a hardness of 8 GPa or more, 9 GPa or more, 10 GPa or more, 11 GPa or more, 12 GPa or more, 13 GPa or more, 14 GPa or more, or 15 GPa or more by the Berkovich Indenter Hardness Test at an indentation depth of 100 nm. In aspects, hard coating 251 (e.g., optical stack 503a or 503b and/or scratch-resistant layer 533) can exhibit a hardness ranging from greater than or equal to 8 GPa to 30 GPa, from greater than or equal to 10 GPa to 25 GPa, from greater than or equal to 12 GPa to 20 GPa, from greater than or equal to 15 GPa to 20 GPa, or any range or subrange therebetween. Such measured hardness values may be exhibited by the optical stack 503a or 503b and/or the foldable apparatus 101, 301, 401, 501, 601, 701, and/or 901 over an indentation depth of 50 nm or more, or 100 nm or more (e.g., from 100 nm to 300 nm, from 100 nm to 400 nm, from 100 nm to 500 nm, from 100 nm to 600 nm, from 200 nm to 300 nm, from 200 nm to 400 nm, from 200 nm to 500 nm, or from 200 nm to 600 nm). Similarly, maximum hardness values of 8 GPa or more, 9 GPa or more, 10 GPa or more, 11 GPa or more, 12 GPa or more, 13 GPa or more, 14 GPa or more, or 15 GPa or more by the Berkovich Indenter Hardness Test may be exhibited by the hard coating 251 (e.g., optical stack 503a or 503b and/or scratch-resistant layer 533) over an indentation depth of 50 nm or more, or 100 nm or more (e.g., from 100 nm to 300 nm, from 100 nm to 400 nm, from 100 nm to 500 nm, from 100 nm to 600 nm, from 200 nm to 300 nm, from 200 nm to 400 nm, from 200 nm to 500 nm, or from 200 nm to 600 nm).

Throughout the disclosure, an elastic modulus (e.g., Young's modulus) of the hard coating 251 (e.g., optical stack 503a or 503b, scratch-resistant layer 533) is determined using nanoindentation with a Berkovich diamond indenter tip. See: Fischer-Cripps, A. C., “Critical Review of Analysis and Interpretation of Nanoindentation Test Data,” Surface & Coatings Technology, 200, 4153-4165 (2006); and Hay, J., Agee, P, and Herbert, E., “Continuous Stiffness measurement During Instrumented Indentation Testing, Experimental Techniques,” 34 (3) 86-94 (2010). For coatings, instantaneous estimates of the elastic modulus are measured as a function of indentation depth. The elastic modulus is taken as the maximum value of the instantaneous estimate of the elastic modulus for measurements within the stack thickness 257, 259a, and/or 259b (e.g., hard coating 251 and/or optical stack 503a or 503b, scratch-resistant layer 533) minus 5 nm from the corresponding exterior surface. Without wishing to be bound by theory, if a coating is of sufficient thickness, then it is then possible to isolate the properties of the coating from an adjacent coating based on the resulting response profiles as a function of depth. Extraction of reliable nanoindentation data is based on well-established protocols described in the above-mentioned references. Otherwise, these metrics can be subject to significant errors. In aspects, an elastic modulus of hard coating 251 (e.g., optical stack 503a or 503b, scratch-resistant layer 533) can be 100 GPa or more, 120 GPa or more, 150 GPa or more, 170 GPa or more, 200 GPa or more, 220 GPa or more, 300 GPa or less, 250 GPa or less, 220 GPa or less, 210 GPa or less, 200 GPa or less, 180 GPa or less, 160 GPa or less, 140 GPa or less, or 120 GPa or less. In aspects, an elastic modulus of hard coating 251 (e.g., optical stack 503a or 503b, scratch-resistant layer 533) can be from 100 GPa to 300 GPa, from 120 GPa to 250 GPa, from 150 GPa to 220 GPa, from 170 GPa to 200 GPa, or any range or subrange therebetween.

As used herein, “Vickers Hardness” of the hard coating 251 (e.g., optical stack 503a or 503b, scratch-resistant layer 533) is measured in accordance with ASTM E92. Although not stated, it is to be understood that the units of the Vickers Hardness is the conventional VH. In aspects, a Vickers Hardness of the hard coating 251 (e.g., optical stack 503a or 503b, scratch-resistant layer 533) can be 500 or more, 700 or more, 1,000 or more, 1,200 or more, 5,000 or less, 2,500 or less, 1,500 or less, or 1,000 or less. In aspects, a Vickers Hardness of the hard coating 251 (e.g., optical stack 503a or 503b, scratch-resistant layer 533) can be in a range from greater than or equal to 500 to less than or equal to 5,000, from greater than or equal to 700 to less than or equal to 2,500, from greater than or equal to 1,000 to less than or equal to 1,500, or any range or subrange therebetween. In aspects, a pencil hardness of the hard coating 251 (e.g., optical stack 503a or 503b, scratch-resistant layer 533) can be 8H or more or 9H or more (e.g., greater than or equal to 9H).

As used herein, “Mohs Hardness” of the hard coating 251 (e.g., optical stack 503a or 503b, scratch-resistant layer 533) is determined in accordance with ASTM C1895. In aspects, a Mohs Hardness of the hard coating 251 (e.g., optical stack 503a or 503b, scratch-resistant layer 533) can be greater than or equal to 7, greater than or equal to 8, greater than or equal to 9, or greater than or equal to 10, less than or equal to 10, or less than or equal to 9. In aspects, a Mohs Hardness of the hard coating 251 (e.g., optical stack 503a or 503b, scratch-resistant layer 533) can be in a range from greater than or equal to 7 to less than or equal to 10, from greater than or equal to 8 to less than or equal to 9, or any range or subrange therebetween. In further aspects, a Mohs hardness of the hard coating 251 (e.g., the foldable apparatus having the hard coating disposed over the foldable substrate) can be greater than a Mohs hardness of the foldable substrate alone (e.g., without the hard coating).

In aspects, as shown in FIGS. 4-6, the foldable apparatus 401, 501, and/or 601 can optionally comprise an anti-fingerprint coating 421 disposed over the second major surface 205 and/or 415 of the foldable substrate 201 and/or 403 and the hard coating 251 (e.g., third major surface 253). The anti-fingerprint coating 421 comprises an inner surface 425 facing the second major surface 205 and/or 415 of the foldable substrate 201 and/or 403 and/or the third major surface 253 of the hard coating 251. In further aspects, as shown, the inner surface 425 of the anti-fingerprint coating 421 can be disposed on and/or bonded to third major surface 253 of the hard coating 251. In further aspects, as shown in FIGS. 4-6, the anti-fingerprint coating 421 comprises an exterior surface 423 that forms an exterior surface of the foldable apparatus 401, 501, and/or 601, if present. Consequently, a user would interact with the foldable apparatus 401, 501, and/or 601 by, for example, touching the exterior surface 423 or viewing an image through the exterior surface 423. An anti-fingerprint thickness 429 is defined as an average distance between the inner surface 425 and the exterior surface 423. The anti-fingerprint thickness 429 is determined from a cross-sectional scanning electron microscope (SEM) image. In further aspects, the anti-fingerprint thickness 429 can be 1 nm or more, 2 nm or more, 3 nm or more, 5 nm or more, 8 nm or more, 10 nm or more, 75 nm or less, 50 nm or less, 25 nm or less, 15 nm or less, 10 nm or less, 8 nm or less, or 5 nm or less. In further aspects, the anti-fingerprint thickness 429 can be in a range from 1 nm to 75 nm, from 2 nm to 50 nm, from 3 nm to 25 nm, from 5 nm to 15 nm, from 8 nm to 10 nm, or any range or subrange therebetween.

In further aspects, the anti-fingerprint coating 421 can be substantially free and/or free of fluorine, although the anti-fingerprint can include fluorine in other aspects. For example, the anti-fingerprint coating 421 can comprise an alkyl silane (e.g., being a single alkyl silane thick or multiple alkyl silanes can react to form a composite alkyl silane as the anti-fingerprint coating). As used herein, an “alkyl silane” refers to a compound comprising an alkyl chain directly bonded to a silicon atom of a silane group or a surface silanol (e.g., of the substrate or underlying optical stack), and the silane group can be bonded to other silane groups (e.g., forming a siloxane or siloxane-like network). In further aspects, the alkyl silane can comprise from 4 carbons to 34 carbons (i.e., a C₄-C₃₄ alkyl group), for example, from 6 carbons to 34 carbons (i.e., a C₆-C₃₄ alkyl group), from 8 carbons to 20 carbons (i.e. a C₈-C₂₀ alkyl group). Exemplary aspects of alkyl silane include iso-octylsilanes (e.g., iso-octyltrimethoxysilane), dodecylsilanes (e.g., dodecyltrimethoxysilane), octadecylsilanes (e.g., octadecyltrimethoxysilane), or combinations thereof. In further aspects, the silane can be a methoxy silane (e.g., trimethoxy silane) and/or a trialkoxy silane. In further aspects, the silane can be a trimethoxysilane, a triethoxysilane, a trichlorosilane, or combinations thereof (e.g. dichloromethoxysilane, chlorodimethoxysilane). In aspects, the alkyl silane can comprise an alkyl group comprising from 4 carbons to 34 carbons (i.e., a C₄-C₃₄ alkyl group) (e.g., from 6 carbons to 34 carbons (i.e., a C₆-C₃₀ alkyl group), from 8 carbons to 20 carbons (i.e. a C₈-C₂₀ alkyl group)), for example, an iso-octyl alkyl group, a dodecyl alkyl group, an octadecyl alkyl group, or combinations thereof. An exemplary aspects of the alkyl group is an octadecyl alkyl group. Providing an alkyl silane can reduce a surface energy (e.g., total, dispersive, polar) of the anti-fingerprint coating, which can enable the anti-fingerprint coating to be oleophilic. Reacting an initial coating with a methoxy silane and/or a trialkoxy silane can be well-bonded to the initial coating and enable low surface energy (e.g., total surface energy or 30 mN/m or less, polar surface energy of 5 mN/m or less).

As used herein, the anti-fingerprint coating 421 can decrease a visibility of a fingerprint (e.g., simulated fingerprint), increase an ability to remove a fingerprint (e.g., by wiping), and/or decrease an amount of material from a fingerprint (e.g., simulated fingerprint) transferred to the anti-fingerprint coating. In further aspects, the anti-fingerprint coating can reduce the visibility of, reduce a color shift of and/or reduce droplet formation of fingerprint oil disposed thereon relative to the substrate without the coating. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the substrate refers to a difference in measured color as √((a₁*−a₂*)²+(b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. For example, the anti-fingerprint coating can exhibit an (e.g., as-formed) water contact angle from 90° to 120°, an (e.g., as-formed) oleic acid contact angle of 40° or less, and a coefficient of friction of 0.25 or less Additionally or alternatively, the anti-fingerprint coating (e.g., as-formed) can exhibit a diiodomethane contact angle of an can be 60° or more and/or have a hexadecane contact angle of 45° or less (e.g., wets hexadecane and/or oleic acid). Providing a low diiodomethane contact angle (e.g., 60° or less) and/or a low hexadecane contact angle (e.g., 30° or less) can reduce the visibility and/or color shift associated with fingerprints by enabling fingerprint oil to be dispersed across the anti-fingerprint coating rather than beading up into pronounced droplets.

Additionally or alternatively, in further aspects, the anti-fingerprint coating can reduce the visibility of and/or reduce a color shift of fingerprint oil disposed thereon relative to a glass-based substrate without the coating. Specifically, such an anti-fingerprint coating can cause fingerprint oil to spread out over the surface of the coating. Reducing the thickness of fingerprint oil droplets and/or increasing an area of the coating covered by the fingerprint oil can decrease a color shift and/or visibility associated with the fingerprint oil. Anti-fingerprint coatings that can be oleophilic are to be contrasted with other coatings (e.g., anti-fingerprint coatings) that can reduce droplet formation by being oleophobic. Additionally, the anti-fingerprint coating can enable the removal of aqueous material (e.g., water droplets, sweat droplets) from the coating, for example, by being hydrophobic, as discussed herein. In further aspects, the anti-fingerprint coating can exhibit an (e.g., as-formed) water contact angle from 90° to 120°, an (e.g., as-formed) oleic acid contact angle of 40° or less, and a coefficient of friction of 0.25 or less. In further aspects, the anti-fingerprint coating can exhibit a hexadecane contact angle of 20° or less (or wet hexadecane) and/or a diiodomethane contact angle of 60° or more.

Additionally or alternatively, the anti-fingerprint coating can be an easy-to-clean coating. Throughout the disclosure, an “easy-to-clean” coating on a glass-based substrate can repel material and/or facilitate removal of material disposed thereon relative to the glass-based substrate without the coating. As used herein, an ability to repel material is determined based on a contact angle with higher contact angles associated with greater repulsion. As used herein, an ability to remove material is measured by wiping the material disposed on the surface (e.g., coating or glass-based substrate) with a cheesecloth (see details from the Cheesecloth Abrasion Test with the modification that the material is disposed on the surface before wiping) and the visibility of the material is monitored. A decreased visibility (e.g., fewer wiping cycles to achieve a predetermined reduction is visibility) is associated with a coating facilitating removal of material disposed thereon. In further aspects, the easy-to-clean coating can exhibit an (e.g., as-formed) water contact angle from 90° to 120°, an (e.g., as-formed) oleic acid contact angle of 50° or more, and a coefficient of friction of 0.25 or less.

In aspects, the anti-fingerprint coating 421 and/or the foldable apparatus 101, 301, 401, 501, 601, 701, and/or 901 can comprise an average transmittance (as described above) of 80% or more, 85% or more, 88% or more, 89% or more, 90% or more, 91% or more, 92% or more, or 93% or more. In aspects, the average transmittance of the anti-fingerprint coating 421 and/or the foldable apparatus 101, 301, 401, 501, 601, 701, and/or 901 can range from 80% to 100%, from 85% to 99%, from 88% to 97%, from 89% to 97%, from 90% to 96%, from 91% to 95%, from 92% to 94%, or any range or subrange therebetween. In aspects, the transmittance of the anti-fingerprint coating 421 and/or the foldable apparatus 101, 301, 401, 501, 601, 701, and/or 901 at 550 nm can be within one or more of the ranges mentioned above in this paragraph for the average transmittance.

As used herein, haze refers to transmission haze that is measured through the anti-fingerprint coating 421 and/or through the foldable apparatus 401, 501, and/or 601 (e.g., through the exterior surface 423) in accordance with ASTM D1003-21 at 0° relative to a direction normal to the exterior surface (e.g., exterior surface 423). Haze is measured using a HAZE-GARD PLUS available from BYK Gardner with an aperture over the source port. The aperture has a diameter of 8 mm. A CIE C illuminant is used as the light source for illuminating the anti-fingerprint coating 421 and/or through the foldable apparatus 401, 501, and/or 601. In aspects, the anti-fingerprint coating 421 and/or through the foldable apparatus 401, 501, and/or 601 comprises a haze of 5% or less, 2% or less, 1.5% or less, 1% or less, 0.5% or less, or 0.1% or less, for example from 0.01% to 5%, from 0.01% to 2%, from 0.05% to 1.5%, from 0.05% to 1%, from 0.1% to 0.5%, or any range or subrange therebetween.

Throughout the disclosure, a coefficient of friction refers to a dynamic coefficient of friction measured in accordance with ASTM D1894-14. Unless otherwise indicated, “coefficient of friction” refers to the “dynamic coefficient of friction.” In aspects, the exterior surface 423 of the anti-fingerprint coating 421 can comprise a dynamic coefficient of friction of 0.25 or less, 0.22 or less, 0.20 or less, 0.18 or less, or 0.15 or less. In aspects, the exterior surface 423 of the anti-fingerprint coating 421 can comprise a dynamic coefficient of friction in a range from 0.05 to 0.25, from 0.10 to 0.22, from 0.12 to 0.20, from 0.15 to 0.18, or any range or subrange therebetween.

Throughout the disclosure, contact angles are determined for a drop of a corresponding liquid disposed on the exterior surface (not treated with plasma nor corona) using a 30 gauge needle with the contact angle measured using a goniometer in accordance with ASTM D5946. If a contact angle cannot be reliably determined due to a high degree of droplet spread corresponding to a contact angle of 15° or less, then the coating is said to “wet” the droplet material. As used herein, water contact angles are measured using a drop of deionized water. As used herein, a coating is “hydrophobic” if it has a water contact angle of 100° or more. As used herein, a coating is “superhydrophobic” if it has a water contact angle of 130° or more. As used herein, an “as-formed”coating refers to a coating that has not been subjected to an abrasive (e.g., see Steel Wool Abrasion Test and Cheesecloth Abrasion Test below). As used herein, a coating is “oleophilic” if it has a hexadecane contact angle of less than 60°.

In aspects, the anti-fingerprint coating 421 (e.g., as-formed) is hydrophobic but not superhydrophobic. In aspects, the water contact angle of the anti-fingerprint coating 421 (e.g., as-formed) can be 90° or more, 100° or more, 102° or more, 105° or more, 110° or more, 115° or more, 120° or less, 115° or less, or 110° or less. In aspects, the water contact angle of the anti-fingerprint coating 421 (e.g., as-formed) can range from 90° to 120°, from 100° to 115°, from 102° to 110°, from 105° to 110°, or any range or subrange therebetween. In aspects, a diiodomethane contact angle of the anti-fingerprint coating 421 (e.g., as-formed) can be 60° or more, 62° or more, 65° or more, 80° or less, 75° or less, 73° or less, or 70° or less. In aspects, a diiodomethane contact angle of the anti-fingerprint coating 421 (e.g., as-formed) can range from 60° to 80°, from 62° to 75°, from 65° to 72°, or any range or subrange therebetween. In aspects, the anti-fingerprint coating 421 can be oleophilic. In aspects, a hexadecane contact angle of the anti-fingerprint coating 421 (e.g., as-formed) can be 45° or less, 40° or less, 30° or less, 25° or less, 20° or less, or the anti-fingerprint coating 421 can wet hexadecane. In further aspects, the anti-fingerprint coating 421 (e.g., as formed) wets hexadecane. Providing a low diiodomethane contact angle (e.g., 60° or less) and/or a low hexadecane contact angle (e.g., 30° or less) can reduce the visibility and/or color shift associated with fingerprints by enabling fingerprint oil to be dispersed across the anti-fingerprint coating rather than beading up into pronounced droplets. Providing a high water contact angle (e.g., 100° or more) can enhance the removal of aqueous material (e.g., water droplets, sweat droplets) from the anti-fingerprint coating.

Throughout the disclosure, surface energy (e.g., total surface energy) and components thereof (e.g., polar, dispersive) are calculated using the Wu model based on contact angle measurements, as described above. In aspects, the anti-fingerprint coating 421 can comprise a total surface energy of 35 milliNewtons per meter (mN/m) or less, 32 mN/m or less, 30 mN/m or less, 29 mN/m or less, 28 mN/m or less, or 27 mN/m or less. In aspects, the anti-fingerprint coating 421 can comprise a total surface energy ranging from 20 mN/m to 35 mN/m, from 22 mN/m to 32 mN/m, from 25 mN/m to 30 mN/m, from 25 mN/m to 29 mN/m, from 26 mN/m to 28 mN/m, or any range or subrange therebetween. In aspects, the anti-fingerprint coating 421 can comprise a dispersive surface energy of 30 mN/m or less, 28 mN/m or less, 26 mN/m or less, 25 mN/m or less, 24 mN/m or less, or 23 mN/m or less. In aspects, the anti-fingerprint coating 421 can comprise a dispersive surface energy ranging from 15 mN/m to 30 mN/m, from 18 mN/m to 28 mN/m, from 20 mN/m to 26 mN/m, from 22 mN/m to 25 mN/m, or any range or subrange therebetween. Alternatively, in aspects, the anti-fingerprint coating 421 can comprise a dispersive surface energy ranging 0.5 mN/m to 6 mN/m, from 1 mN/m to 4 mN/m, from 1 mN/m to 3 mN/m, from 1.5 mN/m to 2 mN/m, or any range or subrange therebetween. In aspects, the anti-fingerprint coating 421 can comprise a polar surface energy of 6 mN/m or less, 4 mN/m or less, 3 mN/m or less, or 2 mN/m or less. Providing a low total surface energy (including a low dispersive surface energy and/or a low polar surface energy) can enable oils (e.g., fingerprint oil) to be dispersed across the anti-fingerprint surface (e.g., oleophilic), which can decrease a visibility and/or a color shift associated with fingerprints.

Throughout the disclosure, the “Steel Wool Abrasion Test” is used to determine the durability of a coating. For the Steel Wool Abrasion Test, steel wool (Bonstar #0000) was cut into strips (25 mm×12 mm) and placed on a sheet of aluminum foil to bake in an oven for 2 hours at 100° C. A steel wool strip was fitted to an attachment (10 mm×10 mm) of an abrader (5750, Taber Industries) using a zip tie. Weights totaling 720 grams were added to the Taber arm to result in a total applied load of 1 kilogram. The stroke length was set at 25 mm, the speed was set to 40 cycles per minute, and testing occurred at 23° C. The area to be abraded was marked onto the back of the sample for tracking. A sample of the coating was secured in the abraded and subjected to 2,000 cycles, 3,000 cycles, or 3,500 cycles. After the coating is abraded for the predetermined number of cycles, an abraded water contact angle is measured in accordance with the method for the contact angle described above. Unless otherwise indicated, the abraded water contact angle is calculated as the average of 12 water contact angle measurements taken at evenly spaced locations along the abraded area. A high contact angle (e.g., 85° or more, 90° or more) is indicative of the anti-fingerprint coating surviving the Steel Wool Abrasion Test. Decreases in the contact angle below 70 degrees correlate with a loss of the anti-fingerprint coating. In aspects, the abraded water contact angle after 2,000 cycles, 3,000 cycles, and/or 3,500 cycles in the Steel Wool Abrasion Test can be 85° or more, 88° or more, or 90° or more.

Throughout the disclosure, the “Cheesecloth Abrasion Test” is also used to determine the durability of a coating. In the Cheesecloth Abrasion Test, 4 layers of cheesecloth wrap (Crockmeter Squares for American Standards, 200877; SDL Atlas USA, Rock Hill, SC) are affixed to a cylindrical tip with a radius of 2 cm of a Linear Taber Abrader (Model 5750; Taber Industries, North Tonawanda, NY) with a constant load of 750 grams. The path-length of each swipe is 15 mm, with each cycle comprising a forward and backward swipe to return the tip to its original position before proceeding with the next cycle. The speed was 30 cycles per minute, testing occurred at 23° C. After the coating is abraded for 200,000 cycles, a cheesecloth-abraded water contact angle is measured in accordance with the method for the contact angle described above. In aspects, a cheesecloth-abraded water contact angle of the anti-fingerprint coating 421 can be 100° or more, 105° or more, or 110° or more. In aspects a difference between the water contact angle of the anti-fingerprint coating (as-formed) and the cheesecloth-abraded water contact angle (after 200,000 cycles) can be 15° or less, 12° or less, 10° or less, or 8° or less. As demonstrated by the results of the Steel Wool Abrasion Test and the Cheesecloth Abrasion Test, the anti-fingerprint coatings of the present disclosure can withstand abrasion and maintain good contact angles.

Throughout the disclosure, the “Rubber Abrasion Test” is also used to determine the durability of a coating. In the Rubber Abrasion Test, a 6 mm diameter by 20 mm rod of rubber is affixed to a cylindrical tip of a Linear Taber Abrader (Model 5750; Taber Industries, North Tonawanda, NY) with a length of 5 mm of the rubber is exposed to contact the coating and under with a constant load of 1 kg. The path-length of each swipe is 15 mm, with each cycle comprising a forward and backward swipe to return the tip to its original position before proceeding with the next cycle. The speed was 40 cycles per minute, testing occurred at 23° C. After the coating is abraded for 5,000 cycles, a rubber-abraded water contact angle is measured in accordance with the method for the contact angle described above. In aspects, a rubber-abraded water contact angle of the anti-fingerprint coating 421 can be 80° or more, 85° or more, 90° or more, 95° or more, 100° or more, 105° or more, or 110° or more. In aspects a difference between the water contact angle of the anti-fingerprint coating (as-formed) and the rubber-abraded water contact angle (after 3,000 cycles) can be 15° or less, 12° or less, 10° or less, or 8° or less.

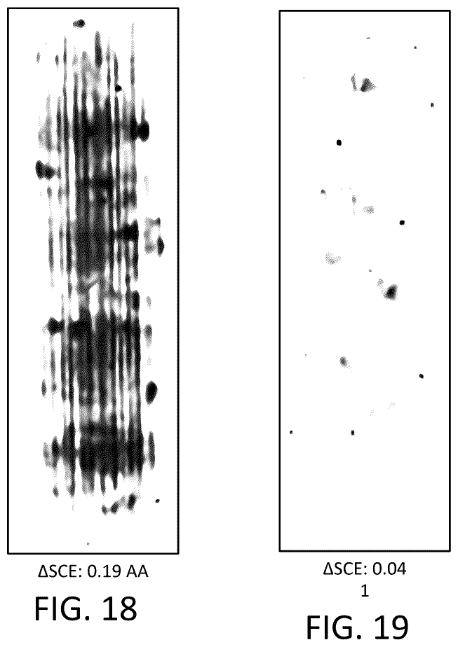

Throughout the disclosure, the “Taber Abrasion Test” is also used to determine the durability of a coating. In the Taber Abrasion Test, a Calibrase CS-8 tip (0.5 inch diameter, available from Taber Industries) is used in a Linear Taber Abrader (Model 5750; Taber Industries) is used to abrade the surface under a load of 350 grams (g) along a 50 mm path length for 500 cycles at 60 cycles per minute. Then, any surface damage generated by this abrasion is quantified by measuring the change in reflectance haze (total and/or SCE) (comparing the reflectance haze at the start of the Taber Abrasion Test to the reflectance haze after the 500 cycles in the Taber Abrasion Test) is measured. Unless otherwise indicated, reflectance haze is measured using a Konica-Minolta CM700d Spectrophotometer. In aspects, the total reflectance haze at the end of the Taber Abrasion Test of the outer surface (e.g., exterior surface 423 or third major surface 253) of the foldable apparatus can be 0.15% or less, 0.12% or less, 0.10% or less, or 0.08% or less. In aspects, the change in the total reflectance haze as a result of the Taber Abrasion Test (of the outer surface of the foldable apparatus) can be within one or more of the ranges mentioned in the previous sentence. In aspects, the change in SCE reflectance haze as a result of the Taber Abrasion Test (of the outer surface of the foldable apparatus) can be 0.15% or less, 0.12% or less, 0.10% or less, 0.08% or less, 0.06% or less, 0.05% or less, or 0.04% or less. For Example, FIGS. 18-19 schematically represent differences between an uncoated foldable substrate (Example AA in FIG. 18) and hard coating disposed on the foldable substrate (Example 1 in FIG. 19) after the Taber Abrsaion Test. As shown, the change in SCE reflectance haze (ASCE) is 0.19% for Example AA but is reduced to 0.04% for Example 1. Likewise, the total reflectance haze for FIG. 18 (Example AA) is 0.234% but is only 0.080% for FIG. 19 (Example 1). Consequently, the hard coating can reduce visible surface damage on the foldable apparatus (relative to no hard coating).

As used herein, “surface roughness” means the Ra surface roughness, which is an arithmetical mean of the absolute deviations of a surface profile from an average position in a direction normal to the surface of the test area. Ra surface roughness values for a 2 μm by 2 μm test area using atomic force microscopy (AFM). In aspects, the anti-fingerprint coating 421 can comprise a surface roughness Ra (e.g., as-formed) of 1 nm or less, 0.8 nm or less, 0.7 nm or less, 0.6 nm or less, 0.5 nm or less, 0.1 nm or more, 0.2 nm or more, 0.3 nm or more, or 0.4 nm or more. In aspects, the anti-fingerprint coating 421 can comprise a surface roughness Ra (e.g., as-formed) ranging from 0.1 nm to 1 nm, from 0.2 nm to 0.8 nm, from 0.3 nm to 0.7 nm, from 0.4 nm to 0.5 nm, or any range or subrange therebetween.

In aspects, a visibility of a fingerprint on the anti-fingerprint coating 421, as defined above as an absolute value of a difference between CIELAB L* values for a portion of the anti-fingerprint coating 421 with and without fingerprint oil, can be 15 or less, 10 or less, 8 or less, 5 or less, 2 or less. In aspects, a visibility of a fingerprint on the anti-fingerprint coating 421 can range from 0 to 15, from 0.5 to 10, from 1 to 8, from 2 to 5, or any range or subrange therebetween. In aspects, a color shift of a fingerprint on the anti-fingerprint coating 421, as defined above as √((a₁*−a₂*)²+(b₁*−b₂*)²), can be 15 or less, 10 or less, 8 or less, 5 or less, 2 or less. In aspects, a color shift of a fingerprint on the anti-fingerprint coating 421 can range from 0 to 15, from 0.5 to 10, from 1 to 8, from 2 to 5, or any range or subrange therebetween.

FIGS. 7-9 schematically illustrate aspects of a foldable apparatus 701 and/or 901 in accordance with aspects of the disclosure in a folded configuration. As shown in FIGS. 8-9, the foldable apparatus 701 and/or 901 is folded such that the second major surface 205 of the foldable substrate 201 is on the inside of the folded foldable apparatus 701 and/or 901 and/or the hard coating 251 (e.g., third major surface 253) is on the inside of the foldable apparatus 701 and/or 901. In this case, for example, a display would be located on the side of the first major surface 203, and a viewer would view the display from the side of the second major surface 205. As shown in FIG. 8, the foldable apparatus 101 shown in FIG. 3 can be modified (as described herein) and folded to form folded foldable apparatus 701 such that the second major surface 205 of the foldable substrate 201 and/or the third major surface 253 of the hard coating 251 is on the inside of the folded foldable apparatus 701. In FIG. 8, a user would view a display device in place of the PET sheet 807 through the foldable substrate 201 and the hard coating 251 and, thus, the user would be positioned on the side of the second major surface 205. In aspects, as shown in FIG. 9, the polymer-based portion 289 and/or 299 can be disposed over the foldable substrate 201.

As used herein, “foldable” includes complete folding, partial folding, bending, flexing, or multiple capabilities. As used herein, the terms “fail,” “failure” and the like refer to breakage, destruction, delamination, or crack propagation. Likewise, a foldable apparatus achieves a parallel plate distance of “X,” or has a parallel plate distance of “X,” or comprises a parallel plate distance of “X” if it resists failure when the foldable apparatus is held at a parallel plate distance of “X” for 24 hours at 60° C. and 90% relative humidity.

As used herein, the “parallel plate distance” of a foldable apparatus is measured with the following test configuration and process using a parallel plate apparatus 801 (see FIGS. 8-9) that comprises a pair of parallel rigid stainless-steel plates 803 and 805 comprising a first rigid stainless-steel plate 803 and a second rigid stainless-steel plate 805. When measuring the “parallel plate distance” for a foldable apparatus resembling the foldable apparatus 301 shown in FIG. 3, the adhesive layer 261 is removed and is replaced by a test adhesive layer 809. Unless otherwise indicated, the test adhesive layer used comprised (going from closest to the first major surface 203 of the foldable substrate 201 to further from the first major surface 203): 15 μm optically clear adhesive comprising a poly(alkyl methacrylate); 20 μm of a polyurethane acrylate; and a 35 μm polysiloxane layer. Further, the test is conducted with a 100 μm thick sheet 807 of polyethylene terephthalate (PET) rather than with the release liner 271 of FIGS. 2-3. Thus, during the test to determine the “parallel plate distance” of a configuration of a foldable apparatus, the foldable apparatus 701 is produced by using the 100 μm thick sheet 807 of polyethylene terephthalate (PET) rather than with the release liner 271 of FIG. 3. Consequently, the foldable apparatus 301 shown in FIG. 3 can be modified (as described herein) and folded to form folded foldable apparatus 701 shown in FIG. 8 with a first contact surface 813 of the test adhesive layer 809 contacting the sheet 807 and the second contact surface 815 of the test adhesive layer 809 contacting the first major surface 203 and/or filling any first recess 211. Also, this positions the outer surface 817 of the sheet 807 of PET on the outside of foldable apparatus and in contact with the pair of parallel rigid stainless-steel plates 803 and 805 of the parallel plate apparatus 801.

For determining a “parallel plate distance”, the Static Folding Test is conducted as follows: the distance between the parallel plates is reduced at a rate of 50 μm/second until the parallel plate distance 811 is equal to the “parallel plate distance” to be tested; then, the parallel plates are held at the “parallel plate distance” to be tested for 24 hours at 60° C. and 90% relative humidity. As used herein, the “minimum parallel plate distance” is the smallest parallel plate distance that the foldable apparatus can withstand without failure under the conditions and configuration described above (Static Folding Test).

In aspects, the foldable apparatus 101, 301, 401, 501, 601, 701, and/or 901 can achieve a parallel plate distance (in mm) that is less than or equal to 0.1 (mm/μm) times the substrate thickness (in μm), less than or equal to 0.08 (mm/μm) times the substrate thickness (in μm), less than or equal to 0.067 (mm/μm) times the substrate thickness, less than or equal to 0.05 (mm/μm) times the substrate thickness, less than or equal to 0.03 (mm/μm) times the substrate thickness, and/or less than or equal to 0.01 (mm/μm) times the substrate thickness. For example, a foldable substrate having a substrate thickness of 300 μm satisfies a parallel plate distance (in mm) that is less than or equal to 0.1 (mm/μm) times the substrate thickness if the foldable substrate achieves a parallel plate distance of 30 mm (i.e., 300 μm substate thickness×0.1 mm/μm=30 mm parallel plate distance). In aspects, the foldable apparatus can achieve a parallel plate distance (in mm) that is equal to the substrate thickness (in μm) times the following factor: from greater than or equal to 0.001 mm/μm to less than or equal to 0.1 mm/μm, from greater than or equal to 0.003 mm/μm to less than or equal to 0.08 mm/μm, from greater than or equal to 0.005 mm/μm to less than or equal to 0.05 mm/μm, from greater than or equal to 0.01 mm/μm to less than or equal to 0.03 mm/μm, or any range or subrange therebetween.

In aspects, the foldable apparatus 101, 301, 401, 501, 601, 701, and/or 901 can achieve a parallel plate distance of 30 millimeters (mm) or less, 20 mm or less, 10 mm or less, 5 mm or less, 3 mm or less, 2 mm or less, or 1 mm or less. In further aspects, the foldable apparatus can achieve a parallel plate distance of 20 mm, or 10 mm, of 5 mm, 3 mm, 2 mm, or 1 mm. In aspects, the foldable apparatus can comprise a minimum parallel plate distance of 30 mm or less, 20 mm or less, 10 mm or less, 5 mm or less, 3 mm or less, 2 mm or less, 1 mm or less, 1 mm or more, 2 mm or more, 3 mm or more, 5 mm or more, or 10 mm or more. In aspects, the foldable apparatus can comprise a minimum parallel plate distance in a range from 1 mm to 30 mm, from 1 mm to 20 mm, from 1 mm to 10 mm, from 1 mm to 5 mm, from 2 mm to 3 mm, or any range or subrange therebetween. In aspects, the foldable apparatus can achieve a minimum parallel plate distance in a range from 1 mm to 30 mm, from 2 mm to 20 mm, from 3 mm to 10 mm, from 5 mm to 10 mm, or any range or subrange therebetween.

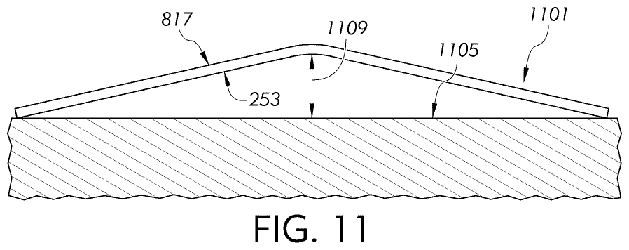

When the test apparatus is released from the parallel plate apparatus 801 after the Static Folding Test, the test apparatus can exhibit residual warp. As shown in FIG. 11, the residual warp 1109 is measured for the test apparatus (e.g., folded foldable apparatus 1101) immediately after the test apparatus is released from the parallel plate distance and placed with the third major surface 253 of the coating facing a direction of gravity and a surface 1105 of stainless steel polished with #0000 steel wool (Bonstar)—and outer surface 817 of the PET sheet facing away from the surface 1105. The residual warp 1109 is measured as the maximum distance in the direction gravity between the third major surface 253 of the coating and the surface 1105. As used herein, immediately after the Static Folding Test, the foldable apparatus is placed in the configuration shown in FIG. 11 without the application of any external force (other than the inherent force from gravity acting on the foldable apparatus) until the residual warp is measured (e.g., 24 hours later).

In aspects, a residual warp of a 100 mm long section of the foldable apparatus 24 hours after being tested in the Static Folding Test (for a parallel plate distance of 5 mm or 3 mm—or 0.1 mm/μm or 0.05 mm/μm times the substrate thickness—with the length oriented in the direction of the parallel plate distance) can be 20 mm or less, 17 mm or less, 15 mm or less, 13 mm or less, 11 mm or less, 10 mm or less, 9 mm or less, 8 mm or less, 7 mm or less, 6 mm or less, 5 mm or less, 4 mm or less, 3 mm or less, 2 mm or less, 4 mm or less, 3 mm or less, 2.0 mm or less, 1.5 mm or less, or 1.0 mm or less. In aspects, a residual warp of a 100 mm long section of the foldable apparatus 24 hours after being tested in the Static Folding Test (e.g., for a parallel plate distance of 5 mm or 3 mm—or 0.1 mm/μm or 0.05 mm/μm times the substrate thickness) can be from 0.1 mm to 20 mm, from 0.2 mm to 17 mm, from 0.3 mm to 15 mm, from 0.4 mm to 13 mm, from 0.5 mm to 11 mm, from 0.6 mm to 10 mm, from 0.7 mm to 9 mm, from 0.8 mm to 8 mm, from 0.9 mm to 7 mm, from 1.0 mm to 6 mm, from 1.3 mm to 5 mm, from 1.5 mm to 4 mm, from 2 mm to 3 mm, or any range or subrange therebetween. In aspects, a residual warp of a 100 mm long section of the foldable apparatus 24 hours after being tested in the Static Folding Test (e.g., for a parallel plate distance of 5 mm—or 0.1 mm/μm or 0.05 mm/μm times the substrate thickness) can be from greater than or equal to 0.1 mm to less than or equal to 10 mm, from greater than or equal to 0.3 mm to less than or equal to 5 mm, from greater than or equal to 0.5 mm to less than or equal to 3 mm, from greater than or equal to 0.7 mm to less than or equal to 2.0 mm, from greater than or equal to 1.0 mm to less than or equal to 1.5 mm, or any range or subrange therebetween. In aspects, a residual warp of the foldable apparatus, as a slope (i.e., residual warp 1109 divided by the length dimension shown in FIG. 11 of the folded foldable apparatus 1101 in a flat configuration), 24 hours after being tested in the Static Folding Test (for a parallel plate distance of 5 mm or 3 mm—or 0.1 mm/μm or 0.05 mm/μm times the substrate thickness—with the length oriented in the direction of the parallel plate distance) can be 0.2 or less, 0.17 or less, 0.15 or less, 0.13 or less, 0.11 or less, 0.10 or less, 0.09 or less, 0.08 or less, or 0.07 or less, 0.06 or less, 0.05 or less, 0.04 or less, 0.03 or less, 0.02 or less, or 0.01 or less. In aspects, a residual warp of a 100 mm long section of the foldable apparatus, as a slope, 24 hours after being tested in the Static Folding Test (e.g., for a parallel plate distance of 5 mm or 3 mm—or 0.1 mm/μm or 0.05 mm/μm times the substrate thickness) can be from 0.001 to 0.2, from 0.003 to 0.17, from 0.005 to 0.15, from 0.07 to 0.13, from 0.009 to 0.11 mm, from 0.010 to 0.10, from 0.012 to 0.09, from 0.015 to 0.08, from 0.02 to 0.07 mm, from 0.03 mm to 0.06, from 0.04 to 0.05 mm, or any range or subrange therebetween.

As demonstrated by the Examples discussed herein, it was unexpectedly discovered that the foldable apparatus including the hard coating described herein can achieve parallel plate distances less than or equal to 0.1 mm/μm (or 0.05 mm/μm) times the substrate thickness (or 5 mm or 3 mm) in the Static Folding Test. It would have been expected that a foldable apparatus having the hard coating would fail due to the high stiffness imparted by the high modulus and high hardness hard coating and/or brittleness of the hard coating. Instead, the hard coating improves the folding performance of the foldable apparatus (by incorporating the hard coating). Further, it was unexpectedly discovered that the foldable apparatus including the hard coating described herein can exhibit low residual warp after the Static Warp Test (e.g., 24 hours). Again, it would have been expected that the increased stiffness imparted by the high modulus (e.g., higher modulus than the foldable substrate) and high hardness hard coating would have resisted the foldable apparatus returning to the folded configuration, which would appear as high residual warp (e.g., greater than 3 times the parallel plate distance in the Static Fold Test).

In the Dynamic Cycling Test, the test apparatus (e.g., folded foldable apparatus 701) as described above is placed between the pair of parallel rigid stainless-steel plates 803 and 805 (arranged as shown in FIG. 8 and in the Static Folding Test) such that the third major surface 253 of the hard coating 251 faces itself. In the Dynamic Cycling Test, a “cycle” comprises decreasing the parallel plate distance 811 between the parallel plates 803 and 805 from a distance of 100 mm until the parallel plate distance 811 is equal to the “parallel plate distance” to be tested and then the parallel plate distance is increased to 100 mm. The folded foldable apparatus 701 is cycled for 200,000 cycles at a cycling rate of 30 cycles per minute in an environment maintained at 23° C. and 50% relative humidity. The polymer-based portion (e.g., adhesive layer) in the test apparatus (e.g., folded foldable apparatus) can withstand a predetermined parallel plate distance if the test apparatus does not fail during the 200,000 cycles.

In aspects, the foldable apparatus can achieve a parallel plate distance (in mm) in the Dynamic Cycling Test that is less than or equal to 0.1 (mm/μm) times the substrate thickness (in μm), less than or equal to 0.08 (mm/μm) times the substrate thickness (in μm), less than or equal to 0.05 (mm/μm) times the substrate thickness, less than or equal to 0.03 (mm/μm) times the substrate thickness, and/or less than or equal to 0.01 (mm/μm) times the substrate thickness. In aspects, the foldable apparatus can achieve a parallel plate distance (in mm) in the Dynamic Cycling Test that is equal to the substrate thickness (in μm) times the following factor: from greater than or equal to 0.001 mm/μm to less than or equal to 0.1 mm/μm, from greater than or equal to 0.003 mm/μm to less than or equal to 0.08 mm/μm, from greater than or equal to 0.005 mm/μm to less than or equal to 0.05 mm/μm, from greater than or equal to 0.01 mm/μm to less than or equal to 0.03 mm/μm, or any range or subrange therebetween. In aspects, the foldable apparatus can achieve a parallel plate distance in the Dynamic Cycling Test that is 20 mm, or 10 mm, of 5 mm, 3 mm, 2 mm, or 1 mm. In further aspects, the foldable apparatus can achieve a parallel plate distance in the Dynamic Cycling Test in a range from range from 1 mm to 30 mm, from 1 mm to 20 mm, from 1 mm to 10 mm, from 1 mm to 5 mm, from 2 mm to 3 mm, or any range or subrange therebetween.

When the test apparatus is released from the parallel plate apparatus 801 after the Dynamic Cycling Test, the test apparatus can exhibit residual warp, which is measured as described above with reference to FIG. 11. In aspects, the residual warp 24 hours after the Dynamic Cycling Test can be within one or more of the ranges discussed above for the residual warp 24 hours after the Static Fold Test, where the parallel plate distance can be within any of the corresponding ranges discussed above.

A width 287 of the central portion 281 of the foldable substrate 201 is defined between the first portion 221 and the second portion 231 in the direction 106 of the length 105. In aspects, the width 287 of the central portion 281 of the foldable substrate 201 can extend from the first portion 221 to the second portion 231. A width 210 of the first central surface area 213 and the second central surface area 243 of the foldable substrate 201 is defined between the first transition region 212 and the second transition region 218, for example, as the portion comprising the central thickness 209, in the direction 106 of the length 105. In aspects, the width 287 of the central portion 281 of the foldable substrate 201 and/or the width 210 of the first central surface area 213 of the foldable substrate 201 can be 1.4 times or more, 1.6 times or more, 2 times or more, 2.2 times or more, 3 times or less, or 2.5 times or less the minimum parallel plate distance. In aspects, the width 287 of the central portion 281 of the foldable substrate 201 and/or the width 210 of the first central surface area 213 of the foldable substrate 201 as a multiple of the minimum parallel plate distance can be in a range from 1.4 times to 3 times, from 1.6 times to 3 times, from 1.6 times to 2.5 times, from 2 times to 2.5 times, from 2.2 times to 2.5 times, from 2.2 times to 3 times, or any range or subrange therebetween. Without wishing to be bound by theory, the length of a bent portion in a circular configuration between parallel plates can be 1.6 times the parallel plate distance 811. Without wishing to be bound by theory, the length of a bend portion in an elliptical configuration between parallel plates can be 2.2 times the parallel plate distance 811. In aspects, the width 287 of the central portion 281 of the foldable substrate 201 and/or the width 210 of the first central surface area 213 of the foldable substrate 201 can be 1 mm or more, 3 mm or more, 5 mm or more, 8 mm or more, 10 mm or more, 15 mm or more, 20 mm or more, 100 mm or less, 60 mm or less, 50 mm or less, 40 mm or less, 35 mm or less, 30 mm or less, or 25 mm or less. In aspects, the width 287 of the central portion 281 of the foldable substrate 201 and/or the width 210 of the first central surface area 213 of the foldable substrate 201 can be in a range from 1 mm to 100 mm, from 3 mm to 60 mm, from 5 mm to 50 mm, from 8 mm to 40 mm, from 10 mm to 35 mm, from 20 mm to 30 mm, from 20 mm to 25 mm, or any range of subrange therebetween. By providing a width within the above-noted ranges for the central portion (e.g., between the first portion and the second portion), folding of the foldable apparatus without failure can be facilitated.

The foldable apparatus 101, 301, 401, 501, 601, 701, and/or 901 may have an impact resistance defined by the capability of a region of the foldable apparatus (e.g., a region comprising the first portion 221, the second portion 231, and/or central portion 281) to avoid failure at a pen drop height (e.g., 5 centimeters (cm) or more, 10 centimeters or more, 20 cm or more), when measured according to the “Pen Drop Test.” As used herein, the “Pen Drop Test” is conducted such that samples of foldable apparatus are tested with the load (i.e., from a pen dropped from a certain height) imparted to an outer major surface (e.g., third major surface 253 of the hard coating 251 shown in FIGS. 2-3) with the foldable apparatus configured as in the parallel plate test with 100 μm thick sheet 807 of PET attached to the test adhesive layer 809—15 μm optically clear adhesive comprising a poly(alkyl methacrylate); 20 μm of a polyurethane acrylate; and a 35 μm polysiloxane layer—instead of the release liner 271 shown in FIG. 2. As such, the PET layer in the Pen Drop Test is meant to simulate a foldable electronic display device (e.g., an OLED device). During testing, the foldable apparatus bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to an outer surface of the foldable apparatus. For the foldable apparatus 101, 301, 401, 501, 601, 701, and/or 901 in FIGS. 2-5, 7-8, and 33, the pen is guided to the outer major surface (e.g., first major surface 203 of the foldable substrate 201 for foldable apparatus 101 or 301 shown in FIGS. 2-3, second major surface 205 of the foldable substrate 201 for foldable apparatus 301, 401, or 501 shown in FIGS. 3-5), and the tube is placed in contact with the second major surface 205 of the foldable substrate 201 so that the longitudinal axis of the tube is substantially perpendicular to the outer major surface with the longitudinal axis of the tube extending in the direction of gravity. The tube has an outside diameter of 1 inch (2.54 cm), an inside diameter of nine-sixteenths of an inch (1.4 cm), and a length of 90 cm. An acrylonitrile butadiene (ABS) shim is employed to hold the pen at a predetermined height for each test. After each drop, the tube is relocated relative to the sample to guide the pen to a different impact location on the sample. The pen employed in Pen Drop Test is a BIC Easy Glide Pen, Fine, having a tungsten carbide ballpoint tip of 0.7 mm (0.68 mm) diameter, and a weight of 5.73 grams (g) including the cap (4.68 g without the cap).

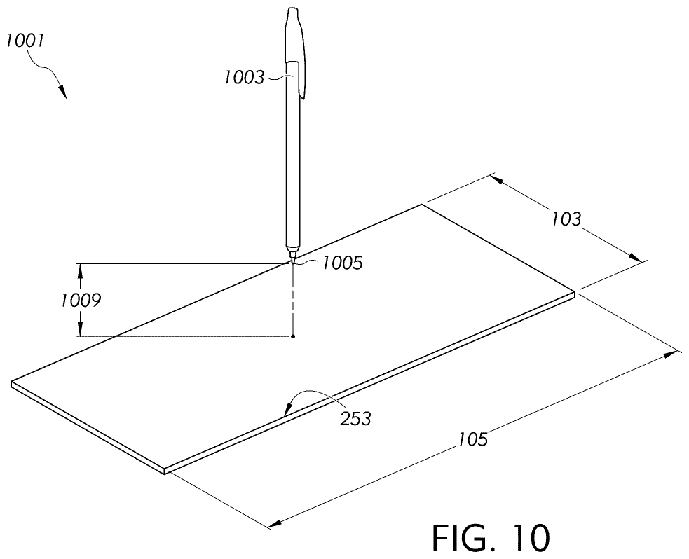

Referring to FIG. 10, a pen drop apparatus 1001 includes a ballpoint pen 1003, which is a BIC Easy Glide Pen, Fine comprising a tungsten carbide ballpoint tip 1005 of 0.7 mm (0.68 mm) diameter, and a weight of 5.73 grams (g) including the cap. The ballpoint pen 1003 is held at a predetermined height 1009 from an outer surface (e.g., third major surface 253 of the hard coating) of the foldable apparatus. A tube (not shown for clarity) is used as part of the pen drop apparatus 1001 to guide the ballpoint pen 1003 to the outer surface (e.g., third major surface 253 of the hard coating) of the sample, and the tube is placed in contact with outer surface so that the longitudinal axis of the tube is substantially perpendicular to the outer major surface with the longitudinal axis of the tube extending in the direction of gravity. The tube has an outside diameter of 1 inch (2.54 cm), an inside diameter of nine-sixteenths of an inch (1.4 cm), and a length of 90 cm. An acrylonitrile butadiene (“ABS”) shim (not shown) is employed to hold the ballpoint pen 1003 at a predetermined height 1009 for each test.

For the Pen Drop Test, the ballpoint pen 1003 is dropped with the cap attached to the top end (i.e., the end opposite the ballpoint tip 1005) so that the ballpoint tip 1005 can interact with the test sample (e.g., third major surface 253). In a drop sequence according to the Pen Drop Test, one pen drop is conducted at an initial height of 1 cm, followed by successive drops in 0.5 cm increments up to 20 cm, and then after 20 cm, 2 cm increments until failure of the test sample. After each drop is conducted, the presence of any observable fracture, failure, or other evidence of damage to the sample is recorded along with the particular pen drop height. After each drop, the tube is relocated relative to the outer surface of the sample to be tested to guide the ballpoint pen 1003 to a different impact location on the outer surface of the sample to be tested. The ballpoint pen is changed to a new pen after every 5 drops, and for each new multilayer apparatus tested. In addition, all pen drops are conducted at random locations on the exterior surface (e.g., third major surface 253) that are at or near the center of the exterior surface (e.g., third major surface 253) unless indicated otherwise, with no pen drops near or on the edge of the sample. Using the Pen Drop Test, multiple samples can be tested according to the same drop sequence to generate a population with improved statistical accuracy. For the Pen Drop Test, the pen is to be changed to a new pen after every 5 drops, and for each new sample tested. In addition, all pen drops are conducted at random locations on the sample at or near the center of the sample, with no pen drops near or on the edge of the samples.

For purposes of the Pen Drop Test, “failure” means the formation of a visible mechanical defect in a laminate. The mechanical defect may be a crack or plastic deformation (e.g., surface indentation). The crack may be a surface crack or a through crack. The crack may be formed on an interior or exterior surface of a laminate. The crack may extend through all or a portion of the foldable substrate 201 and/or 403 and/or hard coating. A visible mechanical defect has a minimum dimension of 0.2 mm or more.

In aspects, the foldable apparatus can resist failure for a pen drop in a region (e.g., comprising the first portion 221 or the second portion 231) at a pen drop height of 10 centimeters (cm), 12 cm, 14 cm, 16 cm, or 20 cm. In aspects, a maximum pen drop height that the foldable apparatus can withstand without failure over a region can be 10 cm or more, 12 cm or more, 14 cm or more, 16 cm or more, 40 cm or less, or 30 cm or less, 20 cm or less, 18 cm or less. In aspects, a maximum pen drop height that the foldable apparatus can withstand without failure over a region can be in a range from 10 cm to 40 cm, from 12 cm to 40 cm, from 12 cm to 30 cm, from 14 cm to 30 cm, from 14 cm to 20 cm, from 16 cm to 20 cm, from 18 cm to 20 cm, or any range or subrange therebetween.

In the Quasi-Static Puncture test, a tungsten carbide ball with a predetermined diameter is placed on the outer surface (e.g., third major surface 253 of the hard coating 251) and pressed into the outer surface at a rate of 0.5 mm/min until failure. The foldable apparatus is configured such that the first major surface 203 or 415 of the foldable substrate 201 or 405 faces an aluminum plate (6063 aluminum alloy, as polished to a surface roughness with 400 grit paper). No tape is used on the side of the sample resting on the aluminum plate. Unless otherwise indicated, the predetermined diameter of the tungsten carbide ball is 0.5 mm. The foldable apparatus can exhibit a puncture resistance as measured in a Quasi-Static Puncture Test of 2.0 kgf or more, 2.5 kgf or more, 3.0 kgf or more, 3.5 kgf or more, 4.0 kgf or more, 4.2 kgf or more, 4.4 kgf or more, 4.5 kgf or more, 4.6 kgf or more, 4.7 kgf or more, 4.8 kgf or more, 4.9 kgf or more, 5.0 kgf or more.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of a portion of the housing or the cover substrate comprises the foldable apparatus (e.g., foldable substrate with the hard coating disposed thereon) discussed throughout the disclosure. The consumer electronic product can comprise a portable electronic device, for example, a smartphone, a tablet, a wearable device, or a laptop.

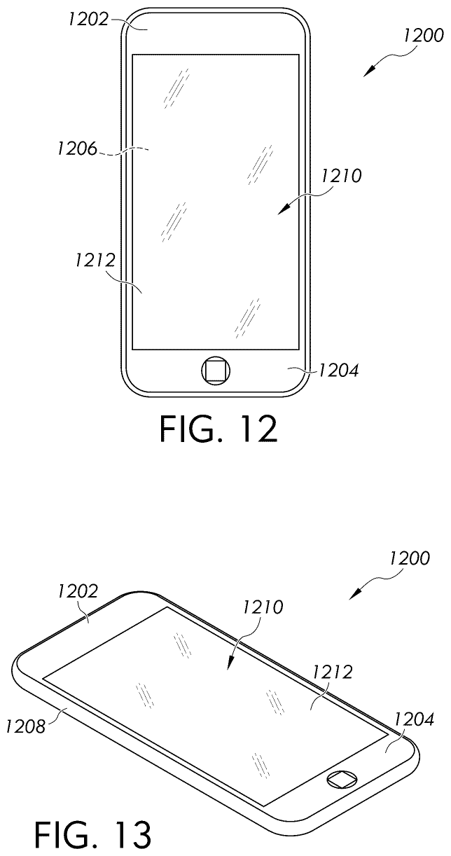

The foldable apparatus and/or hard coating disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance, or a combination thereof. An exemplary article incorporating any of the foldable apparatus and/or hard coating disclosed herein is shown in FIGS. 12-13. Specifically, FIGS. 12-13 show a consumer electronic device 1200 including a housing 1202 having front 1204, back 1206, and side surfaces 1208. Although not shown, the consumer electronic device can comprise electrical components that are at least partially inside or entirely within the housing. For example, electrical components include at least a controller, a memory, and a display. As shown in FIGS. 12-13, the display 1210 can be at or adjacent to the front surface of the housing 1202. The consumer electronic device can comprise a cover substrate 1212 at or over the front surface of the housing 1202 such that it is over the display 1210. In aspects, at least one of the cover substrate 1212 or a portion of housing 1202 may include any of the foldable apparatus and/or the hard coating disclosed herein.

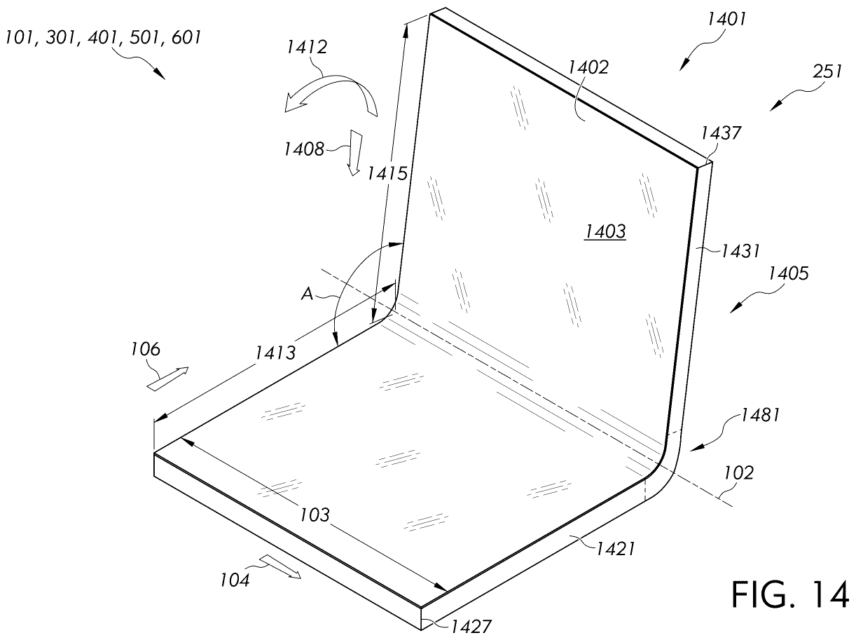

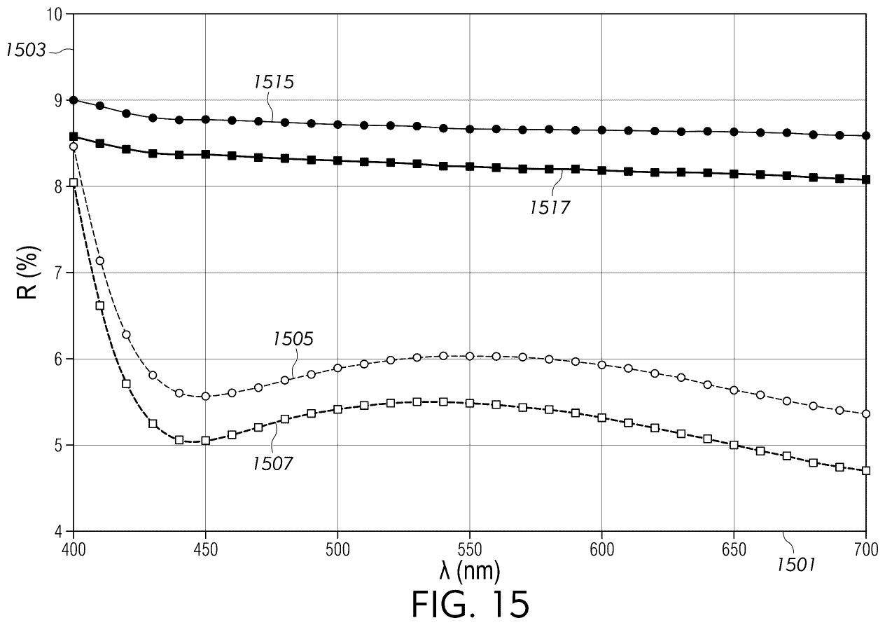

Also, FIG. 14 schematically shows a perspective view of a consumer electronic product 1401 that is foldable. The consumer electronic product 1401 can include the foldable apparatus 101, 301, 401, 501, 601, 701, and/or 901 (e.g., having the hard coating 251) in accordance with aspects of the present disclosure. As shown, the consumer electronic product 1401 can include a front surface 1403 and a side surface 1405. The consumer electronic product 1401 can include electronic components, including a display 1402 that can be viewed through the front surface 1403 and/or at the front surface 1403. In aspects, as shown, the consumer electronic product 1401 can be folded in a direction 1412 to form a folded configuration that brings a first end 1427 and a second end 1437 (opposite the first end 1427) closer together (than in the unfolded configuration). Additionally, as shown, the consumer electronic product 1401 can be folded so that the front surface 1403 and/or display 1402 faces itself, although the consumer electronic product could be folded opposite the direction 1412 so that the front surface 1403 is on the outside of the consumer electronic product in the folded configuration. As discussed above with reference to FIG. 1, the consumer electronic product 1401 shown in FIG. 14 can be folded about the fold axis 102 (or rolled). As shown in FIG. 15, the consumer electronic product 1401 can comprise a central portion 1481 positioned between a first portion 1421 including the first end 1427 and a second portion 1431 including the second end 1437. A location of the fold axis 102 can determine a first distance 1413 between the first end 1427 and the fold axis 102 (e.g., in direction 106) relative to a second distance 1415 between the second end 1437 and the fold axis 102 (e.g., in direction 1408). A total length of the consumer electronic product (e.g., length 105 in FIG. 1) can be the sum of the first distance 1413 and the second distance 1415). Also, as shown, the consumer electronic product is depicted as being in a folded or partially folded configuration with an angle A formed by front surface 1403 about the fold axis 102.

### Examples

Various aspects will be further clarified by the following examples. Examples 1-6 and AA-CC comprised a glass-based substrate (Composition 1 having a nominal composition in mol % of: 65.1 SiO₂; 14.1 Al₂O₃; 16.4 Na₂O; 3.4 MgO; and 1.0 CaO) with a thickness of 30 μm or 50 μm (see Table 1). The substrates had a dimension of 100 mm (see width 104 in direction 103 in FIG. 1) along the fold axis and a length of 160 mm. The 30 μm thick substrate was chemically strengthened (prior to the deposition of any coatings) to have a maximum compressive stress of 698 MPa and a depth of layer of 5.4 μm. The 50 μm thick substrate was chemically strengthened (prior to the deposition of any coatings) to have maximum a compressive stress of 664 MPa and a depth of layer of 4.5 μm. The anti-fingerprint coating used was W880-K9 (available from MMT Co., Ltd.). As coated on the glass-based substrate, the anti-fingerprint coating exhibited a water contact angle of 119°; and the water contact angle of the anti-fingerprint coating on hard coating HC1 was 117°. Table 1 presents the arrangement of components in Examples 1-6 and AA-CC. The composition of the hard coatings HC1 and HC2 are presented below in Tables 2-3.

TABLE 3
Components of Examples 1-5 and AA-CC

| | Substrate | | Anti- |
|---|---|---|---|
| | thickness | Hard | Fingerprint |
| Ex. | (μm) | Coating | Coating |
| AA | 50 | None | No |
| BB | 30 | None | No |
| CC | 30 | None | Yes |
| 1 | 50 | HC1 | No |
| 2 | 50 | HC1 | Yes |
| 3 | 50 | HC1 | No |
| 4 | 30 | HC1 | Yes |
| 5 | 30 | HC2 | Yes |

Tables 2-3 shows the composition of the hard coatings (including optical stacks) HC1 and HC2 (corresponding to the order that the layers are deposited-meaning that the first row is the closest to the glass-based substrate and the last row is the furthest from the glass-based substrate), respectively. In Tables 2-3, the substrate (i.e., glass-based substrate) and air are shown to help orient the optical stack, but the substrate and air are not actually elements of the optical stack. In Tables 2-3, “SiON” refers to silicon oxynitride (i.e., SiOₓN_{y} with non-zero amounts of both silicon and oxygen—x>0, y>O—and x+y is less than or equal to 1), and “SiNₓ” refers to silicon nitride, which can have a non-stoichiometric (i.e., other than Si₃N₄) ratio of the constituent atoms. The refractive index reported in Tables 2-3 for each layer was measured using optical ellipsometry with an optical wavelength of 550 nm. The thickness of hard coating HC1 was 256.4 nm (about 250 nm) and the thickness of hard coating HC2 was 2,311.5 nm (about 2.3 μm).

TABLE 2
Composition of Hard Coating HC1

| | Refractive | Thickness |
|---|---|---|
| Material | Index | (nm) |
| (substrate) | 1.50 | |
| SiO₂ | 1.45 | 25.0 |
| SiNx | 2.04 | 20.9 |
| SiO₂ | 1.46 | 22.8 |
| SiNₓ | 2.03 | 103.8 |
| SiO₂ | 1.47 | 83.9 |
| (air) | 1.00 | |

TABLE 3
Composition of Hard Coating HC2

| | Refractive | Thickness |
|---|---|---|
| Material | Index | (nm) |
| (substrate) | 1.50 | |
| SiO₂ | 1.47 | 20.0 |
| SiON | 2.01 | 8.1 |
| SiO₂ | 1.47 | 64.3 |
| SiON | 2.01 | 20.6 |
| SiO₂ | 1.47 | 48.4 |
| SiON | 2.01 | 36.0 |
| SiO₂ | 1.47 | 26.9 |
| SiON | 2.01 | 46.0 |
| SiO₂ | 1.47 | 8.8 |
| SiON | 1.97 | 1500. |
| SiO₂ | 1.46 | 16.4 |
| SiNₓ | 2.06 | 37.0 |
| SiO₂ | 1.46 | 50.4 |
| SiNₓ | 2.06 | 23.3 |
| SiO₂ | 1.46 | 84.7 |
| SiNₓ | 2.06 | 24.2 |
| SiO₂ | 1.46 | 44.9 |
| SiNₓ | 2.06 | 149.6 |
| SiO₂ | 1.46 | 102.1 |
| (air) | 1.00 | |

FIG. 15 schematically illustrates reflectance (R) (in %) on the vertical axis 1503 (i.e., y-axis) as a function of optical wavelength on the horizontal axis 1501 (i.e., x-axis) for Examples 1, 3, and AA-BB. Curve 1505 corresponds to Example BB, curve 1505 corresponds to Example AA, curve 1507 corresponds to Example 1, and curve 1517 corresponds to Example 4. As shown, the addition of the hard coating HC1 in Examples 1 and 3 (curves 1517 and 1507) lowers the reflectance relative the uncoated substrates of Examples AA and BB (curves 1515 and 1505) for all optical wavelengths shown.

Table 4 presents the CIELAB color coordinates (L*, a*, b*) measured in reflection for Examples 1, 3, and AA-BB using a D65 illuminant. All of these examples (Examples 1, 3, and AA-BB) have absolute values of a* and b* color coordinates less than 2 (and less than 1) that is likely to be perceived as colorless. The addition of hard coating HC1 to Examples AA-BB (corresponding to Examples 1 and 3) had essentially the same change in CIELAB color coordinates (see last two rows) regardless of substrate thickness. Also, the decrease in L* from the addition of hard coating HC1 is primarily attributed to the decreased reflectance (discussed above with reference to FIG. 15) of Examples 1 and 3 (relative to Examples AA-BB) leading to a lower intensity of light being reflected, which is perceived as darker in reflectance in CIELAB color space. An average reflectance (averaged over optical wavelengths from 400 nm to 750 nm) was 1.0% and 1.1% for Examples 2 and 4, respectively. An average transmittance (averaged over optical wavelengths from 400 nm to 750 nm) was 95.0% and 95.1% for Examples 2 and 4, respectively.

TABLE 4
CIE color coordinates of Examples 1, 3, and AA-BB

| Ex. | L* | a* | b* |
|---|---|---|---|
| AA | 34.49 | −0.08 | −0.45 |
| BB | 35.38 | −0.01 | −0.33 |
| 1 | 27.83 | −0.94 | 0.63 |
| 3 | 29.27 | −0.52 | 0.77 |
| Difference: 1 & AA | −6.66 | −0.86 | 1.08 |
| Difference: 3 & BB | −6.11 | −0.85 | 1.10 |

Tables 5-6 present foldability and residual warp properties of the Examples. The parallel plate distance tested is presented in parenthesis following the Example in the left-most column of Tables 5-6. Table 5 presents the results of the Dynamic Folding Test and residual warp (immediately after—t=0—and 24 hours after the end of the Dynamic Folding Test). Examples 1 and AA were tested at a parallel plate distance of 5 mm and passed the Dynamic Folding Test, with both Examples 1 and AA having warp less than 2 mm (both immediately and after 24 hours). This indicates that hard coating HC1 only slightly increases residual warp of Example AA and a parallel plate distance of 5 mm. Examples 4 and BB were tested at a parallel plate distance of 3 mm and passed the Dynamic Folding Test. At this smaller parallel plate distance, an initial warp of 5.2 mm was observed for Example BB that decreased to 1.8 mm after 24 hours. Surprisingly, Example 4 exhibited less residual warp than Example BB both initially (0.8 mm less warp) and after 24 hours (0.2 mm less)—at least 10% less residual warp. This result is unexpected because it would have been expected that the addition of the hard coating on the side that is on the inside of the fold (to achieve the parallel plate distance) would increase warp or even fail when folded.

Examples 5 and BB were tested at a parallel plate distance of 4 mm and passed the Dynamic Folding Test. A crease was seen in Example 5 (4 mm), which is attributed to hard coating HC2. This suggests that hard coating HC2 is too thick for folding to a parallel plate distance of 4 mm without damage, although it is expected that larger parallel plate distances (e.g., 5 mm) could be achieved without damage. In contrast, hard coating HC1 is thinner than hard coating HC2, and Examples 1 and 4 including hard coating HC1 are able to achieve at least parallel plate distances of 5 mm and 3 mm, respectively, without damage where a minimal increase in residual warp (or a decrease in residual warp—for Example 4 versus Example BB) is observed.

TABLE 5
Results of Dynamic Folding Test and Residual
Warp of Examples 1, 4-5, and AA-BB.

| | | | |
|---|---|---|---|
| | Dynamic | Warp | Warp |
| Ex. (mm) | Folding Test | (t = 0) | (t = 24 h) |

| AA | (5 mm) | Pass | 1.1 | mm | 0.4 | mm |
|---|---|---|---|---|---|---|
| 1 | (5 mm) | Pass | 1.3 | mm | 1.3 | mm |
| BB | (4 mm) | Pass | <0.5 | mm | <0.5 | mm |
| 5 | (4 mm) | Pass | Crease | | Crease | |
| BB | (3 mm) | Pass | 5.2 | mm | 1.8 | mm |
| 4 | (3 mm) | Pass | 4.4 | mm | 1.6 | mm |

TABLE 6
Results of Static Folding Test and Residual
Warp of Examples 2, 4, and AA-BB.

| | | Static | Warp | | Warp | | Warp | |
|---|---|---|---|---|---|---|---|---|
| Ex. (mm) | | Folding Test | (t = 0) | | (t = 24 h) | | (t = 48 h) | |
| AA | (5 mm) | Pass | 12.48 | mm | 11.62 | mm | 11.05 | mm |
| 2 | (5 mm) | Pass | 11.68 | mm | 10.32 | mm | 9.71 | mm |
| BB | (3 mm) | Pass | 1.18 | mm | 0.71 | mm | 0.54 | mm |
| 4 | (3 mm) | Pass | 1.21 | mm | 0.91 | mm | 0.91 | mm |

Table 6 presents the results of the Static Folding Test and residual warp (immediately after—t=0—and 24 hours after the end of the Dynamic Folding Test). Examples 2 and AA were tested at a parallel plate distance of 5 mm and passed the Static Folding Test. Example AA exhibited residual warp of 12.48 mm initially that decreased to 11.62 mm after 24 hours and 11.05 mm after 48 hours. Surprisingly (similar to the discussion above for Example 4 versus Example BB), Example 2 exhibits less residual warp than Example AA initially (0.8 mm less), after 24 hours (0.7 mm less), and after 48 hours (1.34 mm less)—greater than 5% reduction in residual warp overall and greater than 10% reduction after 48 hours.

Examples 6 and BB were tested at a parallel plate distance of 3 mm and passed the Static Folding Test with both Examples 6 and B having residual warp less than 2 mm (both immediately, after 24 hours, and after 48 hours). The residual warp immediately (t=0) after the Static Folding Test is essentially the same between Examples 6 and BB, although a greater reduction in residual warp is seen for Example BB than Example 6. Still, Example 4 (and Example BB) has residual warp of less than 1 mm 24 hours after and 48 hours after the Static Folding Test.

Overall (between Tables 5 and 6), the residual warp of the examples including hard coating HC1 is generally less than 10% of the residual warp seen without the hard coating. This result is unexpected in itself due to expectations about the increased stiffness imparted by the high modulus (e.g., higher modulus than the foldable substrate) and high hardness hard coating discussed herein. Further, the results presented between Example 4 and Example BB in Table 5 as well as between Example 2 and Example AA in Table 6 demonstrate that the residual warp is lower with hard coating HC1 than the foldable substrate without the hard coating, which is even more unexpected for the same reasons. Notably, the decrease in residual warp from the inclusion of hard coating HC1 appears to occur when the residual warp is greater (e.g., greater than 2 mm). This indicates that the hard coating can improve the foldability of the foldable apparatus, especially at relatively small parallel plate distances (e.g., as a multiple of the substrate thickness), where largely residual warp would otherwise be expected.

The Pencil Hardness of Examples 1, 3, and AA was measured to be 9H. No scratches were observed when abraded with a 9H pencil lead under a load of 750 g. The Mohs hardness of Examples AA-BB was measured to 7, but the Mohs hardness of Examples 1 and 3 was measured to be 8 (greater than the underlying substrate alone).

FIGS. 18-19 schematically represent differences between an uncoated foldable substrate (Example AA in FIG. 18) and hard coating disposed on the foldable substrate (Example 1 in FIG. 19) after the Taber Abrsaion Test. As shown, the change in SCE reflectance haze (ASCE) is 0.19% for Example AA but is reduced to 0.04% for Example 1. Likewise, the total reflectance haze for FIG. 18 (Example AA) is 0.234% but is only 0.080% for FIG. 19 (Example 1). Consequently, the hard coating can reduce visible surface damage on the foldable apparatus (relative to no hard coating).

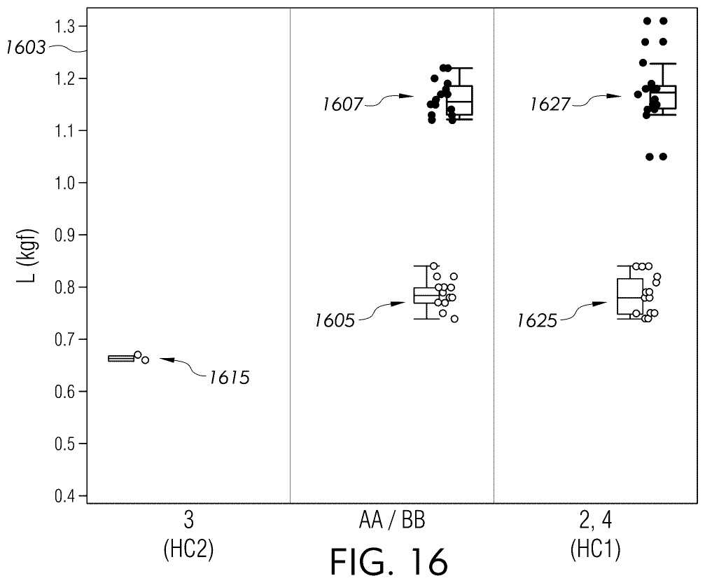

FIG. 16 schematically illustrates a load (L) in kilograms-force (kgf) withstood in a Quasi-Static Puncture Test on the vertical axis 1703 (i.e., y-axis) for Examples 2-4 and AA-BB. Points 1605 correspond to Example BB, points 1615 correspond to Example 1 (HC2), and points 1625 correspond to Example 2 (HC1). Examples 1, 4, and BB all have a substrate thickness of 30 μm. Of these examples, Example 1 (HC2) withstood the lowest load (about 0.65 kgf) whereas Examples 4 and BB withstood comparable loads (about 0.75 kgf). Points 1607 correspond to Example AA and points 1627 correspond to Example 2. Examples 2 and AA both have a substrate thickness of 50 μm, and both Examples 2 and AA withstood comparable loads (about 1.15 kgf). As expected, the examples with the 50 μm substrate thickness have better puncture resistance than the examples with the 30 μm substrate thickness. This demonstrates that the hard coating HC1 does not impair the puncture resistance of the foldable apparatus but does not necessarily help much either (as reflected by the Quasi-Static Puncture Test).

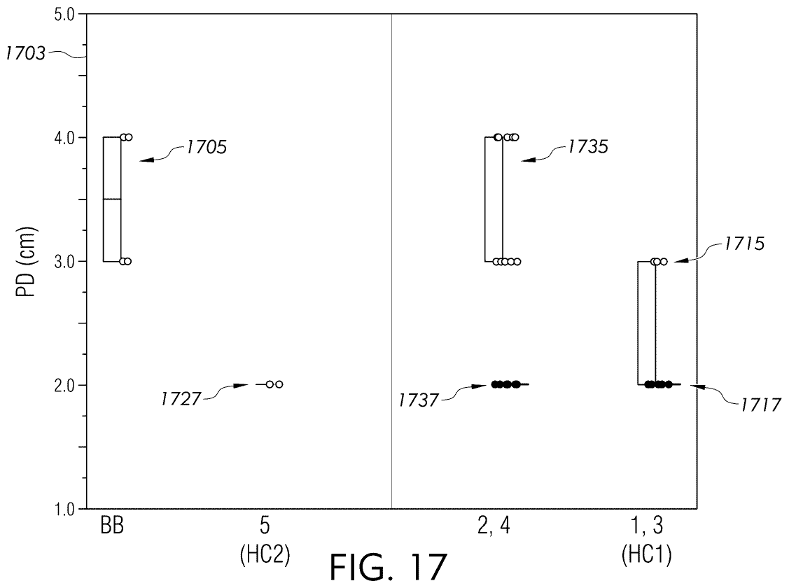

FIG. 17 schematically illustrates pen drop heights in centimeters (cm) in a Pen Drop Test on the vertical axis 1703 (i.e., y-axis) for Examples 1-5 and BB. Points 1717 correspond to Example 3, points 1737 correspond to Example 4, and points 1727 correspond to Example 5 (HC2). Examples 3-5 have a substrate thickness of 30 μm, and Examples 3-5 have withstood pen drop heights of 2 cm. Points 1705 correspond to Example BB, points 1715 correspond to Example 1, and points 1735 correspond to Example 2. Examples 1-2 and BB have a substrate thickness of 50 μm. Examples 2 and BB have essentially the same distribution of pen drop heights between 3 cm and 4 cm (as each other). While Example 1 only has points at 3 cm, this is likely due to the limited number of samples; otherwise, Example 1 would be expected to have the same distribution as Example 2. As expected, the examples with the 50 μm substrate thickness have better puncture resistance than the examples with the 30 μm substrate thickness.

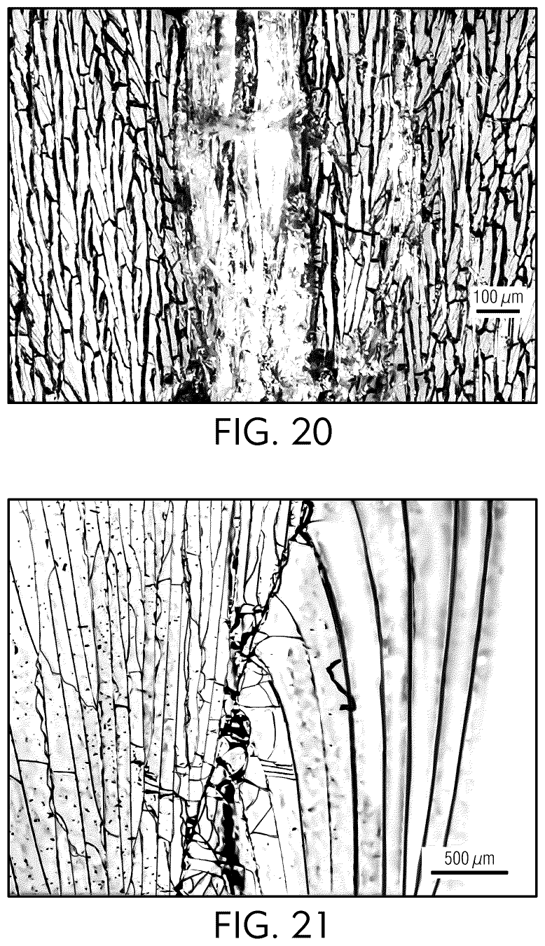

FIGS. 20-21 schematically illustrates an article fractured from the inside surface of the article in a folded configuration for Examples AA and 1, respectively. The scale in FIG. 21 (500 μm) is five times larger than the scale in FIG. 21 (100 μm). First, the size of the fractured pieces in FIG. 21 (Example AA) is at least an order of magnitude larger than the fractured pieces in FIG. 20 (Example 1). Additionally, fractured pieces in the middle of the image in FIG. 20 were ejected from the sample, which is visible as the regions without noticeable fragment boundaries. In contrast, no fragments were ejected from Example 1 (FIG. 21).

The above observations can be combined to provide foldable apparatus having a hard coating disposed over a foldable substrate that still maintains foldability comparable to that of the underlying foldable substrate. As demonstrated by the Examples discussed herein, it was unexpectedly discovered that the foldable apparatus including the hard coating described herein can achieve parallel plate distances less than or equal to 0.1 mm/μm (or 0.05 mm/μm) times the substrate thickness (or 5 mm or 3 mm) in the Static Folding Test. It would have been expected that a foldable apparatus having the hard coating would fail due to the high stiffness imparted by the high modulus and high hardness hard coating and/or brittleness of the hard coating. Instead, the hard coating improves the folding performance of the foldable apparatus (by incorporating the hard coating). Further, it was unexpectedly discovered that the foldable apparatus including the hard coating described herein can exhibit low warp after the Static Warp Test (e.g., 24 hours). Again, it would have been expected that the increased stiffness imparted by the high modulus (e.g., higher modulus than the foldable substrate) and high hardness hard coating would have resisted the foldable apparatus returning to the folded configuration, which would appear as high warp (e.g., greater than 3 times the parallel plate distance in the Static Fold Test).

Between Tables 5 and 6, the residual warp of the examples including hard coating HC1 is generally less than 10% of the residual warp seen without the hard coating. This result is unexpected in itself due to expectations about the increased stiffness imparted by the high modulus (e.g., higher modulus than the foldable substrate) and high hardness hard coating discussed herein. Further, the results presented between Example 4 and Example BB in Table 5 as well as between Example 2 and Example AA in Table 6 demonstrate that the residual warp is lower with hard coating HC1 than the foldable substrate without the hard coating, which is even more unexpected for the same reasons. Notably, the decrease in residual warp from the inclusion of hard coating HC1 appears to occur when the residual warp is greater (e.g., greater than 2 mm). This indicates that the hard coating can improve the foldability of the foldable apparatus, especially at relatively small parallel plate distances (e.g., as a multiple of the substrate thickness), where largely residual warp would otherwise be expected.

In aspects, foldable apparatus can comprise an anti-fingerprint coating disposed over the hard coating that can reduce a visibility and/or color shift associated with disposing a fingerprint thereon. Providing a low total surface energy (including a low dispersive surface energy and/or a low polar surface energy) of the anti-fingerprint coating can enable oils (e.g., fingerprint oil) to be dispersed across the anti-fingerprint surface (e.g., oleophilic), which can decrease a visibility and/or a color shift associated with fingerprints. For example, providing an alkyl silane can reduce a surface energy (e.g., total, dispersive, polar) of the anti-fingerprint coating, which can enable the anti-fingerprint coating to be oleophilic. Providing a low hexadecane contact angle (e.g., 30° or less) and/or a low diiodomethane contact angle (e.g., 60° or less) can reduce the visibility and/or color shift associated with fingerprints by enabling fingerprint oil to be dispersed across the anti-fingerprint coating rather than beading up into pronounced droplets. Providing a high water contact angle (e.g., 100° or more) can enhance the removal of aqueous material (e.g., water droplets, sweat droplets) from the anti-fingerprint coating. Consequently, the anti-fingerprint coating can be hydrophobic and oleophilic.

The foldable substrate can comprise a glass-based material, which can provide good dimensional stability, good impact resistance, and/or good puncture resistance. The glass-based substrate can comprise one or more compressive stress regions, which can further provide increased impact resistance and/or increased puncture resistance.

Embodiments of the present disclosure may be further understood in view of the following information.

A further example (Example 2) foldable apparatus was fabricated by forming an additional hard coating (HC3) in accordance with the present disclosure on a foldable glass substrate.

TABLE 7
Composition of Hard Coating HC3

| | | | |
|---|---|---|---|
| Thickness | | | Extinction |
| (nm) | Material | RI | coefficient |

ETC

| | | | |
|---|---|---|---|
| 101.5 | SiO2 | 1.4671 | 0 |
| 154.4 | SiN | 2.0285 | 0.00109 |
| 45.1 | SiO2 | 1.4671 | 0 |
| 26 | SiN | 2.0285 | 0.00109 |
| 85.6 | SiO2 | 1.4671 | 0 |
| 25.2 | SiN | 2.0285 | 0.00109 |
| 50.4 | SiO2 | 1.4671 | 0 |
| 39.4 | SiN | 2.0285 | 0.00109 |
| 16 | SiO2 | 1.4671 | 0 |
| 1500 | SiON | 1.95733 | 0.00005 |
| 8 | SiO2 | 1.4671 | 0 |
| 50.6 | SiON | 1.96379 | 0.00096 |
| 26.4 | SiO2 | 1.4671 | 0 |
| 35.9 | SiON | 1.96379 | 0.00096 |
| 49.2 | SiO2 | 1.4671 | 0 |
| 20 | SiON | 1.96379 | 0.00096 |
| 64 | SiO2 | 1.4671 | 0 |
| 8 | SiON | 1.96379 | 0.00096 |
| 20 | SiO2 | 1.4671 | 0 |

Substrate

As can be seen by comparing Tables 3 and 7, the hard coating HC3 differs from the hard coating HC2 in that the thicknesses of the layers differ and the refractive indices of certain ones of the higher refractive index layers differ from one another. For example, each of the hard coatings HC3 and HC2 included a 1500 nm thick SiON layer positioned so that 9 other layers of the stack were between the thick SiON layer and the substrate. In HC2, the thick SiON layer exhibited a refractive index of approximately 1.97, whereas in HC3, the thick SiON layer exhibited a refractive index of approximately 1.96. These differences are the result of differences between coating processes used to fabricated HC2 and HC3.

The substrate on which HC3 was deposited was a 100 μm thick chemically strengthened sheet of Gorilla Glass 2® manufactured by Corning Incorporated®. The substrate was chemically strengthened to exhibit a maximum compressive stress of 790.5 MPa and a DOL of 15.9 μm on at the coated surface (prior to deposition of HC3 thereon). It has been observed that the substrate tends to be heated during HC3's deposition process. Elevated temperatures can adversely effect the stress profile of the substrate, particular at long deposition times (such as when the thick SiON layer is deposited). The elevated deposition temperatures increase ion mobility in the glass substrate and thus, can cause the larger ions present at the surface of the glass substrate to layer to migrate, thus adversely affecting the compressive stress in the surface of the glass substrate. In the stack represented in Table 7, the coating was formed using sputtering process in which the power, flow rates, and deposition times for each layer were controlled so that the temperature of the substrate (at the coated surface) never exceeded 140° C. Such a low temperature sputtering process beneficially minimized adverse effects (e.g., reduced maximum CS and DOL) on the substrate's stress profile caused by the deposition process.

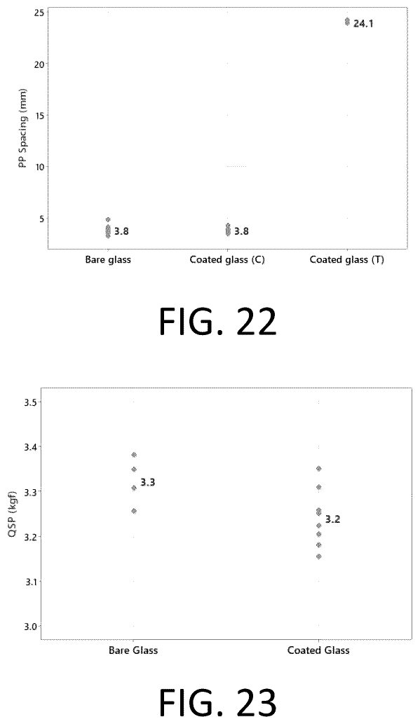

In forming this example, a reaction to nitride or oxynitride occurred in a inductively coupled plasma (ICP) region within a sputtering chamber. Parameters to control temperature included: number of targets used, power applied to each sputtering target (kW), deposition time for each layer, and ICP power. Gas flow rates were used to control other layer characteristics. For example argon (Ar) gas flows at the sputtering target (sccm) were used to control the stress and resulting warpage. O₂ and N₂ flow rates were used to tune the refractive index and extinction coefficient of each layer, Particularly, the power applied to each sputtering target (4 sputtering targets were used) was controlled to be less than 9 kW and, more particularly, to less than or equal to 6 kW during the deposition of the thickest layers. A deposition time of less than 2 hours was maintained for each layer (and less than 10 minutes for most layers). Ar flow rates of between 150 and 500 sccm were used for each target. ICP power was maintained beneath 3 kW. N₂ gas flow in the ICP region was between 200 and 250 sccm. O₂ flow in the ICP region was maintained relatively low (less than 15 sccm) during deposition of the thick SiON layer, while higher O₂ flow of 180 sccm was used for SiO₂ layers not contacting the thick SiON layer. The coating conditions used are provided in detail in Table 8. The maintenance of compressive stress enabled by these deposition conditions is believed to contribute to the bending performance of this example, described herein with respect to FIG. 22.

TABLE 8
Coating Conditions for HC3

| | | Target 1 | | Target 2 | | Target 3 | | Target 4 | |
|---|---|---|---|---|---|---|---|---|---|
| | | | Ar | | Ar | | Ar | | Ar |
| | | Power | Flow | Power | Flow | Power | Flow | Power | Flow |
| Step | Time (s) | (kW) | (sccm) | (kW) | (sccm) | (kW) | (sccm) | (kW) | (sccm) |
| 1 | 60 | | 180 | | 180 | | 180 | | 180 |
| 2 | 55.1 | 0 | 180 | 3 | 180 | 3 | 180 | 3 | 180 |
| 3 | 21.0 | 0 | 180 | 6 | 180 | 6 | 180 | 6 | 180 |
| 4 | 181.8 | 0 | 180 | 3 | 180 | 3 | 180 | 3 | 180 |
| 5 | 54.9 | 0 | 180 | 6 | 180 | 6 | 180 | 6 | 180 |
| 6 | 142.2 | 0 | 180 | 3 | 180 | 3 | 180 | 3 | 180 |
| 7 | 96.5 | 0 | 180 | 6 | 180 | 6 | 180 | 6 | 180 |
| 8 | 76.4 | 0 | 180 | 3 | 180 | 3 | 180 | 3 | 180 |
| 9 | 135.1 | 0 | 180 | 6 | 180 | 6 | 180 | 6 | 180 |
| 10 | 21.8 | 0 | 180 | 3 | 180 | 3 | 180 | 3 | 180 |
| 11 | 2000 | 0 | 480 | 6 | 480 | 6 | 480 | 6 | 480 |
| 11 | 2000 | 0 | 480 | 6 | 480 | 6 | 480 | 6 | 480 |
| 12 | 250.2 | 0 | 480 | 6 | 480 | 6 | 480 | 6 | 480 |
| 13 | 46.9 | 0 | 180 | 9 | 180 | 0 | 180 | 0 | 180 |
| 14 | 108.3 | 0 | 480 | 7 | 480 | 7 | 480 | 7 | 480 |
| 15 | 165.2 | 0 | 180 | 9 | 180 | 0 | 180 | 0 | 180 |
| 16 | 67.9 | 0 | 480 | 7 | 480 | 7 | 480 | 7 | 480 |
| 17 | 30.9 | 0 | 180 | 9 | 180 | 0 | 180 | 0 | 180 |
| 18 | 64.6 | 0 | 480 | 7 | 480 | 7 | 480 | 7 | 480 |
| 19 | 158.7 | 0 | 180 | 9 | 180 | 0 | 180 | 0 | 180 |
| 20 | 383.0 | 0 | 480 | 7 | 480 | 7 | 480 | 7 | 480 |
| 21 | 341.5 | 0 | 180 | 9 | 180 | 0 | 180 | 0 | 180 |

| | | ICP1 Power | | ICP2 Power | | | | | |
|---|---|---|---|---|---|---|---|---|---|
| | Time | (kW) | | (KW) | | Ar flow | O2 flow | O2 flow | N2 flow |
| Step | (s) | start | end | start | end | (sccm) | (sccm) | (sccm) | (sccm) |
| 1 | 60 | 0.5 | 3 | 0.5 | 3 | 80 | 180 | | |
| 2 | 55.1 | 2.8 | | 2.8 | | 80 | 180 | | |
| 3 | 21.0 | 2.8 | | 2.8 | | 80 | | 13 | 250 |
| 4 | 181.8 | 2.8 | | 2.8 | | 80 | 180 | | |
| 5 | 54.9 | 2.8 | | 2.8 | | 80 | | 13 | 250 |
| 6 | 142.2 | 2.8 | | 2.8 | | 80 | 180 | | |
| 7 | 96.5 | 2.8 | | 2.8 | | 80 | | 13 | 250 |
| 8 | 76.4 | 2.8 | | 2.8 | | 80 | 180 | | |
| 9 | 135.1 | 2.8 | | 2.8 | | 80 | | | |
| 10 | 21.8 | 2.8 | | 2.8 | | 80 | 180 | | |
| 11 | 2000 | 2.8 | | 2.8 | | 80 | | 6 | 250 |
| 11 | 2000 | 2.8 | | 2.8 | | 80 | | 6 | 250 |
| 12 | 250.2 | 2.8 | | 2.8 | | 80 | | 6 | 250 |
| 13 | 46.9 | 2.8 | | 2.8 | | 80 | 180 | | |
| 14 | 108.3 | 2.8 | | 2.8 | | 80 | | | 200 |
| 15 | 165.2 | 2.8 | | 2.8 | | 80 | 180 | | |
| 16 | 67.9 | 2.8 | | 2.8 | | 80 | | | 200 |
| 17 | 30.9 | 2.8 | | 2.8 | | 80 | 180 | | |
| 18 | 64.6 | 2.8 | | 2.8 | | 80 | | | 200 |
| 19 | 158.7 | 2.8 | | 2.8 | | 80 | 180 | | |
| 20 | 383.0 | 2.8 | | 2.8 | | 80 | | | 200 |
| 21 | 341.5 | 2.8 | | 2.8 | | 80 | 180 | | |

The process conditions described herein can also beneficially limit the residual film stresses present in the hard coating. In aspects, the hard coating can be characterized by a residual compressive stress that is less than 1000 MPa. In some implementations the hard coating can be characterized by a residual compressive stress in a range from about 5 MPa to about 1000 MPa (compression), or from about 5 MPa to 500 MPa, or from 80 MPa to 400 MPa. For example, the residual compressive stress the hard coating can be 50 MPa, 100 MPa, 150 MPa, 200 MPa, 250 MPa, 300 MPa, 350 MPa, 400 MPa, 450 MPa, 500 MPa, 550 MPa, 600 MPa, 650 MPa, 700 MPa, 750 MPa, 800 MPa, 850 MPa, 900 MPa, 950 MPa, 1000 MPa, or any value lying in a range bounded by any two of the preceding values as inclusive endpoints (e.g., from 100 MPa to 450 MPa, from 300 MPa to 400 MPa, etc.). HC3, when deposited using the coating conditions described herein, exhibited a residual compressive stress less than 450 MPa. Residual compressive stress in the hard coating can be obtained by measuring the curvature of the substrate before and after deposition of the hard coating, and then calculating residual film stress according to the Stoney equation according to principles known and understood by those with ordinary skill in the field of the disclosure. Indeed, the example herein with HC3 exhibited minimal warpage of less than 0.5 mm throughout a 100 mm×100 mm area of the apparatus (which had dimensions of 160 mm×100 mm in this example) as a result of the coating, indicating a low residual compressive stress (the warpage being measured prior to any static or dynamic bending test being conducted).

Samples coated with HC3 were subjected to the Parallel Plate Test described herein with the coating both under compression (in the configuration of the hard coating 251 depicted in FIG. 8) and tension (with the coating on the opposite surface of the substrate to that shown in FIG. 8). The results are plotted in FIG. 22. As shown, with the coating under compression, the coated samples can achieve a minimum parallel plate distance that is comparable to that of bare, uncoated glass. In aspects, when the coating is placed under tension during the testing, the foldable apparatus can achieve a minimum parallel plate distance (in mm) that is less than or equal to 0.3 (mm/μm) times the thickness of the foldable substrate (in μm) and greater than or equal to 0.1 (mm/μm) times the thickness of the foldable substrate (in μm). In depicted example, the samples exhibited a minimum parallel plate distance of 24.1 mm in tension when the substrate thickness was 100 μm. To obtain the bending performance depicted in FIG. 22, the edges of the substrate that were bent during the parallel plate test (i.e., those extending parallel to the fold axis 102) were covered with a masking tape prior to depositing HC3. The edge masking tape was situated to prevent any material of the layers of HC3 from being deposited on the edge surfaces or minor surfaces of the substrate. Coating materials being deposited on the minor surfaces (the edge surface connecting the first and second major surfaces to one another) was found to reduce bending strength of the foldable substrate. The edge masking aids in preventing such strength reduction.

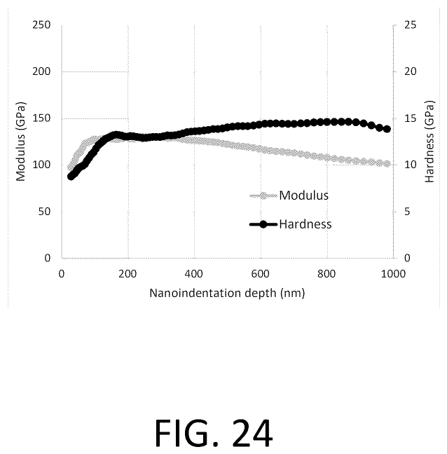

Samples coated with HC3 were subjected to the Quasi-Static Puncture test described herein, along with a comparable bare, uncoated substrate. The results are shown in FIG. 23. As shown, the coated substrate exhibited a comparable puncture resistance to that of the bare glass, indicating that the hard coating did not degrade puncture performance. In aspects, with the coatings described herein, the foldable apparatus exhibits a puncture resistance (in kgf) that is greater than or equal to the thickness of the foldable substrate (in μm) squared divided by 3300. FIG. 24 plots results for hardness and elastic modulus of HC3 as a function of indentation depth using the Berkovich nanoindentation test described herein. As shown, this example exhibited a maximum hardness, as measured by a Berkovich Indenter Hardness test, that is greater than or equal to 14 GPa and the maximum modulus was greater than or equal to 130 GPa. At an indentation depth of 100 nm, the hardness was greater than 12 GPa and the modulus was greater than or equal to 130 GPa. At an indentation depth of 500 nm, the hardness was greater than 14 GPa and the modulus was greater than or equal to 110 GPa. Generally, the hard coatings described herein can be configured so that the foldable apparatus exhibits a hardness, measured with a Berkovich nanoindentation test at 100 nm indentation depth, that is greater than or equal to than 9 GPa, greater than or equal to than 10 GPa, or even greater than or equal to than 11 GPa, and, at a 500 nm indentation depth, that is greater than or equal to 12 GPa, greater than or equal to than 13 GPa, or even greater than or equal to than 14 GPa. The nanoindentation hardness at a depth of 500 nm can be greater than that at an indentation depth of 100 nm. In aspects, the hard coatings described herein can be configured so that the foldable apparatus exhibits an elastic modulus, measured with a Berkovich nanoindentation test at a 100 nm indentation depth, that is greater than or equal to than 120 GPa, greater than or equal to than 125 GPa, or even greater than or equal to than 130 GPa, and, at a 500 nm indentation depth, that is greater than or equal to 110 GPa, greater than or equal to than 115 GPa, or even greater than or equal to than 120 GPa. The elastic modulus at an indentation depth of 100 nm may be greater than that at an indentation depth of 500 nm. These hardness and modulus measurements result from the positioning of the thick SION layer in the stack, which may vary depending on the optical performance desired from the foldable apparatus. As described in greater detail herein, the optical control layers of HC3 (the number of layers separating the thick SiON layer from the outer surface of the coating facing the observer) provide relatively favorable optical transmittance and reflectance performance.

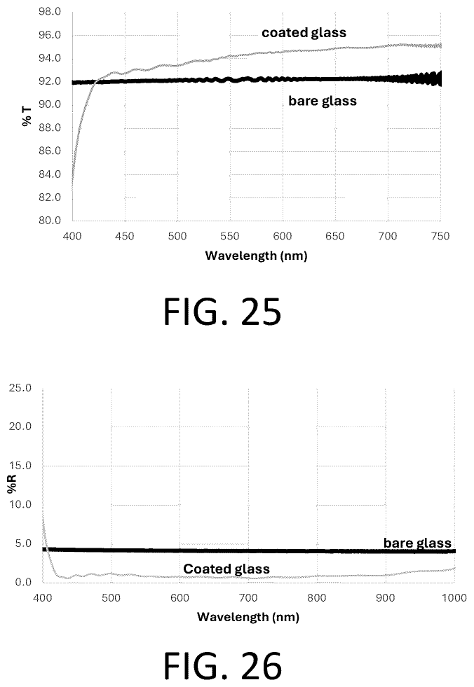

Optical performance of the example coated with HC3 was measured and compared to a bare substrate. FIG. 25 plots the transmittance as measured (for normally incident light) from 400 nm to 700 nm and FIG. 26 plots a 1-sided reflectance (from an outer surface of the coating) from 400 nm to 700 nm. As shown, the coated sample outperforms the bare glass over the measured range. Indeed, over a wavelength range from 400 nm to 700 nm, the apparatus including HC3 exhibited an average transmittance that is greater than or equal to 94%. Moreover, the coated sample exhibited a first surface photopic average reflectance less than 1%. Color measurements were also taken for the sample coated with HC3 when illuminated with a D65 light source with a CIE1964 10° observer. The results are below in Table 8 (calculated over a wavelength range from 400 nm to 700 nm). As shown, the sample exhibited the superior optical performance demonstrated in FIGS. 25-26 while maintaining a neutral color in transmittance and reflectance.

TABLE 8

| Measurement | X | Y | Z | x | y | Y | L | a* | b* |
|---|---|---|---|---|---|---|---|---|---|
| T_{bare} | 87.27 | 92.15 | 98.55 | 0.31 | 0.33 | 92.15 | 96.88 | −0.07 | 0.17 |
| 2R_{bare} | 7.44 | 7.86 | 8.57 | 0.31 | 0.33 | 7.86 | 33.70 | −0.08 | −0.46 |
| 1R_{bare} | 3.90 | 4.13 | 4.50 | 0.31 | 0.33 | 4.13 | 24.08 | −0.09 | −0.40 |
| T_{coat} | 89.11 | 94.06 | 99.22 | 0.32 | 0.33 | 94.06 | 97.66 | 0.01 | 1.07 |
| 1R_{bare} | 0.77 | 0.87 | 1.06 | 0.29 | 0.22 | 0.86 | 7.89 | −2.27 | −1.71 |

The samples also underwent modified abrasive testing as outlined in Annex A2, entitled “Abrasion Procedures,” of ASTM C158-02 (2012), entitled “Standard Test Methods for Strength of Glass by Flexure (Determination of Modulus of Rupture). The contents of ASTM C158-02 and the contents of Annex 2 in particular are incorporated herein by reference in their entirety. The test was modified in that the abrasive material was 320 grit SiC. The surface of the substrate (when bare) and HC3 were sandblasted at loads of 20 psi, 25 psi, and 30 psi. The coated samples exhibited an improvement in that they did not fail (fracture or exhibit branching cracks) at a load of 25 psi, whereas the bare glass failed at this load, exhibiting flaws with a check depths of up to 32 μm in a 100 μm substrate. This demonstrates that the hard coatings described herein can improve the abrasion performance of the foldable apparatus. This was confirmed with conospherical diamond scratch testing, which was conducted using a conospherical diamond tip (90 degree angle/10 pm radius). The diamond tip came into contact with the outer surface of the coating facing the observer, with a force of 0.2 N being applied at a scratch speed of 24 mm/min. The load was incrementally increased to form scratches at loads of 0.3 N, 0.4 N, 0.5 N, 0.6 N, and 0.7 N, until the sample fractured. The coated sample exhibited improved performance in that it did not fracture until a load of 0.7 N was applied, whereas the noncoated sample fractured at a 0.6 N load. The bare glass also exhibited lateral cracking to a greater degree at a load of 0.5 N than did the coated sample, further demonstrating improved abrasion resistance.

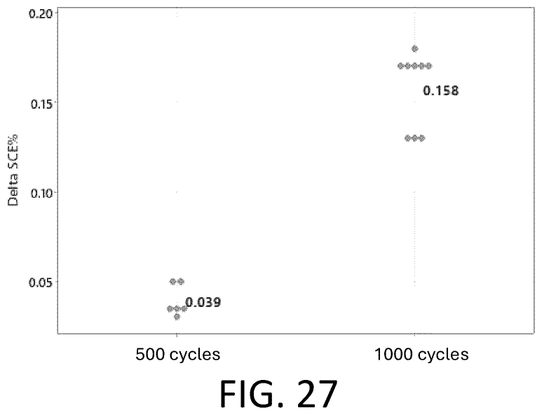

The samples were also subjected to the Taber Abrasion Test described herein. A sample coated with HC3 was subjected to 500 cycles and 1000 cycles of the Taber Abrasion Test. The results are shown in FIG. 27. As shown, the change in SCE reflectance haze as a result of the Taber Abrasion Test (of the coated surface of the foldable apparatus) can be less than 0.15% after 1000 cycles. The scratches were barely visible at a magnification of 50×. This is significantly improved over the bare glass, which exhibited a change in SCE reflectance haze as a result of the Taber Abrasion Test of about 0.25%.

A further example foldable apparatus can be fabricated by forming an additional hard coating (HC4) in accordance with the present disclosure on a foldable glass substrate.

TABLE 9
Composition of Hard Coating HC4

| Thickness | | | Extinction |
|---|---|---|---|
| (nm) | Material | RI | coefficient |
| 89.1 | SiO2 | 1.478 | 0 |
| 150.3 | SiON | 1.994 | 0.00004 |
| 16.4 | SiO2 | 1.478 | 0 |
| 52.6 | SiON | 1.994 | 0.00004 |
| 8.8 | SiO2 | 1.478 | 0 |
| 2000 | SiON | 1.994 | 0.00004 |
| 8.7 | SiO2 | 1.468 | 0 |
| 43.9 | SiON | 1.994 | 0.00004 |
| 30 | SiO2 | 1.468 | 0 |
| 25.9 | SiON | 1.994 | 0.00004 |
| 53.3 | SiO2 | 1.468 | 0 |
| 10 | SiON | 1.994 | 0.00004 |
| 25 | SiO2 | 1.468 | 0 |

Substrate

HC4 can be on a substrate that was the same as the example described above with respect to HC3. Similar deposition conditions could be used to obtain a hard coating with relatively low residual compressive stress without significantly degrading the compressive stress present at the coated surface prior to the deposition process. Optical performance of the sample coated with HC4 was modelled.

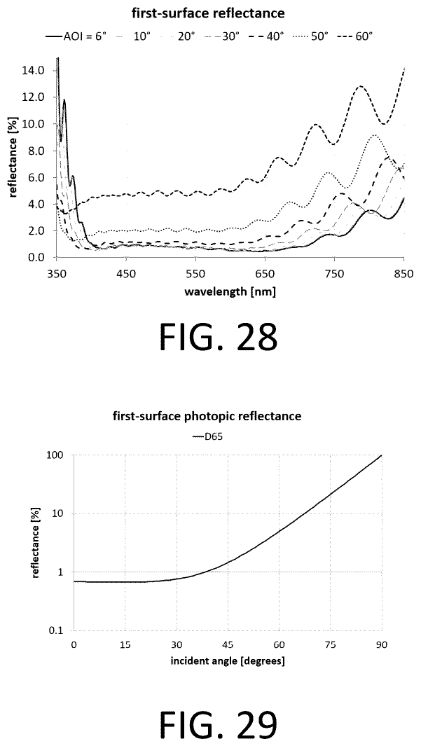

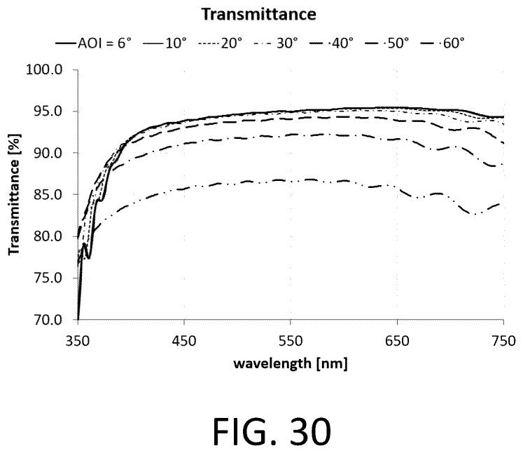

FIG. 28 is plot of a modelled first surface reflectance over a wavelength range from 350 nm to 850 nm for the sample, as measured for light incident on the coating at 6°, 10°, 30°, 40°, 50°, and 60° angles of incidence. FIG. 29 is a plot of the modelled first-surface photopic average reflectance of the sample as a function of angle of incidence. As shown, for angles of incidence from 0° to 30°, the sample exhibited an average first surface photopic average reflectance of less than 1%. For angles of incidence from 0° to 60°, the sample exhibited an average first surface photopic average reflectance of less than 9%. FIG. 30 is a plot of modelled two surface transmittance for the sample, as measured for light incident on the coating at 6°, 10°, 30°, 40°, 50°, and 60° angles of incidence. As shown, for angles of incidence less than or equal to 10°, the sample exhibited an average transmittance that is greater than or equal to 94% for light form 400 nm to 700 nm. For angles of incidence up to 60°, the sample exhibited an average transmittance of greater than or equal to 85% for light form 400 nm to 700 nm.

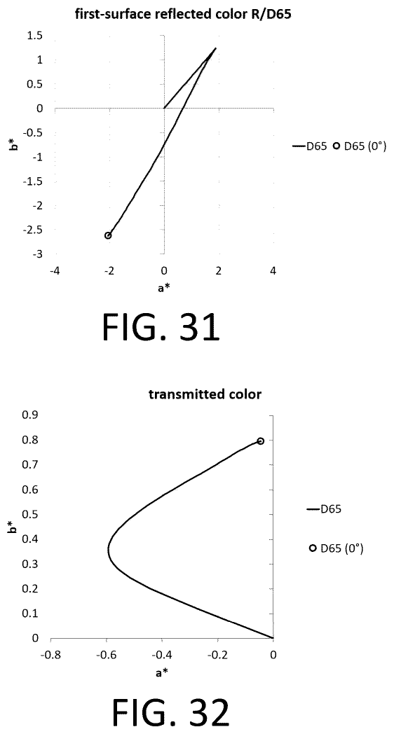

FIG. 31 is a plot of modelled first surface reflected color for angles of incidence ranging from 0° to 90° (for light incident on the coating). As shown, over a range of angles of incidence from 0° to 60°, the sample exhibited a reflected a* value within a range from −2.5 to 2.5 and a reflected b* value from −3 to 2. At near-normal incidence (angles of incidence up to) 10° the reflected a* and b* values were each in a range from −5 to 0, and more particularly in a range from −3 to 0. FIG. 32 is a plot of modelled transmitted color for light incident on the coating at angles of incidence ranging from 0° to 90°. As shown, over a range of angles of incidence from 0° to 60°, the sample exhibited a transmitted a* value within a range from 0 to 0.6 and a transmitted b* value from 0 to 0.8. Generally the hard coatings described herein may exhibit a transmitted color such that the a* and b* values are in a range from 0 to 5 at near-normal incidence, and more particularly form 0 to 2, or even more particularly from 0 to 1.

The hard coatings described herein may be further characterized by their first surface reflected color uniformity. In aspects, the substrate includes a hard coating that acts as an anti-reflective coating disposed on the first major surface of the substrate, and, at a point on an outer surface of anti-reflective coating opposite the first major surface, the article exhibits a single-surface reflectance under a D65 illuminant having a maximum angular color variation, ΔEₘₐₓ, defined as:

$$Δ {E}_{θ} = √ \{ {( {a}_{max}^{*} - {a}_{min}^{*} )}^{2} + {( {b}_{max}^{*} - {b}_{min}^{*} )}^{2} \}$$

where a*_{max, min} and b*_{max, min} are maximum and minimum a* and b* values, respectively, exhibited by the apparatus at the point when the reflected color is measured over an angular range from 0° to 60°. That is, a*ₘₐₓ is the maximum a* value exhibited at the point on the hard coating over the angular range from 0° to 60°. In aspects, ΔEₘₐₓ is less than or equal to 10, less than or equal to 9, less than or equal to 8, less than or equal to 7, less than or equal to 6, less than or equal to 5, less than or equal to 4, or even less than or equal to 3. In aspects, at the point on the reflective surface, the anti-reflective coating exhibits a single-surface reflectance under a D65 illuminant having an angular color variation, ΔE_{θ}, defined as:

$$Δ {E}_{θ} = √ \{ {( {a}_{θ1}^{*} - {a}_{θ2}^{*} )}^{2} + {( {b}_{θ1}^{*} - {b}_{θ2}^{*} )}^{2} \}$$

where a*_{θ1} and b*_{θ1} are a* and b* values of the point measured from a first angle θ₁, and a*_{θ2} and b*_{θ2} are a* and b* values of the point measured from a second angle θ₂, θ₁ and θ₂ being any two different viewing angles at least 5 degrees apart in a range from about 10° to about 60° relative to a normal vector of the reflective surface, and where ΔE_{θ} is less than 5. That is, in aspects, the coating is configured such that one cannot select two viewing angles in the viewing angle range from 10° to 60° that are at least 5 degrees apart that result in a ΔE_{θ} value of 5 or more.

Embodiments of the present disclosure may be further understood in view of the following information.

Additional implementations of the hard coatings described herein are identified in Tables 10, 11, 12, and 13 below.

TABLE 10
Composition of Hard Coating HC5

| Thickness (nm) | Material |
|---|---|
| 100 | SiO2 |
| 2000 | SiON |
| 25 | SiO2 |

Substrate

TABLE 11
Composition of Hard Coating HC6

| Thickness (nm) | Material |
|---|---|
| 2000 | SiON |
| 25 | SiO2 |

Substrate

TABLE 12
Composition of Hard Coating HC7

| Thickness (nm) | Material |
|---|---|
| 100 | SiO2 |
| 2000 | SiON |

Substrate

TABLE 13
Composition of Hard Coating HC8

| Thickness (nm) | Material |
|---|---|
| 2000 | SiON |

Substrate

Each of HC5, HC6, HC7, and HC8 contained a 2 μm thick SiON scratch resistant layer. As illustrated by the designs for HC7 and HC8, in aspects, the hard coating can comprise a scratch resistant layer that is disposed directly on the substrate. In such aspects, an additional layer of lower refractive index material (SiO₂ in the provided examples) may be disposed on the scratch resistant layer, or, in the alternative, the hard coating can consist of a single layer of any of the materials described herein with respect to the scratch resistant layer disposed directly on the substrate. While the thickness of the scratch resistant layer in HC5, HC6, HC7, and HC8 is 2000 μm, it should be appreciated that alternative thicknesses throughout the range of 0.05 μm to 5 μm provided herein for the scratch resistant layer may be used in the configurations provided for HC5, HC6, HC7, and HC8. As such, in aspects, the scratch resistant layer may comprise a thickness that is greater than or equal to 1.5% of the substrate thickness and less than or equal to 20% of the substrate thickness. For example, in aspects, the hard coating can comprise a scratch resistant layer that is 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20.0%, or any percentage lying in any range defined by any two of the preceding values as inclusive endpoints (e.g., from 1.5% to 20%, from 5% to 7%, from 10% to 15%, from 8% to 12%, from 1.5% to 3.0%, etc.).

As described herein, particularly when coating chemically strengthened substrates, it is beneficial to maintain a low coating process temperature to prevent stress relaxation to maintain adequate bending performance. In aspects, hard coatings described herein (including HC5, HC6, HC7, and HC8) can be formed according to a reactive sputtering process employing a single-chamber, box-type sputtering apparatus. Such a sputtering process and have a number of parameters that can be altered to vary the characteristics of the hard coatings. These parameters include: power applied to the target (kW), argon (Ar) gas flow (sccm), nitrogen (N₂) gas flow (sccm), oxygen (O₂) gas flow (sccm), and gas flow pressure (mTorr). In aspects such a reactive sputtering process can employ a sputtering power from about 0.1 kW to about 5 kW, an argon gas flow rate from about 10 sccm to about 100 sccm, and a sputter chamber pressure from about 1 mTorr to about 10 mTorr. Various examples in accordance with the present were formed on a 100 μm thick strengthened sheet of Gorilla Glass 2® manufactured by Corning Incorporated® using the reactive sputtering parameters outlined in Table 14. The substrate was chemically strengthened to exhibit a maximum compressive stress of 790.5 MPa and a DOL of 15.9 μm on at the coated surface. It was found that these parameters beneficially maintained the substrate temperature at or beneath 100° C. to minimize stress relaxation caused by the deposition.

TABLE 14
Exemplary Reactive Sputtering Parameters

| | | N2 | O2 | Ar | Process | Temperature |
|---|---|---|---|---|---|---|
| | Power | Flow | Flow | Flow | pressure | of deposition |
| | (W) | (sccm) | (sccm) | (sccm) | (mTorr) | (degree C.) |
| SiON | 2500 | 65 | 50 | 35 | 5 | 100 |
| SiO2 | 2000 | 0 | 50 | 35 | 1 | — |

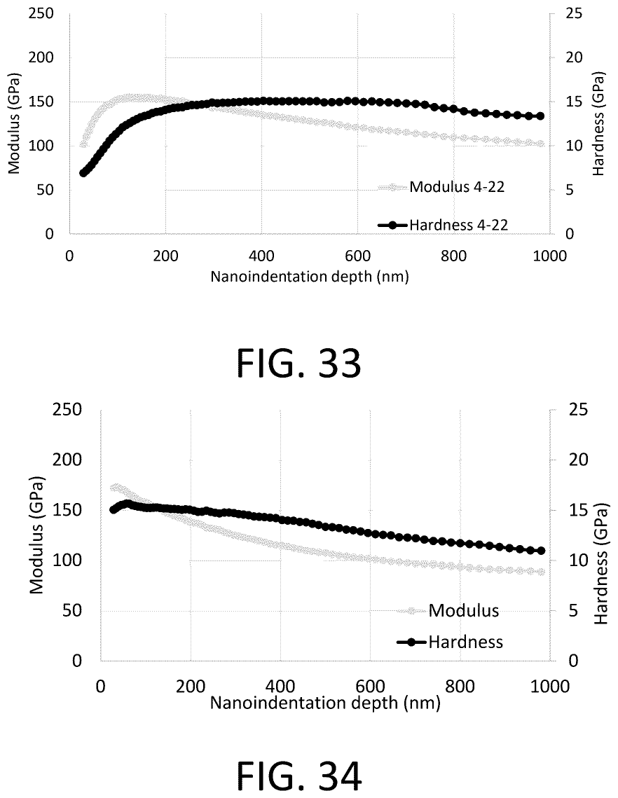

Referring now to FIG. 33 and FIG. 34, two samples were made in which HC5 and HC6 were deposited on a 100 μm thick strengthened sheet of Gorilla Glass 2® manufactured by Corning Incorporated®. The substrate was chemically strengthened to exhibit a maximum compressive stress of 790.5 MPa and a DOL of 15.9 μm on at the coated surface (prior to deposition of the coatings thereon). The parameters provided in Table 14 were used to deposit the layers. FIG. 33 plots results for hardness and elastic modulus of HC5 as a function of indentation depth using the Berkovich nanoindentation test described herein for the sample coated with HC5, while FIG. 34 plots results for hardness and elastic modulus of HC6 as a function of indentation depth using the Berkovich nanoindentation test described herein for the sample coated with HC6. As shown, both examples exhibited a maximum hardness, as measured by a Berkovich Indenter Hardness test, that is greater than or equal to 14 GPa and the maximum modulus was greater than or equal to 150 GPa, which was more than 50 GPa greater than the substrate.

A comparison between FIGS. 33 and 34 reveals that the addition of the SiO₂ layer above the thick SiON layer (e.g., such that the SiO₂ is disposed between the SiON layer and an outermost surface of the hard coating) changes the hardness profile. Particularly, as shown in FIG. 33, HC5 provides a hardness profile exhibiting a maximum hardness of about 15 GPa at an indentation depth of about 400 nm. HC6, in contrast, provides a maximum indentation hardness above 15 GPa at an indentation depth that is less than 100 nm (approximately 75 nm). At a depth of 100 nm, HC6 exhibits a nanoindentation hardness that is approximately 2 GPa higher than HC5. Such higher hardness at shallower depths is believed to aid in preventing certain types of scratches, such as those due to sliding motions against abrasive surfaces with relatively low applied normal force.

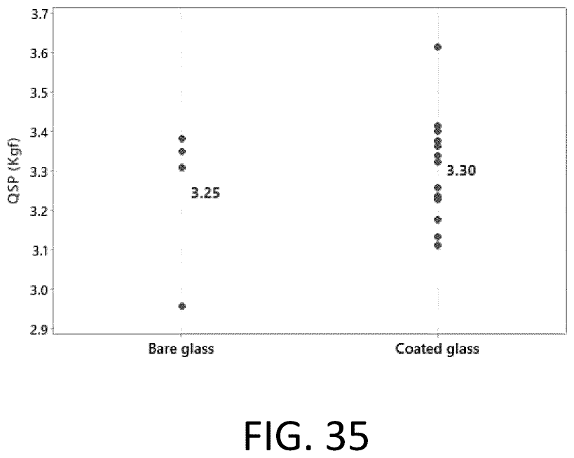

The coated samples were found to exhibit a parallel plate bending performance that was comparable to the uncoated glass, so long as the edges that are bent during the parallel plate testing are covered during deposition of the coating so that none of the coating is disposed on the edges, as described herein. Samples coated with HC6 were subjected to the Quasi-Static Puncture test described herein, along with a comparable bare, uncoated substrate. The results are shown in FIG. 35. As shown, the coated substrate exhibited a comparable puncture resistance to that of the bare glass, indicating that the hard coating did not degrade puncture performance. In aspects, with the coatings described herein, the foldable apparatus exhibits a puncture resistance (in kgf) that is greater than or equal to the thickness of the foldable substrate (in μm) squared divided by 3300.

Samples coated with HC6 were also tested for abrasive impact resistance. In particular, a 10 mm diameter 220 grit (˜63 μm) garnet sandpaper disc was attached to an arrow mounted on an air bearing slide support and launched (parallel to the surface of the table) at a velocity ranging from 200 mm/s to 1500 mm/s towards the sample bonded to a 200 mm thick silicon wafer. A speed gate reported the velocity of the arrow just before impact. The sample was mounted vertically (so that the outermost surface of the coating or glass had a surface normal extending parallel to the direction of travel of the sandpaper disc) during testing. The sample and wafer were attached to a load cell that recorded the force of the impact. Both the coated samples and the bare, uncoated substrate were subjected to such testing. The results for the bare glass and the coated sample are shown in Tables 15-16 below.

TABLE 15
Horizontal Abrasive Impact Testing of Uncoated Glass

| Velocity (mm/s) | Impact Force (N) | Result |
|---|---|---|
| 200 | 58.17 | Pass |
| 250 | 78.66 | Pass |
| 275 | 99.47 | Pass |
| 300 | 111.20 | Pass |
| 325 | 128.26 | Pass |
| 350 | 150.80 | Pass |
| 375 | 160.60 | Fail |

TABLE 16
Horizontal Abrasive Impact Testing of Coated Glass

| Velocity (mm/s) | Impact Force (N) | Result |
|---|---|---|
| 500 | 268.20 | Pass |
| 700 | 503.23 | Pass |
| 1000 | 971.30 | Pass |
| 1200 | 1286.21 | Fail |
| 1500 | 1717.59 | Fail |

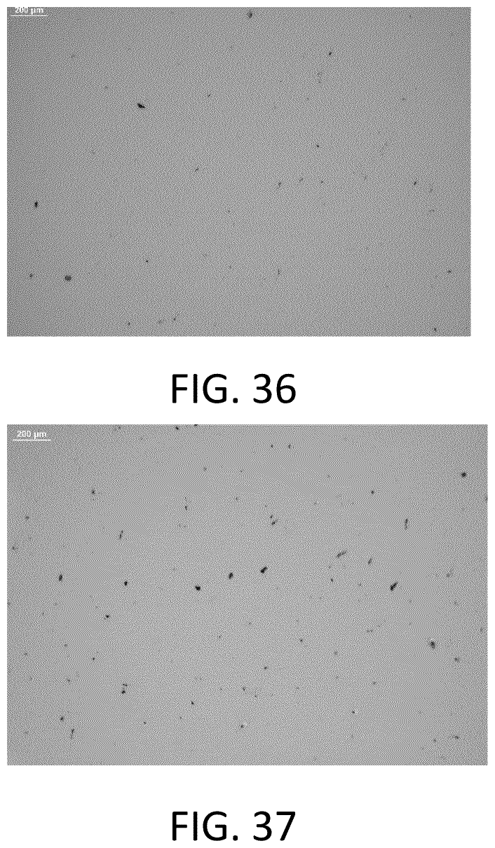

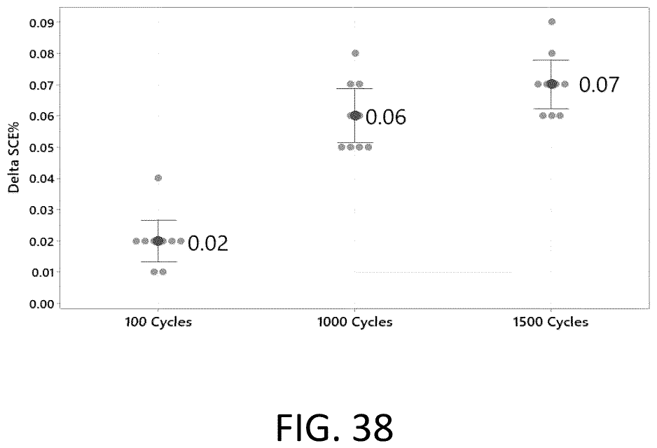

As shown, the coated sample did not fail at impact velocities that were more than 100 mm/s greater than when the uncoated glass failed. The coated samples avoided failure at an impact force that was more than four times greater than when the uncoated glass failed. Particularly, the coated sample did not exhibit failure at impact velocities up to 1000 mm/s, associated with an impact force of 971.30 N, whereas the bare glass exhibited failure at an impact velocity of 375 mm/s, associated with an impact force of 160.60 N. Without wishing to be bound by theory, it is believed that these results are aided by the high hardness of the hard coatings herein over relatively large nanoindentation depth ranges (as shown in FIG. 34, HC6 exhibited a nanoindentation hardness of greater than 10 GPa throughout a depth range of 50 nm to 1000 nm). FIGS. 36 and 37 are micrographs of the coated glass after impacts at 700 mm/s and 1000 mm/s, respectively. As shown, there is minimal damage to the coating and no failure of the substrate resulting from each impact. These results demonstrate that the hard coatings described herein beneficially improve the high speed abrasive impact resistance of the foldable apparatus described herein.

The samples were also subjected to the Taber Abrasion Test described herein. A sample coated with HC6 was subjected to 100 cycles, 1000 cycles, and 1500 cycles of the Taber Abrasion Test. The results are shown in FIG. 37. As shown, the change in SCE reflectance haze as a result of the Taber Abrasion Test (of the coated surface of the foldable apparatus) can be less than 0.1% after 1500 cycles. This is significantly improved over the bare glass, which exhibited a change in SCE reflectance haze as a result of the Taber Abrasion Test of about 0.25%. These results are also improved over the Examples represented in FIG. 27. It is believed this result is in part due to the higher hardness at shallower nanoindentation depths provided by HC 6, as described herein.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein, the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

The terms “substantial,” “substantially,” and variations thereof, as used herein, are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within 10% of each other, for example, within 5% of each other, or within 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure. That is, it will be appreciated that the various disclosed embodiments may involve particular features or elements that are described in connection with that particular embodiment. It will also be appreciated that a particular feature or element although described in relation to one particular embodiment, may be interchanged or combined with alternate embodiments in various non-illustrated combinations or permutations.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1. A foldable apparatus comprising:
a foldable substrate comprising a glass-based material, a first major surface and a second major surface opposite the first major surface, a substrate thickness defined between the first major surface and the second major surface, and the substrate thickness is from greater than or equal to 20 micrometers to less than or equal to less than or equal to 300 micrometers; and
a hard coating disposed on the first major surface, the hard coating comprising an inorganic material and exhibits a hardness of greater than or equal to 8 GigaPascals as measured by a Berkovich Indenter Hardness test,
wherein the foldable apparatus can achieve a parallel plate distance in millimeters equal to 0.1 times the substrate thickness in micrometers in a Static Folding Test at 60° C. and 90% relative humidity for 24 hours when the first major surface is placed in compression during the Static Folding Test.

2. The foldable apparatus of claim 1, wherein the foldable apparatus including the hard coating exhibits the hardness of greater than or equal to 10 GigaPascals as measured by the Berkovich Indenter Hardness test.

3. The foldable apparatus of claim 2, wherein an elastic modulus of the hard coating is greater than or equal to 100 GigaPascals.

4. The foldable apparatus of claim 1, wherein the hard coating comprises an optical stack, the optical stack comprises an anti-reflective coating, a band-pass filter coating, an edge neutral mirror, a beam splitter coating, a multi-layer high-reflectance coating, or an edge filter coating.

5. The foldable apparatus of claim 4, wherein the optical stack comprises the anti-reflective coating.

6. The foldable apparatus of claim 4, wherein the optical stack comprises a scratch-resistant layer, and wherein the scratch-resistant layer has a thickness from greater than or equal to 0.05 micrometers to less than or equal to 3 micrometers.

7. The foldable apparatus of claim 4, wherein the optical stack comprises two or more layers with different refractive indices including at least a first low refractive index layer and a second high refractive index layer, an absolute value of a difference between the first low refractive index layer and the second high refractive index layer is 0.2 or more, and further wherein the optical stack comprises one or more of a silicon-containing oxide, a silicon-containing nitride, a silicon-containing oxynitride, an aluminum-containing nitride, an aluminum-containing oxynitride, or niobia.

8. The foldable apparatus of claim 7, wherein:
the optical stack comprises the anti-reflective coating and the anti-reflective coating comprises alternating layers of one or more higher refractive index materials and one or more lower refractive index materials, wherein refractive indices of the one or more higher refractive index materials of the first layered film are higher than refractive indices of the one or more lower refractive index materials, and
a quantity, thicknesses, number, and materials of the alternating layers of the optical stack are configured so that the foldable apparatus exhibits:
an average percentage transmittance, calculated over a wavelength range between 400 nm and 700 nm, of greater than or equal to 92% for light normally light incident on the first major surface, and
a first surface photopic percentage reflectance, of less than 3% for light normally light incident on an outer surface of the optical stack facing an observer.

9. The foldable apparatus of claim 8, wherein the quantity, thicknesses, number, and materials of the alternating layers of the optical stack are configured so that the foldable apparatus exhibits at least one of:
an average percentage transmittance, calculated over a wavelength range from 400 nm to 700 nm, of greater than or equal to 85% for light incident on the first major surface at each angle in a range of angles of incidence from 0° to 60°, and
a first surface photopic percentage reflectance of less than 1% for light incident on the outer surface at each angle in a range of angles of incidence from 0° to 30°, and
at a point on the outer surface, the anti-reflective coating comprises a single-surface reflectance under a D65 illuminant having an angular color variation, ΔE_{θ}, defined as:
$$Δ {E}_{θ} = √ \{ {( {a}_{θ1}^{*} - {a}_{θ2}^{*} )}^{2} + {( {b}_{θ1}^{*} - {b}_{θ2}^{*} )}^{2} \}$$
where a*_{θ1} and b*_{θ1} are a* and b* values of the point measured from a first angle θ₁, and a*_{θ2} and b*_{θ2} are a* and b* values of the point measured from a second angle θ₂, θ₁ and θ₂ being any two different viewing angles at least 5 degrees apart in a range from about 10 to about 60° relative to a normal vector of the top side,
wherein ΔE_{θ} is less than 5.

11-20. (canceled)

21. The foldable apparatus of claim 8, wherein at least one of:
the foldable apparatus exhibits a puncture resistance (in kgf) that is greater than the substrate thickness (in μm) squared divided by 3300, as measured by the Quasi-Static Puncture test,
the foldable apparatus can achieve a parallel plate distance in millimeters that is less than or equal to 0.3 (mm/μm) times the thickness of the foldable substrate (in μm) and greater than or equal to 0.1 (mm/μm) times the thickness of the foldable substrate (in μm) when the anti-reflective coating when the first major surface placed in tension during the Static Folding Test,
when abraded on the anti-reflective coating as outlined in Annex A2 of ASTM C158-02(2012) with 320 grit SiC particles, the foldable apparatus avoids failure at a load which causes a comparable foldable apparatus including only the foldable substrate to fail,
when the anti-reflective coating is scratched using a conospherical diamond tip (90 degree angle/10 pm radius) at a scratch speed of 24 mm/min, the foldable apparatus avoids failure at a load which causes a comparable foldable apparatus including only the foldable substrate to fail.

22. The foldable apparatus of claim 8, wherein anti-reflective coating exhibits a residual compressive stress in a range from about 5 MPa to 500 MPa.

23. The foldable apparatus of claim 1, wherein a first Mohs hardness of the hard coating disposed on the foldable substrate is greater than or equal to a second Mohs hardness of the foldable substrate alone.

24. The foldable apparatus of claim 1, wherein the foldable apparatus can achieve a parallel plate distance in millimeters equal to 0.05 times the substrate thickness in micrometers in the Static Folding Test at 60° C. and 90% relative humidity for 24 hours when the first major surface is placed in compression during the Static Folding Test.

25. The foldable apparatus of claim 1, wherein the foldable apparatus can withstand 200,000 cycles to the parallel plate distance (in mm) equal to 0.1 times the substrate thickness in micrometers in a Dynamic Cycling Test at 23° C. and 50% relative humidity.

26. The foldable apparatus of claim 1, wherein the foldable apparatus can withstand 200,000 cycles to a parallel plate distance of 5 millimeters in a Dynamic Cycling Test at 23° C. and 50% relative humidity.

27. The foldable apparatus of claim 1, wherein the foldable apparatus can withstand being held at the parallel plate distance equal to 0.1 times the substrate thickness in micrometers in a Static Folding Test at 60° C. and 90% relative humidity for 24 hours.

28. The foldable apparatus of claim 1, wherein at least one of:
a residual warp 24 hours after completion of the Static Folding Test is less than 11.0 millimeters, and
a residual warp 24 hours after completion of a Static Folding Test where the foldable apparatus is held at a parallel plate distance of 5 millimeters at 60° C. and 90% relative humidity for 24 hours is less than or equal to 1.0 millimeter.

29. The foldable apparatus of claim 1, wherein the foldable substrate comprises:
a first portion comprising the substrate thickness;
a second portion comprising the substrate thickness; and
a central portion positioned between the first portion and the second portion, the central portion comprising a central thickness defined between a first central surface area and a second central surface area opposite the first central surface area, and the substrate thickness is greater than the central thickness by greater than or equal to 30 micrometers.

30. The foldable apparatus of claim 1, wherein the hard coating comprises a scratch-resistant layer having a thickness that is greater than or equal to 0.2 μm micrometers to less than or equal to 3 micrometers.

31. The foldable apparatus of claim 30, wherein the thickness of the scratch-resistant layer is greater than or equal to 1.5% and less than or equal to 20% of the substrate thickness.
